(19) United States
(12) Patent Application Publication
(10) Pub. No.: US 2021/0097240 A1
(43) Pub. Date: Apr. 1, 2021

(54) METHOD AND APPARATUS FOR GENERATING PERSUASIVE RHETORIC

(71) Applicant: RAVNEET SINGH, Ft. Lauderdale, FL (US)

(72) Inventor: RAVNEET SINGH, Ft. Lauderdale, FL (US)

(21) Appl. No.: 17/069,854

(22) Filed: Oct. 13, 2020

Related U.S. Application Data
(63) Continuation-in-part of application No. 16/109,647, filed on Aug. 22, 2018, now abandoned.
(60) Provisional application No. 62/914,370, filed on Oct. 11, 2019.
(60) Provisional application No. 62/548,841, filed on Aug. 22, 2017.

(51) Int. Cl. G06F 40/35; H04L 12/58; G06F 16/9536; G06F 16/9535

(52) U.S. Cl. CPC G06F 40/35; G06F 16/9535; G06F 16/9536; H04L 51/32

(57) ABSTRACT

An apparatus to generate persuasive rhetoric for a social media participant. The apparatus includes a processor, an input device, an output device, and a non-transitory storage medium. The non-transitory storage medium includes a proposed message read module, a lingo score module, a pulse score module, a tone score module, and a sentiment module. The proposed message read module reads a number of proposed messages from the input device. The lingo score module measures the linguistic lingo of each of the number of proposed messages based on the linguistic lingo of a number of previously published messages. The pulse score module measuring the frequency of the number of proposed messages with a rate of postings for the number of previously published messages. The tone score module measures a willingness attitude of the number of proposed messages. The sentiment module measures a direction and direction of the number of previously published messages.

### CROSS-REFERENCE TO RELATED APPLICATIONS

The present application claims the benefit of provisional 62/914,370 filed on Oct. 11, 2019; the present application also claims the benefit of nonprovisional patent application Ser. No. 16/109,647 filed on Aug. 22, 2018, which claims the benefit of provisional 62/548,841 filed on Aug. 22, 2017. All of the other applications upon which a claim of benefit has been made are references that are incorporated by reference.

### TECHNICAL FIELD

The disclosure relates generally to an apparatus and method for generating persuasive rhetoric. Specifically, the disclosure relates to an apparatus for generating persuasive rhetoric using a number of social media networks.

### BACKGROUND OF THE INVENTION

Social interactions allow individuals to adjust the interpretation of their messages based on clues from other individuals. Body language, facial expressions, and eye gaze are examples of physical clues on individuals. Reactions of groups of people can be interpreted by group reactions.

Computer managed social networks allow individuals to interact with other individuals in disparate locations without personal interaction. Such interactions, however, can lead to challenges in understanding the interpretation of a message. Reading the interpretation of a message can be measured by various metrics, such as likes, shares, or other types of interactions on a computer network. Various patents and US20180067912 applications have been previously disclosed: US20180203847A1; U.S. Pat. No. 8,924,326; US 20180277093; and US10170100.

Computer mediated communication, and more generally technology mediated communication is becoming a powerful influencer and is changing at a rapid rate due to new developments within modern technology like Artificial Intelligence (AI), machine learning and natural language processing. The field of computer mediated communication within linguistics is digital rhetoric and persuasiveness is required of all types of successful campaigns that are political, private, public and even peer-to-peer related.

Systems have been disclosed in the past for analysis of social media content; see for example, U.S. patent application Ser. No. 13/653,856 and any references cited by the '856 application. Sentiment analysis may be employed by some users of social media, but determining a preferred tone for engaging with an audience is still often hit-and-miss. Additionally, a system that effectively analyzes tone is still desired.

### BRIEF SUMMARY OF THE INVENTION

An apparatus to analyze and generate persuasive rhetoric for a social media participant and reward actual engagement is disclosed. The apparatus may include a processor, an input device, an output device, and a non-transitory storage medium. The input device may be communicatively connected to the processor. The input device may receive a number of proposed messages. The output device may be communicatively connected to the processor. The output device may inform a social media participant of a number of metrics regarding the number of proposed messages. The non-transitory storage medium may include a proposed message read module, a lingo score module, a pulse module, a tone score module, and a sentiment module. The lingo score module may measure the use of social media language in the number of proposed messages based on the lingo of a number of previously published messages. A pulse score module measures the frequency of posting the number of proposed messages relative to the posting rate for the number of previously published messages. A sentiment score module measures the intended direction for an emotional response to a message and the intensity of that emotion based on the number of previously published messages. A score module measures the willingness or intent of a follower to relay the messages of a leader. Dominant tone intensity is divided into emotional or language and there are seven types of emotion inherent in tone: anger, fear, sadness, joy, analytical, confident, and tentative.

A method for generating persuasive rhetoric for a social media participant is described that includes reading a number of proposed messages an input device, measuring a lingo of each of a number of proposed messages based on a lingo of a number of previously published messages, measuring a frequency of the number of proposed messages with a rate of postings for the number of previously published messages, measuring tone of a message based on a willingness attitude of the number of proposed messages, and measuring sentiment of a direction based on a number of previously published messages.

An apparatus to generate persuasive rhetoric for a producing speaker includes a processor, an input device, an output device, and a non-transitory storage medium. The input device receives a number of proposed messages in at least one format of audio, text, video, imagery, photos. The output device informs a producing speaker of a number of metrics regarding the number of proposed messages. The non-transitory storage medium includes a proposed message read module, a lingo score module, a pulse score module, a tone score module, and a sentiment module. The proposed message read module reads a number of proposed messages from the input device. The lingo score module measures the linguistic lingo of each of the number of proposed messages, including at least one of the following: emojis, hashtags, mentions, post urls, abbreviations, emoticons, emojis, capitalization and punctuation; based on a number of previously published messages. The pulse score module measures the frequency of the number of proposed messages over a period of time, with a rate of postings for the number of previously published messages. The tone includes type, intensity, category of tone, the tone score module measuring a willingness attitude of the number of proposed messages. The sentiment module measures direction, emotion, characteristics, and user information to determine a direction and direction of the number of previously published messages.

### BRIEF DESCRIPTION OF THE SEVERAL VIEWS OF THE DRAWINGS

A more particular description of the invention briefly described above is made below and incorporated herein by reference. Several examples of the invention are depicted in drawings included with this application. These examples are presented to illustrate, but not restrict, the invention.

FIG. 1 illustrates an apparatus for generating persuasive rhetoric;

FIG. 2 illustrates a method for generating persuasive rhetoric;

FIG. 3 illustrates an apparatus for generating persuasive rhetoric;

FIG. 4 shows a schematic of architecture of a system as disclosed herein;

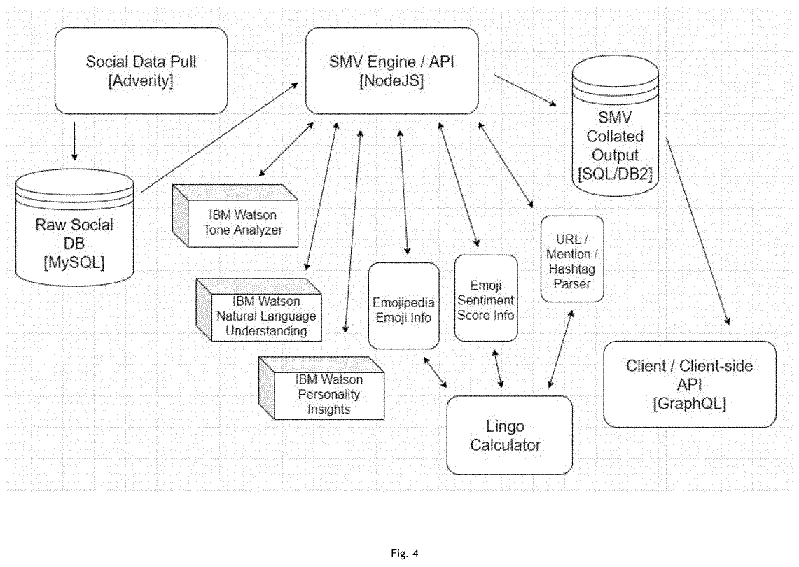

FIG. 5 shows a schematic of architecture of a system as disclosed herein.

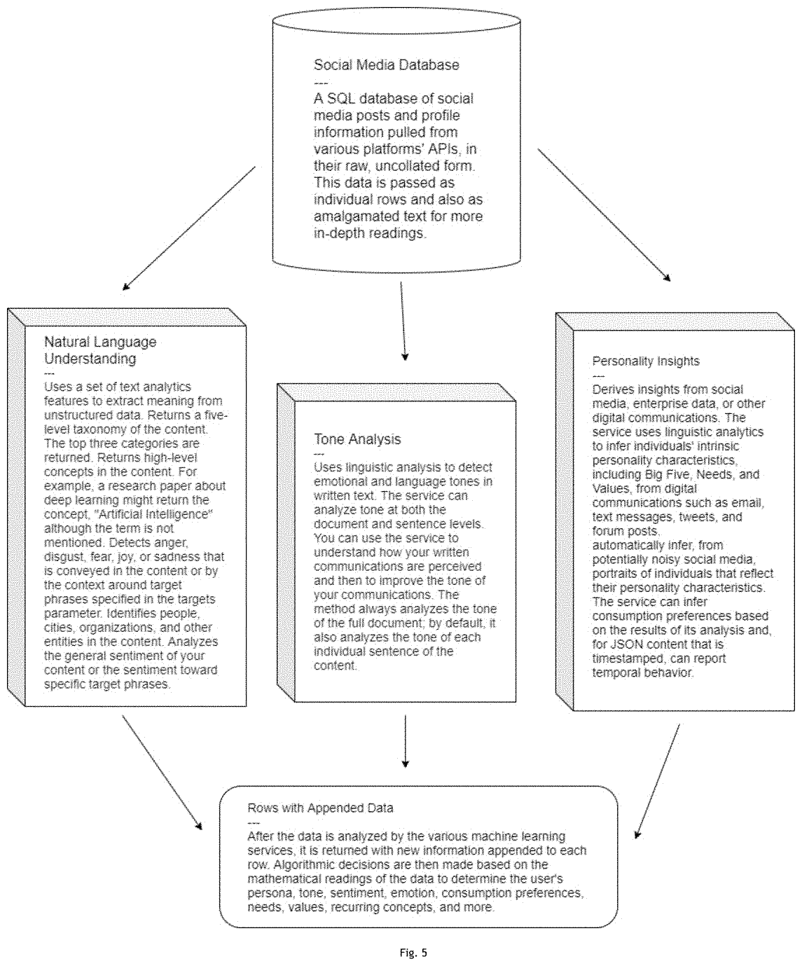

### DETAILED DESCRIPTION OF THE INVENTION

A detailed description of the claimed invention is provided below with reference to examples in the appended figures. Those of skill in the art may recognize that the components and steps of the invention as described by example in the figures below could be arranged and designed in a wide variety of different configurations, without departing from the substance of the claimed invention. Thus, the detailed description of the examples in the figures is merely representative of an example of the invention, and is not intended to limit the scope of the invention as claimed.

In some instances, numerical values are used to describe features such as spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, the modules refer to a combination of hardware and program instructions to perform a designated function. Each of the modules may include a processor and memory. The program instructions are stored in the memory, and cause the processor to execute the designated function of the modules. Additionally, a smartphone app and a corresponding computer system may be used to implement a module or a combination of modules. The storage medium refers to the app itself, the blockchain system, cryptocurrency exchange, the search and compliance engines and the information contained therein.

A purpose of the claimed apparatuses, methods, and systems is to generate persuasive rhetoric in a social media environment. Persuasive rhetoric refers to a measure of how effectively a user (leader) uses their social media voice (tone, sentiment, lingo and pulse) to convince listeners (followers) to participate in the dialogue published or shared by the leader based on follower engagement in the form of follower likes, replies and shares. A number of social media platforms are monitored to identify lingo, pulse, tone, sentiment. An aggregated score may be determined and used to predict the effect of a social media message.

As described above, social media is a method of communication that may restrict physical interaction.

A method includes digitally computing a finalized lingo score from a set of published messages published by a categorized group of social media participants, digitally computing a finalized engagement score, calculating a value of an engagement score for a proposed message, digitally computing a finalized posting frequency from the set of published messages published, digitally querying a tone analyzer for a finalized emotion tone, digitally querying the tone analyzer for a computable finalized social propensities tone, digitally querying, digitally querying the sentiment analyzer for a finalized sentiment computable from the set of published messages the tone analyzer for a computable finalized language tone, digitally querying the tone analyzer for an emotion tone computable from the proposed message and an emotion tone intensity computable from the proposed message, digitally querying the tone analyzer for a social propensities tone computable from the proposed message and a social propensities tone intensity computable from the proposed message, digitally querying, via a processor, the sentiment analyzer for a sentiment computable from the proposed message digitally analyzing, via a processor, the proposed message by computing a proposed message lingo score for the proposed message and a proposed user posting frequency for the proposed message, digitally comparing the finalized lingo score with the lingo score of the proposed message, digitally comparing the finalized posting frequency with the posting frequency of the proposed message, digitally comparing the finalized emotion tone with the emotion tone of the proposed message, digitally comparing the finalized emotion tone intensity with the emotion tone intensity of the proposed message, digitally comparing, via a processor, the finalized social propensities tone with the social propensities tone of the proposed message, digitally comparing the corresponding finalized social propensities tone intensity with the social propensities tone intensity of the proposed message, digitally comparing finalized language tone with the language tone of the proposed message, digitally comparing the finalized language tone intensity with the language tone intensity of the proposed message, digitally comparing the finalized posting frequency with the posting frequency of the proposed message, and, digitally identifying a number of message issues, of the proposed message, changeable to increase the value of the predicted engagement score of the proposed message.

digitally computing a finalized lingo score from a set of published messages published by a categorized group of social media participants, the finalized lingo score comprising a plurality of coefficients of variation for at least three lingo subscores selected from a group consisting of a hashtag subscore, a mentions subscore, an abbreviation subscore, a post-link subscore, an emoji subscore, a jargon subscore, an emoticon subscore, and an all capital letters subscore. A lingo subscore is a measurement of an area of language communication that affects the rhetoric of the message. A hashtag subscore is measured by the use of hashtags, often referred to as #tag, that may provide cues to search engines as to relevant topics for the message. A mentions subscore refers to mentions made by the message of other users or mentions made by other users of the creator of the message. A jargon subscore indicates a measurement of words considered specific to a topic or area of discussion. An emoticon subscore refers to the measurement of the usage of emoticons such as a smiley face or a winking face. An all capital letters subscore refers to the measurement of words written in all capital letters. All capital letters often indicates that the user is either yelling or providing extreme emphasis to a word or phrase.

The method digitally computes a finalized engagement score, from a number of social media reactions to the set of messages published by the categorized group of social media participants, for the set of published messages. The finalized engagement score measures the engagement of a known set of post at a particular point in time. Comparing a number of engagement scores may determine if one message had more engagement, or interaction with users, then another message.

The method calculates, via a processor, a value of an engagement score for a proposed message. The method calculates an engagement score for a proposed message based on the at least three lingo subscores. The comparison of the lingo subscores for the final engagement score compared to the lingo subscores for the proposed message may indicate the expected engagement of the proposed message.

The method digitally computes a finalized posting frequency from the set of published messages published by the categorized group of social media participants, wherein the categorized group of social media participants belong to a number of categories selectable from an occupation category, a role category, a gender category, an age range category, a geographic location category; a celebrity status category, a politician category, a candidate category, a political opinion category, and combinations thereof. The method computes a frequency at which messages are published and the effectiveness of that frequency in reaching a number of categories. The method may compare the frequency of the user of the proposed message compared to other users targeting similar categories. One reason to measure the frequency of message publication is to seek a resonant frequency which attracts the most attention of a targeted audience.

The method digitally queries, via a processor, a tone analyzer for a finalized emotion tone computable from the set of published messages and for a finalized emotion tone computable from the set of published messages, the finalized emotion tone selectable from a group consisting of joy, sadness, anger, disgust, and fear. The tone analyzer analyzes words used in the message, as well as other emotional cues such as emoticons to determine if the tone of the message is one of joy, sadness, anger, disgust, or fear.

Words indicating joy may include terms such as happy, delight, triumph, win, proud, exhilaration or other words generally expressing happiness.

Words indicating sadness may include terms such as sorrow, regret, depressed, despair, death, loss, drop out, cancel, or other words the generally indicate sadness.

Words indicating anger may include annoyed, displeased, resent, upset, rage, annoyed, irritated, infuriated, or other words that generally indicate anger.

Words indicating discussed may include words such as revolting, horrified, nausea, disk taste, revolt, repel, sicken, or other words the indicate that the topic is displeasing or unsanitary.

Words indicating fear may include terror, fright, horror, panic, dismayed, slippery slope, anxious or other words indicating fear.

The method digitally queries, via a processor, the tone analyzer for a computable finalized social propensities tone from the set of published messages and for a finalized social propensities tone, the finalized social propensities tone comprising a social propensities tone selected from a group consisting of openness, conscientiousness, extroversion, agreeableness, and emotional range. The social propensities tone measures the expected response of a message against a target audience. The social propensity tone may indicate that an audience is open to an idea, is conscientious about a subject, interested in engaging in a subject, will agree with the topic, or may have a range of other emotions.

The method digitally queries, via a processor, the tone analyzer for a computable finalized language tone from the set of published messages and a computable finalized language tone intensity from the set of published messages, the finalized language tone selectable from a group consisting of analytical, confident, and tentative. The tone analyzer may be applied to a set of published messages to determine the intensity of the proposed message compared to other messages from the target audience.

The method digitally receives, via a processor from the tone analyzer, the finalized emotion tone, the finalized emotion tone intensity, the finalized social propensities tone, the finalized social propensities tone intensity, the finalized language tone, and the finalized language tone intensity. The tone intensity indicates the strength of the tone being used, and may be compared to historic data of prior messages from or to a target audience.

The method digitally queries, via a processor, the sentiment analyzer for a finalized sentiment computable from the set of published messages, the finalized sentiment selectable from a group consisting of a positive sentiment, a neutral sentiment, and a negative sentiment. The sentiment analyzer uses words and phrases from the proposed message to determine of the sentiment of the proposed message is positive, neutral, or negative. Identifying that the proposed message is positive, neutral, or negative may enable the user to direct discussion in a preferred direction. For example, if the user is proposing an idea that the user desires others to support a positive message may be more effective. In another example, if the user is opposing an idea, the user may desire a negative message to indicate a dislike or distrust of the topic of the message.

The method digitally receives, from the sentiment analyzer, the finalized sentiment computable from the set of published messages. The sentiment analyzer may analyze a set of published messages to determine the sentiment of a target group such that a user may embrace or oppose the overall sentiment of a target group.

The method digitally queries, via a processor, the tone analyzer for an emotion tone computable from the proposed message and an emotion tone intensity computable from the proposed message, the emotion tone selectable from a group consisting of joy tone, sadness tone, anger tone, disgust tone, and fear tone. The tone analyzer may analyze the tone of a proposed message based on the joy, sadness, anger, disgust, or fear tones used in the message. A message may contain multiple tones indicating both anger and discussed for example.

The method digitally queries, via a processor, the tone analyzer for a social propensities tone computable from the proposed message and a social propensities tone intensity computable from the proposed message, the social propensities tone selectable from a group consisting of openness tone, conscientiousness tone, extroversion tone, agreeableness tone, and emotional range tone. The tone analyzer for social propensities may measure a number of attributes of a target audience based on messages from the audience or messages to which the audience has responded. An audience may be open to new ideas or particular topics. An audience may be conscientious about particular social topics. An audience may be eager to interact as compared to other target audiences. An audience may be prone to agreeing with particular topics or people. An audience may be prone to emotional issues, approaches, or responses. By measuring the social propensities of a target audience a proposed message may be tailored to reach that audience.

The method digitally queryies, via a processor, the tone analyzer for a language tone computable from the proposed message and a language tone intensity computable from the proposed message, the language tone selectable from a group consisting of analytical tone, confident tone, and tentative tone. The tone analyzer for language tone may analyze as to whether a proposed message has an analytic tone, a confident tone, or a tentative tone. An analytic tone would tend to use facts, logic, reason, or statistics to justify a particular point of view or to validate the message. A confident tone would indicate that the user of the proposed message is confident of their position, and may not need the analysis another user made to justify their position. A tentative tone may indicate that the user is unsure of a particular topic or is being guarded as to a particular point of view.

The method digitally receives, via a processor, from the tone analyzer, for the proposed message, the emotion tone, emotion tone intensity, the social propensities tone, the social propensities tone intensity, the language tone, and the language tone intensity. The emotion tone of the proposed message indicates the social propensities, language, and language intensity. The tone analyzer may provide information to match a proposed messages tone with the preferred tone of a target audience.

The method digitally queries, via a processor, the sentiment analyzer for a sentiment computable from the proposed message, the sentiment selectable from a group consisting of a positive sentiment, a neutral sentiment, and a negative sentiment. The sentiment of the proposed message may be used to either match a target audiences sentiment or to influence the sentiment of the target audience for the topic of the message.

The method digitally receives, via a processor, from the sentiment analyzer, the sentiment for the proposed message. The sentiment of the proposed message may be used to compare with the sentiment of prior published messages to identify how a target audience will respond to the proposed message.

The method digitally analyzes, via a processor, the proposed message by computing a proposed message lingo score for the proposed message and a proposed user posting frequency for the proposed message. By analyzing the message lingo score and user frequency of a proposed message, the proposed message may be posted at the time to greater increase its effectiveness in reaching a target audience.

The method digitally compares, via a processor, the finalized lingo score with the lingo score of the proposed message. By comparing the finalized lingo score with the lingo score the proposed message the effectiveness of the proposed message compared to historical data may be identified. Changes to the proposed message may then be made in order to improve or alter the effectiveness of the proposed message.

The method digitally compares, via a processor, the finalized posting frequency with the posting frequency of the proposed message. By comparing the time interval from the prior message with the frequency of the set of published messages a frequency may be determined to help identify if a target audience has sufficient data, effective data, or too much data for the regular consumption of the target audience.

The method digitally compares, via a processor, the finalized emotion tone with the emotion tone of the proposed message. By comparing the emotion tone of the proposed message with the finalized emotion tone the proposed message may be altered to better match the emotion tone of the finalized group, or may be altered to alter the overall tone of a target audience.

The method digitally compares, via a processor, the finalized emotion tone intensity with the emotion tone intensity of the proposed message. Comparing the finalized emotion to own intensity with the emotion tone intensity of the proposed message allows the method to identify when a proposed message is either weaker or stronger than other messages at the target group. By altering the weakness or strength of the message, the method may influence the engagement with the proposed message.

The method digitally compares, via a processor, the finalized social propensities tone with the social propensities tone of the proposed message. The social propensity tone of the proposed message compared to the finalized social propensity tones may help the method to identify the receptiveness of a target audience for the tone of the proposed message.

The method digitally compares, via a processor, the corresponding finalized social propensities tone intensity with the social propensities tone intensity of the proposed message. By comparing the tone intensity of the proposed message with the finalized social propensity tone the method may identify whether a proposed message is too strong or too weak in a social propensity.

The method digitally compares, via a processor, finalized language tone with the language tone of the proposed message. By comparing the language tone of the proposed message with the finalized language tone the effectiveness of the proposed message and matching the language tone of a target group may be identified.

The method digitally compares, via a processor, the finalized language tone intensity with the language tone intensity of the proposed message. The language tone intensity of the proposed message compared to the finalized language tone intensity may indicate a message that is either too strong, or too weak, for a target audience.

The method digitally compares, via a processor, the finalized posting frequency with the posting frequency of the proposed message. Messages are posted too frequently may be optimized out, or ignored, by users or social media platforms. By monitoring the frequency of prior messages a sort of resonant frequency for message posting for a target audience on a target platform may be identified. The proposed message may be delayed in order to match the frequency that is calculated to be the most effective at reaching a target audience.

The method digitally identifies, via a processor, a number of message issues, of the proposed message, changeable to increase the value of the predicted engagement score of the proposed message. By identifying a number of issues with the proposed message that can be changed, and potentially proposing those changes, the method can enable a user to better understand potential effects of a proposed message.

The method may include digitally managing a persona by identifying, via a processor, an optimal target lingo score, an optimal target posting frequency, an optimal target emotion tone, an optimal target emotion tone intensity, an optimal target social propensities tone, an optimal target social propensities tone intensity, an optimal target language tone, an optimal target language tone intensity, and an optimal target sentiment, for a target audience, the target audience identifiable by at least one characteristic selected from the group consisting of occupation, role, gender, age, geographic location, political party affiliation, marital status, status as a celebrity, status as a politician, status as political candidate, type of political opinion, and religious affiliation. By managing the persona, the method can include strengths and admirable attributes of a user's public persona. The method may also use weaknesses in the person's public persona and alter messages to strengthen the weaknesses in the opinions of the target users.

The method of claim 1, further comprising instructing an output device to display the at least three lingo subscores selected from the group consisting of a hashtag subscore, a mentions subscore, an abbreviation subscore, a post-link subscore, an emoji subscore, a jargon subscore, an emoticon subscore, and an all capital letters subscore.

The method may identify, via a processor, a number of synonym phrase, the number of synonymous phrases having the same denotation as the target phrase while having a different connotation, the different connotation influencing the tone intensity. Synonymous phrases may have stronger or weaker lingo subscores altering the perception of the proposed message. For example, one phrasing may indicate a high level of anger which is distasteful to a target audience. A synonymous phrasing may be suggested with a lower anger subscore to more effectively reach the target audience.

The method may optimize the lingo score of the proposed message by identifying, via a processor, a number of linguistic additions and a number of linguistic deletions. A lingo score may be altered by adding or deleting particular words to affect the lingo subscore. By using or deleting jargon associated with the topic the lingo subscore may change to better match a target audience.

The method may optimize the subscore comprises adding a number of hashtags, emoticons, or capital letters to improve a subscore of the target message. hashtag subscore, a mentions subscore, an abbreviation subscore, a post-link subscore, an emoji subscore, a jargon subscore, an emoticon subscore, and an all capital letters subscore. The method may add a number of hashtags, emoticons, change words to capital letters, mention other users, add or remove abbreviations, add links to other topics, messages, articles, or post to optimize subscores of the proposed message.

The method may delay publication of the target message to match the target posting frequency. When the method identifies that a user is posting messages more frequently than the target audience can consume the method may delay the publication of a proposed message. This delay may allow the message to obtain a better residence with the target audience.

The message may be at least one selected from a group consisting of text, image, audio, video, and an image with text embedded. Images may include embedded text or messages known as “memes”. Text, images, audio, video, and means may be effective with different groups and others. For example one group may prefer memes, while different group may prefer videos.

The method may monitor, via a processor, a reach metric of the target message after the target message is published. The reach metric of the target message may indicate that a desired level of engagement related to a particular message has been reached.

The method may monitor an effectiveness of a target message by monitoring a plurality of a frequency metric, volume metric, engagement metric, and saturation metric of the target message, wherein frequency measures the time between posts, volume measures the size of conversation about the target message, engagement measures a number of social media reactions to the target message, and saturation measures when engagement patterns of the target message indicate that the engagement patterns have decreased below a minimum engagement threshold. By monitoring target messages a user may measure in real time the interaction with the target message and determine if that particular proposed message has reached a saturation point.

An apparatus for generating persuasive rhetoric for a social media participant includes a processor, a network interface card, a display, an input device, and a non-transitory storage medium, the non-transitory storage medium containing computer program instructions, the computer program instructions causing the apparatus to perform a task.

Instructions for a target engagement scorer instructions digitally computing a target engagement score for a set of published messages, the target engagement score measuring the interactions with the set of published social media participants, target lingo scorer instructions digitally computing a target lingo score from the set of published messages published by a categorized group of social media participants, wherein the target lingo score comprises a plurality of coefficients of variation for at least five lingo subscores selected from the group consisting of a hashtag subscore, a mentions subscore, an abbreviation subscore, a post-link subscore, an emoji subscore, a jargon subscore, an emoticon subscore, and an all capital letters subscore, target posting frequency identifier instructions digitally computing a target posting frequency from the set of published messages published by the categorized group of social media participants, wherein the number of social media participants belong to a number of categories, wherein the category is selected from a group of categories comprising an occupation, a role, a gender, an age, a geographic location; celebrities, politicians, candidates, political opinion, females, and males, digital tone requester instructions requesting that a tone analyzer identify a predominant tone and a corresponding tone intensity for the set of published messages, the predominant tone comprising a communication tone that is categorized into at least one joy, sadness, anger, fear, analytical, tentative, and confidence and the corresponding tone intensity representing a numeric value indicating the strength of the predominant tone, digital tone receiver instructions receiving the predominant tone and the corresponding tone intensity from the tone analyzer, digital sentiment receiver instructions requesting that a sentiment analyzer identify a predominant sentiment for the set of published messages, the predominant sentiment comprising at least one of positive sentiment, neutral sentiment, or negative sentiment. target message analyzer instructions analyzing a target message by digitally computing a message lingo score, a posting frequency, a message tone, a message tone intensity, and a message sentiment, and, a message lingo scorer instructions comparing the message lingo score, the posting frequency, the message tone, the message tone intensity, and the message sentiment to the target lingo score, the target posting frequency, the predominant tone, the tone intensity and the predominant sentiment to identify a number of message issues that may be changed to obtain a designated target result.

The apparatus may include instructions for a target message receiver instructions for receiving a target message from a user using the input device. These instructions would allow a user to input a proposed message into the apparatus.

The apparatus may include instructions for a score presenter instructions for presenting a target lingo score and at least three subscores selected from a group consisting of from the target lingo score, the hashtag subscore, the mentions subscore, the abbreviation subscore, the post-link subscore, the emoji subscore, the jargon subscore, the emoticon subscore, the all capital letters subscore, the target posting frequency, the predominant tone, the tone intensity, the sentiment. The subscores may be used to measure attributes of a proposed message against attributes of a previously published set of messages.

The apparatus may include instructions for target score presenting instructions, presenting a target score for the scores presented from the score presenter. By presenting target scores to a user, the user may alter the message to obtain a target score that improves the effectiveness of the proposed message in reaching your target audience.

The apparatus may include instructions for a synonym identifier identifying a number of synonyms for phrases or words in the target message where the number of synonyms improve the presented scores. Synonymous phrases may maintain the same denotation, will altering the connotation. The altered connotation may affect the lingo subscores increasing the effectiveness of the proposed message in reaching a target audience.

The apparatus may include instructions for a hashtag identifier to identify a number of hashtags, based on the target message, that improve the hashtag subscore. By adding, deleting, or changing a number of hashtags the target audience may be better reached.

The apparatus may include instructions calculating a target score based on a target audience of the target message. The target score may be calculated using lingo subscores associated with a target audience or with other users that are effective with a target audience.

The apparatus may include instructions for a user target identifier to receive, from a user, a target demographic, a target demographic comprising at least one of an occupation, a role, a gender, an age, a geographic location; celebrities, politicians, candidates, political opinion, females, and males.

The apparatus may include instructions to identify historic target the target demographic including at least one of an occupation, a role, a gender, an age, a geographic location; celebrities, politicians, candidates, political opinion, females, and males based on prior messages.

The apparatus may include instructions that combine receiving, from a user, a comprehensive target demographic, a user target demographic comprising at least one of an occupation, a role, a gender, an age, a geographic location, celebrities, politicians, candidates, political opinion, females, and males and identifying the target historic target identifier identifying the target demographic comprising at least one of an occupation, a role, a gender, an age, a geographic location, celebrities, politicians, candidates, political opinion, females, and males based on prior messages. By combining user input with computer-generated historic targets the apparatus may maintain contact with the historic base of the user or expanding the user space to reach a new and additional target audiences.

With the proliferation of social networking, parties that wish to influence elections or opinion are challenged by not being able to see their audience. Computer tokens have taken the place of body language to express opinions. Rather than an audience laughing, individuals may use emoticons or abbreviations to express emotions. The use of computer codes instead of body language may inhibit the flow of communication. Speakers who do not know how to use or interpret such computer codes and social media language (lingo) cannot communicate effectively or persuasively. The invention serves as a tool to help users generate the right persuasive language to use when communicating with followers or listeners so that they engage with the speaker or the content or both.

A social persuasion score may be calculated. The following equation may be used by the system: [[Content+Volume/Population+[tone {engagement (frequency/time)} ] ]/Sentiment (Positive−Negative)=persuasion]]

The social persuasion score (SPS) may be calculated to report the amount of persuasion of individual tweets. In order to calculate the SPS, volume which is represented as Tvolume may be calculated by summing the total amount of tweets the user has tweeted up to the tweet being analyzed. Reach, which may be represented in the formula as R, is the amount of followers one has at the current time the tweet is sent, divided by the total number of Twitter users during the same time. Tone, which may be represented as T, may b e a score ranging from 0 to 1 on 13 different categories of tone which are divided into three groups: Emotional, Language, and Social Personality. The current formula may take the sum of the dominant tone in each three subgroups. This may therefore yield a potential tone score of 0 to 3. Engagement, which is represented by E, may be a measure of the response of the followers. This may be calculated by taking the sum of all retweets, comments, and mentions of the individual tweet divided by amount of followers. Tweet Frequency may also be used in calculating social persuasion and is represented as FTime. This calculation may divide the amount of tweets posted that day divided by 24. This may yield the average amount of tweets posted during that specific 24 hour period. Sentiment may also be calculated as is represented as Ssentiment. The calculation of sentiment may be the number of total tweets−the number of negative tweets, or the number of total tweets−the number of negative, to give a positive score or vice versa, the total number of tweets−the positive or the total number of tweets−the number of positive tweets to give us the negative sentiment. The dominant value may tell us the value and its difference may be used in the equation. Net Sentiment—whether perception of the tweet is positive or negative. As represented above and further described in the text, the social persuasion score may be calculated by multiplying tweet frequency by engagement and tone, then this product may add the amount of reach. Next this new numberic value may be multiplied by total volume. Finally, this product may be divided by the mean value of the dominant sentiment.

The method uses an algorithm to calculate a predicted Social Persuasion Score (SPS) for a planned or published message. The method may be applied to a module or type of apparatus, such as an Artificial Intelligence Engine to assist the user in altering their tone when engaging with followers or the public on a social media platform. The purpose of the SPS score is to maximize follower engagement based on the content of the planned or published message. First, the user will input content. Second, the apparatus or module will extract and read the content according to the algorithm. Third, the apparatus or module will analyze the content according to the algorithm that is based on a set of four variables. The critical variables include tone, sentiment, lingo and pulse. The apparatus or module will then compute and produce two raw scores based on the algorithm. The first score will be the control SPS score for the basic content provided by the user. The second score will be the maximum possible SPS score, based on the highest iteration of difference from the first score, that could be achieved by the content, if communicated differently. The module or apparatus will suggest an alternative that yields an optimal SPS score. The user will then have the option to select the original or the alternative. If the user selects the original, the apparatus or module will retain the first score and the iteration of difference from previously published content. If the user selects the alternative, the apparatus or module will replace the first score with the second score and update the iteration of difference from previously published content. The equation for SPS is: (SPS)=((Content+Volume)÷(Population+[tone {engagement (frequency÷time)}]))÷Sentiment (Positive−Negative).

Content=number of characters for proposed message, for example 155 characters

Volume: May calculated by summing the total amount of posts the user has posted up to the post being analyzed.

In simpler terms: {(t×e)/s}=P, that is to say: A tone score multiplied by an engagement score)/(sentiment value)=a persuasion formula value.

Run the Z factor on the Reach and drop out the outliers; measure of statistical effect size to judge whether the response in the group is enough; the constant factor may be 99%.

In simpler terms: {(t× e)/s}=P, that is to say: A tone score multiplied by an engagement score)/(sentiment value)=a persuasion formula value.

The apparatus, methods, and systems described may examine computer related codes, such as emoticons, reactions, shares, and comments to enable a user to better understand a targeted audience.

The apparatus may analyze persuasiveness in social media content as it relates to voting and campaigning on a social media platform. Persuasion is the measure of how effectively a user in the role of a speaker (leader) uses their social media voice, as measured by tone, sentiment, lingo and pulse, to convince another user in the role listener (follower) to participate in the dialogue published or shared by the speaker based on follower engagement in the form of follower likes, replies, comments, and shares.

Social Media Platform™, a social media platform, and its messages (posts) serve as an example to portray how the apparatus may operate. The apparatus may analyze the tone of social media content as it relates to voter outreach and engagement and may contain a cryptocurrency payment and reward system that rewards social media tokens to a user for allowing another user to use the latter's social media network to increase engagement, while actual engagement is also awarded alternative rewards.

Today, the digital economy and the rise of the Internet of Things (IoT) has a vast distribution, social, economic, political influence on the psychology behavior of an immense part of the human population. IoT is a network of physical devices embedded with electronics that enable them to interconnect and exchange data over the internet. Even with IoTs, leaders may ineffectively engage in many social media platforms by paid, earned, or owned media creating undesirable “social media noise”. This invention allows users to engage other users effectively with an optimal social media voice.

Organizations may look at the analytics of the data of their audience to understand their return on investment (ROI), return on followers (ROF) or return on message (ROM). Each of these classifications creates a total engagement metric part of the social persuasion score and is in aggregate, a return on engagement (ROE). Post Conversation Rate (PCR) is the number of posts (p) divided by the number of comments (c) or PCR=p/c. Post Amplification rate (PAR) is the number of post divided by the number of reports (rps) or PAR=p/rps. Applause Like Rate (ALR) is the number of posts divided by the number of favorites (hearts) (fv) or ALR=t/fv. The audience who responds or listens on Social media platform are called followers. Followers respond to the speaker and their tone, in at least three ways: emotionally, socially and languistically. The speaker of the message is a leader that a follower may follow on that social media platform. A leader who speaks with a tone in their style can produce a chain or pulse approach to reaching followers in their network based on the frequency with which they communicate. ROI, ROF, ROM, ROE are all metrics of SPS.

According to one example, a system for analyzing social media content is disclosed; the system may use various modules to generate a social persuasion score. The system may be used to analyze unpublished social media content, predict its persuasiveness, and provide suggestions or actual corrections to the content. The system may analyze tone, and provide suggestions for rewording content or for taking certain actions, or both, based on the tone of content.

Social media platforms may create decentralized communication that shifts control of information to followers. This is the social media leader's personality, or voice embraces a mental leadership model. That model is a centralized form of electronic communication (as Web sites for social networking and microblogging) through which users create online communities to share information, ideas, personal messages, and other content on a social media platform.

The leader may record his or her communication, such as posts, between at least two dynamic parties in a system that forms a feedback loop, which may include a leader, who may also be a writer, and a number of followers, who may also be a reader. Use of the apparatus may benefit a leader by increasing the leader's efficiency at using social media to achieve goals, variableness in presentation, and to help the leader permanently evolve as a leader. The apparatus may use an artificial intelligence engine or other type of module to assist a user in altering their tone when engaging with followers or the public on a social media platform; the apparatus may calculate an initial Social Persuasion Score (SPS) for a planned communication or published communication.

Social Persuasion Score (SPS) is an index based on a Social Media Voice (SMV) Algorithm ranging from −100 to 100, or a different set of numbers in tens such as −1000 to 1000 or 0 to 10 or −1 to 1. SPS is a proxy for gauging a message sender's overall influence on a receiver's engagement with the message over time. The Persuasion Score Accumulator may determine the total value of the interaction of content by each of these three nodes or one of the three nodes:

### Writer=Reader

### Speaker=Listener

### Leader=Follower

SMV is the measure and direction in which a leader communicates information digitally across the world and in this new digital economy. A leader may have one SMV. A leader who posts content with SMV, using intentional tone, may increase engagement with followers. SMV may consists of the following variables: (1) tone; (2) sentiment; (3) lingo; and (4) pulse. SMV may refer to the creation of meaningful messages and message maps that direct a company in its interactions on SMPs. SMV may help users create engaging messages and message maps to direct a brand in interactions with followers across SMPs. Leaders and organizations that wish to prosper on social media platforms, or business in general, may need to showcase their brand by using a “natural” online voice. This may be because SMV may be comprised of understanding the brand persona first, then suitable message tone, and lastly the intended language necessary to communicate effectually in each post made on the social media.

Definitions of Input Independent and Dependent Variables, Control and device(s) used for the Social Media Voice Algorithm used to determine SPS:

1. (a) Tone: Tone or dominant tone intensity may be the manner and attitude in which a message is delivered to evoke a specific response from followers or listeners or simply, the willingness attitude of a speaker or leader. Tone intensity, which may be represented as T, may be a score ranging from 0 to 1 on 13 different categories of tone which are divided into three groups Emotional, Language and Social Personality. The system may take the sum of the dominant tone in each three subgroups. This may therefore yield a potential tone score of 0 to 3. Anything above 0.05 may be considered significant by the system. Dominant intensity may be the highest value from the range of 0 to 1. There may be at least seven types of tone that may be divided into two categories: emotional or language. Emotional tones may be (a) joy, (b) sadness, (c) anger, (d) fear. The language tones may be (e) analytical, (f) tentative, and (g) confident. Other tones may be added.
2. To help users enhance the persuasiveness of content, some embodiments may rely on an artificial intelligence engine such as the IBM Watson NLU, Sentiment Analyzer tool, which is a natural language understanding software that offers several application programming interface APIs for analysis of texts through a process known as natural language processing. IBM Watson™ is a computer system that answers questions and is capable of identifying a natural language's tone and sentiment. The IBM Watson™ NLU Sentiment analyzer tool is natural language understanding software that offers different application programming interface (APIs) for analysis of texts through a process known as natural language processing. Natural language processing uses AI and computational linguistics that maps the interaction between computers and human languages. Watson™ and NLU provide unique analyses of tone and sentiment. They may each have distinct algorithms to predict tone and sentiment accurately without confounding one another.
3. Some embodiments may use the model as a model to measure tone and sentiment because it demonstrated a high level of reliability and validity according to IBM scholarly research for quantifying other data. IBM Watson™ measures seven types of tone: (a) joy, (b) sadness, (c) anger, (d) fear, (e) analytical, (f) tentative, and (g) confident. These types are divided into two categories: (a) emotion, consists of joy, sadness, anger, and fear; and (b) language, which consists of analytical, tentative, and confident. Each type of tone comes with an intensity score ranging from 0 to 1. If a type of tone is not detected, the IBM tool will produce no score. The message will be given a score of 0 for that tone. If a message yields two or more types of tone, the highest value type of tone will be the dominant tone and will be used in later analyses.

### 4. (b) Sentiment:

5. (a) intensity: strength of text;
6. (b) polarity: whether a text is positive, negative, or neutral
7. Sentiment is the view, attitude, opinion or position taken toward a situation or event and can have a positive, negative, or neutral emotion. Sentiment may be positive, negative, or neutral. The intensity scale may range from −1 to +1. The direction of the sentiment is negative (a negative number indicates negative sentiment) and positive (a positive number indicates positive sentiment). The two variables for sentiment may be measured by intensity and direction. Sentiment may be calculated based on the number of total messages, minus the number of negative messages to give us a positive score or vice versa the total of number of posts, minus the positive to give us the negative sentiment. The dominant value may tell us the value and its difference is used in the equation. Net sentiment is the perception of whether the post is positive or negative. As represented above and further described in the text, the social persuasion score may be calculated by multiplying post frequency by engagement and tone, then this product may add the amount of reach. This value may then be multiplied by total volume and then divided by the mean value of the dominant sentiment. Followers and the leaders may have disagreeing sentiments, or sentiments that are at odds with each other which typically producing push or pull relationship. Sentiment analysis is the use of natural language processing to quantify attitudes about a certain topic.
8. (c) Lingo refers to language and linguistics, including the atypical practical social media language utilized by social media users to communicate on a social media platform. Lingo consist of the following components: (a) mentions, (b) hashtags, (c) abbreviations (RTs), (d) post links (URL), and (e) emojis; (f) emoticons; (g) capitalization and (h) punctuation. Each lingo variable may yield a score of 0 (does not appear in the post) or 1 (appears in the post). Lingo and pulse will be calculated with IBM SPSS, a software package for interactive or batched statistical analysis.

(d) Pulse: Pulse or social media pulse rate (SMR) is the average mean of the amount of time between posts in the social media feed and can be measured in hours or minutes. Burstiness is the transmission of data intermittently, in spurts, rather than a continuous stream. The formula for the coefficient of variation (CV) is:

Coefficient of variation=(standard deviation/mean) in symbols: CV=(SD/)

Therefore, each tweet within the same day may be assigned the same coefficient variation score yielding the fourth independent variable, pulse. Changes in pulse per day may be used to examine associations of tweet engagement. The formula for this calculation may be as follows: coefficient of variation=(standard deviation of tweets per day/mean number of tweets per day).
9. The formula for pulse may be as follows:

$$CV day 1 = \frac{SD day 1}{day 1}$$

10. (e) Frequency: divide the amount of posts for a given message in a given day by 24. This may yield the average amount of posts posted during that specific 24 hour period. The 24 hours period is illustrative in nature, and does not restrict a time period that the system may operate on.

Definition of Output Dependent Variables:

a. Engagement: Engagement (E) may be a measure of the response of the followers. This may be calculated by taking the sum of all likes, replies, comments, mentions or hashtags, votes and shares of an individual message over a specific time, divided by amount of followers. To increase engagement with SPS, a user must first understand and effectively use the linguistic taxonomy (lingo) of each social media platform. For example, on Twitter there are 15 types of tweets that a user would have to know how to use well. Second, a user needs to discover and introduce their brand or online social media personae. This is where a social “voice loop” may begin and the user can evaluate how she or her engages with the audience, reviews feedback and looks at the word of mouth (WoM) of responses based upon the content. Third, a user (leader) may need to leverage that self-expression and feedback loop in the form of his or her own engagement to get pure reciprocity of tone with followers. Engagement may cause persuasion because increased engagement tells a speaker that the SMV used was effective so the speaker just has to repeat that process. Examples of engagement in the invention include:

i. (a) likes: likes of each specific post which shows a user's appreciation for that post.
ii. (b) replies: a reply to another user's post or message using the reply icon
iii. (c) comments, mentions or hashtags
iv. (c) votes: an affirmative vote in favor of or against a campaign or candidate for a given voting booth.
v. (d) shares: reporting of another user's post.

Definition of Control:

a. Follower Growth: may refer to the number of followers who choose to follow another user account by clicking on the symbol or icon “Follow” button displayed on the user's account website or mobile application. Once this is clicked, it will change status to “Following” displaying an activation status of the relationship.

The apparatus may suggest a different planned communication with a different calculated SPS, referred to as the target SPS. The apparatus may automatically send the planned communication or replace a published communication with the planned communication; or in some embodiments, a human user may be required to confirm the suggested planned communication before the planned communication is submitted for publication at a social media platform such as Social media platform. For example, the apparatus may analyze a body of communications, such as published posts belonging to a single user's account, to determine a SPS, and then suggest a campaign with a plurality of proposed communications that may be generated to increase the likelihood of engagement. The frequency over time of communication, also referred to as a social media pulse, may be used to trigger persuasion that may evoke a sentiment of influence over the social media platform.

The apparatus may use an algorithm for calculating scores or adjusting the tone or sentiment such as:

1. the data is organized by a unique identifier (identifier, media_id, ad_id, etc.)

2. the row is checked for the post-SMV analysis flag and bypassed if true

3. the text of the row is captured by its platform's specific field (post_message, tweet_text, caption, etc.)

4. the text is submitted for analysis by tone, sentiment, emotion, persona

5. the text is parsed for hashtags, urls, emojis, mentions

6. supplementary data (such as emoji sentiment or hashtag popularity) is appended

7. a lingo score is calculated via an enum that assigns points for different types of engagement (likes, shares, comments, etc.)

8. the new data is appended to the row and exported to JSON for easy analysis

9. the JSON is parsed into SQL for persistence and efficient querying

The apparatus may be a computer-based system that may provide a user interface to a user; the user may interact with the interface or in some embodiments the computer-based system automatically analyses and posts social media content and the user may view diagrams or visual representations of the analyses or proposed social media campaigns; based on the desired level of interaction between the user and the system, the system may then act automatically or wait for user input before implementing one or more social media campaigns. Users may select a desired tone or a target SPS, and the system may then generate content, responses, or other suggestions of the types of content, such as videos, and target tone for the other types of content, which may include suggestions on how to present a video that may be more likely to evoke a target SPS.

The system may measure the tone of social media content over time, as well as resultant SPS, persuasiveness, and sentiment. Advantages of the disclosed system may include predicting which tone should be used to increase follower engagement or to increase the persuasiveness of social media content to a known, unknown or targeted population.

The system may be used for assisting a social media leader, or someone who aspires to become a social media leader, with publishing social media content using an intentional tone that is more likely to be persuasive to the leader's followers.

The system may also use algorithms and calculations before performing actions or suggesting a course of action; some of the algorithms or calculations may use, search for, or attempt to influence a correlation between the number of followers who like and engage, such as by reporting, and a predicted social persuasion score, which may also be termed a social media persuasion score (SPS).

There may be a correlation between followers who like and report, which may be termed engagement, which may generate a social media platform persuasion score that can be predicted.

The system, apparatus, or computer-implemented method may use quantitative methods or descriptive statistics. Descriptive statistics, for purposes of this disclosure, are brief descriptive coefficients that summarize a given data set, which can be either a representation of the entire population or a sample of it.

The following equation may be used by the system to calculate Social Persuasion Score (SPS):

(SPS)=((Content+Volume)÷(Population+[tone{engagement(frequency÷time)}]))÷Sentiment(Positive−Negative)xx

SPS may be calculated to report the amount of persuasion of individual posts. In order to calculate the SPS, volume which is represented as [Volume], may be calculated by summing the total amount of posts the user has posted up to the post being analyzed. Reach, which may be represented in the formula as R, is the amount of followers a user has at the current time the post is sent, divided by the total number of social media platform users during the same time.

Besides finding a tone, sentiment and lingo analysis, engagement metrics, time and frequency may be calculated to determine a social persuasion score of the data. The system may determine that tone is a separate and measurable metric from sentiment analysis.

The system may make the following assumptions. The leaders use of his tone increases persuasion with his followers. A leader's tone can predict the follower's engagement (RT & Likes) A leader's tone is directly correlated to the effectiveness of communication with his followers. Appropriate tone may increase sentiment analysis. Greater persuasion increases follower engagement. Lower persuasion decreases follower engagement.

For this disclosure as used in the present specification and in the appended claims the term “image,” used herein, refers to an electronic representation of a scene, object, or event.

As used in the present specification and in the appended claims, the term a number refers to one or more of an item; zero not being a number, but rather, the absence of a number.

As used in the present specification and in the appended claims, the term a plurality refers to two or more of an item.

As used in the present specification and in the appended, the term communication refers to the imparting or exchange of information.

As used in the present specification and in the appended, the term cryptocurrency refers to an encrypted, decentralized digital currency transferred and confirmed in a public ledger through mining or through the validation of a transaction. Specifically, cryptocurrency refers to a blockchain database of encrypted, digitally recorded data blocks of transactions stored across decentralized computer networks according to a pre-determined set of rules.

As used in the present specification and in the appended, the term social media leader refers to a social media leader is a user of social media with established credibility online in a specific cause, belief, principle, or organization. A social media leader has access to vast and influential followers. A social media leader engages these followers via a social media platform(s), which empowers the leader to amplify the popularity of his or her message. A social media leader has the power to persuade these followers by their dynamic engagement of their personal/professional tone: emotional, social, and language.

As used in the present specification and in the appended, the term Social media platformism refers to a brief character based statement in the form of opinion, declaration, remark or utterance made by a social media leader; in the shape of a post on the social media platform/online message service called Social Media Platform™; to followers who decision-making to engage are influenced and/or persuaded by the social media leaders emotional, social, or language tone.

As used in the present specification and in the appended, the term social media-ocracy refers to a philosophy that the society that governs us, is the rule of freedom, for followers to express themselves in speech and the rule of the majority followers to engage independently without the impact of prejudice by a virtuous leader.

As used in the present specification and in the appended, the term social persuasion score (SPS) refers to an index ranging from −100 to 100, or a different set of numbers such as −1000 to 1000 or 0 to 10 or −1 to 1, that measures the willingness of one or more followers to be persuaded by a leader. The SPS is a proxy for gauging of the senders overall influence on a receiver's engagement with the frequency over time with the message.

As used in the present specification and in the appended, the term Social Media Pulse (SMP) refers to the rate at which a user sends their social media message to their intended audience so that it resonates with their intended audience. Common persuasion techniques include: (1) reciprocity; (2) consistency and commitment; (3) social proof (assuming the actions of others in an effort to show the correct action or behavior to take in a given situation); (4) authority; (5) liking; (6) and scarcity. Pulse is usually called social media rate (SMR), which is the number of times messages are sent each minute (tpm). Effective persuasion relies on using the right convincing language and linguistic structure in a conversation to convey information to elicit a specific response. Influence is the power to change or affect a person and the ability to command or force that effect.

The rhythm in which content is presented allows users to be in sync with followers for messages that are weak or strong and is a simple way to see if the writer is in beat with the reader. Burstiness the intermittent increase or decrease in the speaker's frequency or activity of communicating content to listeners within a given time.

As used in the present specification and in the appended, the term tone refers to the expression or implication of a speaker's emotional state about the subject matter of a communication, that is, the speaker or leader's willingness to elicit a certain response from listeners or followers. Tone may be emotional or language-based. On that basis, the IBM Watson Tone Analyzer (see US20180203847) will measure seven types of tone for this invention: (a) joy, (b) sadness, (c) anger, (d) fear, (e) analytical, (f) tentative, and (g) confident. This is a major distinction of someone who is a social media leader (digital user or participant) and someone who is not. When leaders engage with tone they are able to use content or their language to social and emotionally connect with their writers. The tone of the leader allows them to help influence the sentiment and empower the listener. When combined, tone and sentiment allow a social media leader to build a strong tie with a follower, which in turn, can inspire follower engagement and action. In any social media network the theory revolves around the effectiveness of the relationship. When a leader uses his attitude in his own voice in the message they can and may be more persuasive to their follower then a third party agency, campaign manager, marketing department, intern, or someone who does not represent the same credibility of the leader. Leaders who embrace tone are more affective in their communication and their content enhances the behavioral action of both the leader and the follower. Tone is a tactical multiplier for engagement that can enhance the strength in which a message is delivered or distributed. Influential marketing is created by sentiment and popularity of the account. The sentiment can be negative, positive, or neutral. Persuasiveness, or persuasiveness scores, can be negative, positive, or neutral. The sentiment can be negatively persuasive, positively persuasive, or neutrally persuasive.

Understanding the Formula of Persuasion. The impact of tone on the social media platform account may be a factor for measuring the persuasion of the content being sent by a leader to a follower. In return, how the follower engages may determine the sentiment of the follower's reaction, as measured by the degree to which the followers redistribute the leader's social media content or to the degree at which followers add their own content to the leader's published content which may result in the followers influencing the leader's published content. (A tone score multiplied by an engagement score)/(sentiment value)=a persuasion formula value. When tone=t, engagement=e, sentiment=s, and persuasion=P, then the simplest way to determine persuasion may be the value of the {(t× e)/s}=P.

Key performance indicators (KPIs) of a social media leader's engagement with followers may be used to calculate that leader's communication performance by measuring and assigning values to the participation or engagement with the followers. These analytics may give insight on the speaker's message. Persuasion, however, whether persuasion is positive negative or neutral, may be a result of sentiment. So, the factors that may influence the content may only be measured after it has been delivered and engaged in persuasively. So, a user may identify the type of content or as an example, the type of post. Then, a user may understand what is measurable between the leader and the follower. Engagement may add to the formula's value to quantify an interaction on each type of call to action of persuasion that a leader wishes to make.

Social media leader “call to action” engagement may occur when a follower interacts with a leaders' content in such a way that it produces metrics. That engagement could create awareness, generate demand, driver adoption, interact with followers, and inspire evangelism for content. The content that is written may be termed the social media strategy, and the social media activity may be the response by which the followers that gives us fundamental social media key performance indicators for measuring persuasion. These KPI's then, in turn, help us measure the impact of social persuasion score of that content by a leader on Social Media Platform™ or other social media platforms.

When a social media leader creates and starts participating in generating awareness such as social aid verification of the account, branding their profile, writing a description, creating a social media platform handle may yield KPI's on impression and reach more followers on and produce a share of Voice (SOV) or Alternatively, top-of-mind awareness (TOM).

A brand is an online persona of a user on a social media platform. The online brand persona of an user will establish the existing role, title, position or influence of the user. The goal for users (acting in the capacity of a campaigner or leaders) on social media platforms (SMP) is to develop an audience online and SMP persona. Personas allow leaders to practice their ability to lead using the follower's sentiment, research, and validation to create an engagement loop and the adoption of more followers. Once leaders get an impression of their target audience and become aware of the optimal time and frequency with which to speak to their audience, they can maximize engagement, SPS and follower trust and loyalty. For example, if a user perceives an online social media brand as more friendly, trustworthy, or desirable copy must include a casual, conversation, or enthusiastic tone.

When a social media leader generates engagement of a target (define) persona audience with content, then the social activity would yield responses and KPIs of the number of engagements. The types of engagement may include: reach of message, the number of messages read, mentions, and hashtags engagements used to calculate the impact of persuasion.

When the social media leader drives the conversion, then the association activity of posts and the social KPIs of the clicks, posts may be used to determine the effectiveness of the persuasion.

When the strategy is to interact with the adoption of customers or users, then the social activity is that of responses specific to them rather and the social KPIS's of earned mentions and positive favorites may create a positive persuasion.

When a social media strategy is to inspire evangelism and target influencers, then the social activity of positive posts, favorites, likes and the social KPIs of the total posts and quotes and mentions that are positive may spark the largest impact of referral activity and positive work of mouth.

Posts can be divided up over the evolution of the timeline. The greater the time a post is on a social media platform, the highest yield it has to strengthen leadership. That content is based on the evolution of their participation. A leader may not be a persuasive overnight. a constant message keeps attracting more and more followers. This “persuasion momentum” is builds over time. The content, however, can be communicated in a number of ways in a post.

A leader may generate a number of types of social interactions. The following are examples of categories of messages:

Text posts: short text messages of text.

Hashtag messages: keywords that people use to find topics on social media.

Link messages: posting a link to a message to indicate a conversation about the post.

Video messages: followers can watch videos and react to them.

Image messages: animated images that allow users to reply and post.

Poll messages are one way to get content ideas from followers. Polls may be taken on a variety of topics from politics to reality shows.

Mention messages may contain a reference to account. (e.g.: “Hello @Social media platformSupport!”)

A leader may engage followers in a number of methods.

The interaction between both these social media nodes of the leader and the follower are defined on their network as the leader is the speaker and the follower being the listener. However, the listener, in this case, can engage in two direct ways to promote the message of the speaker. A leader can strengthen the persuasion factor of their messages by promoting their messages with paid advertisement or choosing to limit their persuasion to a private audience by creating protected messages where your public exposure of posts and mentions is limited.

A post may be shared or repeated. For example, posts in a timeline, a profile, and other profile pages on a social media platform. A comment may be shared directly, or a comment may be shared with an additional comment.

A quoted message may allow one user to quote another message and add a comment.

A protected message may restrict who can see the message. Protected messages may have limited viewing.

Promoted messages are messages where additional viewing has been purchased.

Promoted message may be labelled.

A reply message means to reply to a message from another user. A reply is when a response is made to someone else's message. A reply is associated with the original message.

A direct message is a type of reply that can only be sent to one of your public followers.

Every message has a structure. Within that structure lies clues on the impact of that message. To uncover and dissect the architecture of a message there are at least three components: language, social, and emotional. The study of pyscholinguistics opens up a new field of those processes when applied to social media. A social media leader who messages may have a meaningful impact on their followers if and when they use the right tone. Tone is by definition the voice on how the “character” of your leadership comes through in the words, in the case a message. It is not about what the words but the willingness impression it makes on everyone who reads your message. The text and the tone of voice may create a feeling of the leader's impression. The tone of a message may be communicated and may include all the words used in the message. Tone directs the listener to react in a certain manner to a message in a way that gives the leaders a unique voice. The tone may give a recognizable voice establishing a creditability of brand that allows the listener to identify with.

Use of tone is about using language to give a number of messages their own distinct and recognizable voice creating a pattern of consistency that followers can identify with. This consistency may create a social media pulse of content. Social media pulse may be a content that continues to influence and empower followers on a consistent frequency. Control of tone may be what creates the social media pulse. When and how to use it in sending a message. Patterns in social media may provide information about text, structure, and tone. The engagement of the followers determines the response of behavior from that message. In turn gives us the persuasive factor of the message. A message creates a sentiment which in turn, influences others and empowers a catalyst of change for others to take action based on the sentiment being positive, negative or natural.

Many leaders today don't use tone but rather create social media noise. When they place content with a variety of inconsistent tones, that may create confusion between messaging and purpose of their content. This is called Social media noise. Social media noise is content placed online that has no clear tone or purpose of its messaging. When social media leaders are able to embrace a tone they are able to persuade followers to take action and engage with them more affectively. This may create more influence for the leader. This may create a more powerful impact of the message for the leader.

The tone may be used to help tie in the content or text in a unique fashion that the reaction of the listener can change its emotional state by a single message. Tone of voice may be important to a leader's ability to persuade its audience. These patterns of tones can create patterns of the impact fullness of persuasion based on the engagement of that tone in the message and its tie to followers. The tone of a message can create a brand so that the leader's personality is recognizable to a target audience. This recognition may yield their sentiment to the leader's text in a way that makes them emotionally relate to their leader. When a leader uses tone and not the tone of third parties, advertising agencies, or third parties they may be able to distinctively connect with their listener to be more uniquely persuasive and not considered just a generator of social media noise. A feedback loop may be created when a leader uses the right tone and the audience reacts to that tone. The audience may then respond by sentiment and responds in their own tone. This may create a feedback loop that creates an organic momentum of social media pulse which in essence may help a post viralize. Diversity of content can trigger emotion and reach across all personas of the audience that becomes the leaders reach. This creates popularity of the content. This in the social media when multiplies by engagement can trigger viralization of the social feed of the content. Tone also creates a relationship with the leader and follower. It lays down a foundation of character and identity with the leadership establishing power of authority. Social media leadership tone can strengthen the contents clarity and comprehension in a clutter of social media noise. As more content is placed online in the forms of posts the more the leadership may be strengthened by the tone in which they use. This evolution may transform the language and may allow the effectiveness of the leadership to engage with his/her followers.

A leader who embarks on using their voice may, over time, find results of being more effective leader. (message+tone)×engagement=persuasion upon listeners or followers. This shows the audience who you are strategically as a leader, what your message infrastructure is, organizations of your message or messages and how you may communicate a user's personality with his or her followers. The ability to take the message and know that the outcome was successful in engagement merits a return to the account holder as well as to the messenger. This man be done in the following ways:

### 1. Cryptocurrency

### 2. Tokens

### 3. Credits

### 4. Points

5. Rewards points
6. Swag of services
7. In-kind contributions.

### 8. Bounties

In each of these 8 ways, a reward can be redeemed for a positive SPS or lost for a negative SPS depending on the desired outcome. A message can take a variety of forms:

### 1. Content

### 2. Text

### 3. Audio

### 4. Video

### 5. Virtual Reality

### 6. Mobile

7. Emojis (are graphics)
8. Emoticons (are pictorial symbols that represent facial expression that a user uses on a messaging platform to express emotion through using characters symbols).

Content is the written, text, picture, video, virtual reality, photo, gif, animation, and/or sound that is displayed on the social media networks that humans are interacting in. Message is the result of the act of posting content. A social media participant generates a message, and the content of that message is displayed as a post within a social media platform. The interactions with this content is known as a form of engagement. Social media engagement is measured by analytics. But with vast amounts of data of content, it is nearly possible to know what is working and what is not. This apparatus will aide in solving this challenge and enable users to produce, measure, manufacture, synthesis, artificially create, suggest, and/or recommend engaging content by generating it in a real time, stored, application interface, cloud, mobile, laptop, desktop, tablet, virtual reality device and/or computer machine.

The outcome of persuasion can see be seen by:

1) Converting fiat into a currency
2) A marketplace exchange

### 3. E-commerces

4) Website services
5) Third party websites
6) Form of swaps for swag or other items

Tone structure in social media may be measured a number of different metrics. A message might contain several urban social media abbreviations that signify an expression in a form that can only be made using social media language or lingo. For example, abbreviations such as B4 means before, or LOL means laugh out loud. Word length, sophistication, nuance and popularity also serve as measures of lingo, especially. Shorter words can be more forceful and harder while longer words can be softer and more relaxed. Sentence length can also give shorter posts a concise or informal style or longer ones a more formal or dignified style. Word and sentence length can be measured with a letter and word count. The rhythm of a sentence also serves as a tone metric and signifies the tempo and frequency in which key words are stated in a given sentence. The use of keywords, then creates a pulse of ebb and flow. A word database may be assembled out of key words. Pronoun placement and usage may also serve as metrics and can be measured with names of places or things. For example, first person implies an immediately and personal positioning oneself to a group of people while third person more abstract detachment from followers. The use of jargon or specialized language specific to a particular professional domain like law, finance, politics, or engineering, is also a tone metric. (e.g.: Blue Dog Democrat, Dixicrat, False Consciousness, Kerratic or Yellow Dog Democrat.) Buzzwords are jargon terms that attract novelty are key words that are trending at that time. Clichés are words or phrases in a post that become worn out or overused. Where once fresh and unique words in the messages. The system may measure how often a user uses contractions, diction and colloquialisms as a metric under lingo. The system may measure and suggest against the use of obscure words that few people understand. Mistakes in grammar and misspelling may also be measured along with the use of emoticons, in frequency and type to interpret and relay specific meaning to an intended audience.

Social media platforms may evolve with technology. As social media platforms are exposed, developments may adapt this technology and invention to change.

The system may match tone to match a desired persona. Each audience targeted can be approached by targeting culture, customs, and even social currency. The etiquettes of social media influence perceived appropriate messages. The culture is based on where the message is targeted and which colloquialism, figures of speech or metaphors may be used.

The system may also incorporate the tone of others and give credibility to a message by mentioning another person as an authority or timely response to a reputable fact or figure. Utilizing someone else's tone to be embraced as your own is not only a high compliment to the original author or speaker of that message, but a way to give a message with more credibility by creating a brand. It is important that the tone be understood by the persona being targeted.

The system may analyze a sample social media posts from a single user or group of users and then may grade those posts with a SPS; the system may then compose new messages based on suggested content, and a third party, may then use the system to post content on behalf of the single individual or a group of individuals wherein the content may be predicted to have the same or similar tone as the social media content published by the single user or group of users.

The tone analyzer will convey a speaker's intended attitude or stance for a message. Tone volume is adjusted to two main groups: audience and the situation. So, the content of a message and how it is said can be different when audience personas or situations are different.

Tone is affected by pulse or the frequency of the content deployed over a period. Sentiment is a reaction from the listener (follower) and the situation the speaker writes by choosing the words and sentences to convey tone. Tone can br informal, formal, logical, emotional, intimate, distant, serious or humorous. The sentiment is the inclination of the listener's opinion of the content. which can be positive, negative, or neutral and is evident in the brand reception, rant detection, popularity, perception, or reputation. The system analyzes sentiment to identify the polarity of the audience's reaction to the content and informs the speaker of how engaging a message is relative to the impact of the speaker's tone in order to help a speaker communicate more persuasively to followers or to be empowered to take action.

The tone may be calculated by the structure of the content. Content can consist of text that is long, short, complex simple or a combination of anyone of them. The social media leader tone generator will help suggest tonality, lingo, pulse and sentiment for speakers to use in the messages that they communicate to followers so that their message is more persuasive engaging.

The system interprets, measures and generates a tone that adapts and changes to suit the audience and the situation based on the user's preferences and selected options (e.g.: business entity speaker, intended audience, joyful tone, positive sentiment, optimal positive engagement, celebratory situation).

The system also accounts for the use of pitch in language as a metric of tone to distinguish lexical or grammatical meaning—that is, to distinguish or to inflect words. All verbal languages use pitch to express emotional and other paralinguistic information and to convey emphasis, contrast, and other such features in what is called intonation, but not all languages use tones to distinguish words or their inflections, analogously to consonants and vowels. Languages that do have this feature are called tonal languages.

A social media platform itself can also be programmed to trigger persuasion when the leader engages with the right tone when he evokes engagement and influence over that same network. A leader on such a platform can take a chain approach to tone to reach followers based on a distributed and decentralized communication model that shifts power back to the follower. This social media leader personality or voice, embraces a mental model that is open, on a distributed social media platform (social media platform) and can record his/her communication (posts) between two parties: that of a leader and that of a follower.

Leaders are struggling to keep up with the changes of technology and innovation to communicate with followers effective and their organizations demand no less. Many leaders have avoid the unknown and do not embrace technology as part of their leadership style especially because technology may be unfamiliar to them, not easy to learn or navigate. This invention helps leaders rely on mental models and on technology as a tool to help leaders effectively communicate and engage with followers.

A persuasion metric or score can give insights by showing optimal tone, pulse, relevance, lingo and sentiment to for optimal engagement. Social media systems thinking can best illustrate this is the art and science of making reliable inferences about online behavior within social media networks by developing an increasingly deep understanding of underlying technology, User (UX) Interface, and digital design infrastructure. Cultivating this knowledge of likes, post, leads to the routine use of RIGHT mental models that see the Internet world as a complex system whose SOCIAL behavior is controlled by its dynamic structure, which is the way its feedback loops interact to drive the system's behavior/user.

Social Media Systems thinking is the first visible step in system dynamics which may eventually lead to similar models of this invention for each major social media platform like Facebook™, Social Media Platform™, Instagram™, LinkedIn™, YouTube™, Google+™, and even Snapchat™.

Social Media Platform™ may be used as an example. The two variables of Internet Population (the posts) and Social Media Activity (engagement) form a feedback loop. The third variable, internet penetration, is a constant. The population is what is called a “stock,” so it is a box. It accumulates what flows into it minus what flows out of it. In this case, there is only flow into Population, the straight arrow. The little valve icon is a rate; it equals Population multiplied by the Social Media Activity.

The ecosystem of Social media platform or what is known as the Social media platformsphere, is a microblogging service for users to post or message other users about any topic within a 140-character limit and follow others to receive their posts. The inventor conducted the first quantitative study on the entire Social media platformsphere and the social media relationship between a leader and followers impact of tone upon its value to influence other followers to create a feedback loop of engagement causing persuasion and that study, which is pending completion and publication, is a significant basis for this invention and is incorporated herein by reference pending. By looking at psycholinguistics the system finds the right words to express what a message. That interaction with those words is measured in three categories: conversations, amplification, and applause. Each of these classifications creates a total engagement score that is part of the SPS. Conversation rate (CR) may be the number of posts (t) divided by the number of comments (c) or t/c=CR. Amplification rate (AmR) may be the number of posts divided by the number of reports or t/rts=AmR. Applause rate (ApR) may be the number of post divided by the number of favorites (hearts) or t/fvs=ApR.

The dynamic decision for a leader to engage with its followers in a persuasive matter is proven by his/her presence on the social media platform. This formulation of creating awareness is the first step. The second step is the introduction to the social community by brand, discovery or interruption by the content or the leader's voice. This is the beginnings of the “persuasion loop” (helps determine the score) that then leads to the evaluation step where the leader engages with other experts, reviews feedback and looks at word of mouth (WoM) of responses based upon the content. Then, the leader must leverage this self-expression and interaction of feedback in the form of replies and mentions, which is pure reciprocity, to what is the leader's tone with his or her follower. In this way, leaders are developing an audience online with their social media platform persona that the leader is resonating with. Based upon these interactions leaders use the practice using their social media voice and have instant validation of positive engagement and persuasion so they adopt more and more followers. This is the exercise phase of persuasion where leaders get a sense of the social media pulse of their audience. As a result of strategic targeting and practice with using social media voice, a leader is able to build loyalty that is divided into friends and foes. Friends are loyal advocates who tend to have positive sentiment and commitment toward the leader's messages. Foes are passive listeners who tend to have neutral or negative sentiment and no commitment to the leader's messages. In either case, the leader is establishing a stronger bond with the audience that leads to the audience's willingness to allow the leader to use their content, tone, and engagements with the right sentiment and causes followers to take action or calls to actions which can create a persuasive metric, called the SPS.

Social media culture gives value to engagements to create social media currency that, in turn, allows users to adopt social media customs to be more persuasive.

Social media is has emphasized follower-centric leadership. This crowd power mobilized can create positive or negative change. That change threatens leaders who do not participate in this loop of social freedom of speech; this is social mediocracy. Social mediaocracy is the philosophy that society governs the rule of liberty for followers to express themselves freely and the rule of the majority of followers is to engage independently without the impact of prejudice by a virtuous leader.

The apparatus creates a map of users in a number of social networks. First, users configure their place on the social media platform (establishing their avatar), then find the ability to find the right social media dynamic alignment. This alignment occurs when their online and offline message is the same tone in terms of competency and capabilities. Second, leaders understand that there is a need to create a new identity on social media and can embrace their capabilities of producing content with the tone of voice. Third, leader can amplify a conversation by the distributing it among different channels of technology like a laptop, mobile, television, tablet and social media platforms to create a momentum of applause through likeability. The leaders who align with this dynamic (amplification, conversation, and likeability) may also ideally correspondingly increase what the performance of the linguistic demands based on audience and situation. The more content placed over a period strengthens the tone, and the more technology innovates, the more it may force a leader to creatively generate tone. In both scenarios, leadership may evolve, and tone may evolve as more content and innovations are placed on these social media platforms.

Leaders create feedback loops focused on the world around them and are constantly seeking opportunities to sustain the effectiveness of their tone. They may produce a continuous tone that may change the response of their followers. Because of social media and its decentralized nature and strong shared culture, it is easier for leaders to spot opportunities in the changing world and act proactively and decisively to capitalize on a new design of power via social media. Social mediocracy gives rise to the new model of change and forms a chain of a complex set of connections between leaders and followers: configuration of power, competency of content, and the capabilities of strategic tone.

Purpose and Contributions:

The invention uses the IBM Watson™ Tone Anayzer and Natural Language Understanding (NLU) (https://www.ibm.com/cloud/watson-natural-language-understanding/details) as a basis for which to measure tone and sentiment because it demonstrated a high level of reliability and validity according to IMB scholarly research for quantifying other data. Natural language is imputed/data mined into the software algorithms, which recognize features such as punctuation; n-grams (bigrams, trigrams, unigrams); emotions; greetings; curse words; and sentiment polarity to categorize various emotion groupings. Watson™ and NLU provide unique analyses of tone and sentiment. They each have distinct algorithms to predict tone and sentiment accurately without confounding one another.

### DESCRIPTION OF FIGURES

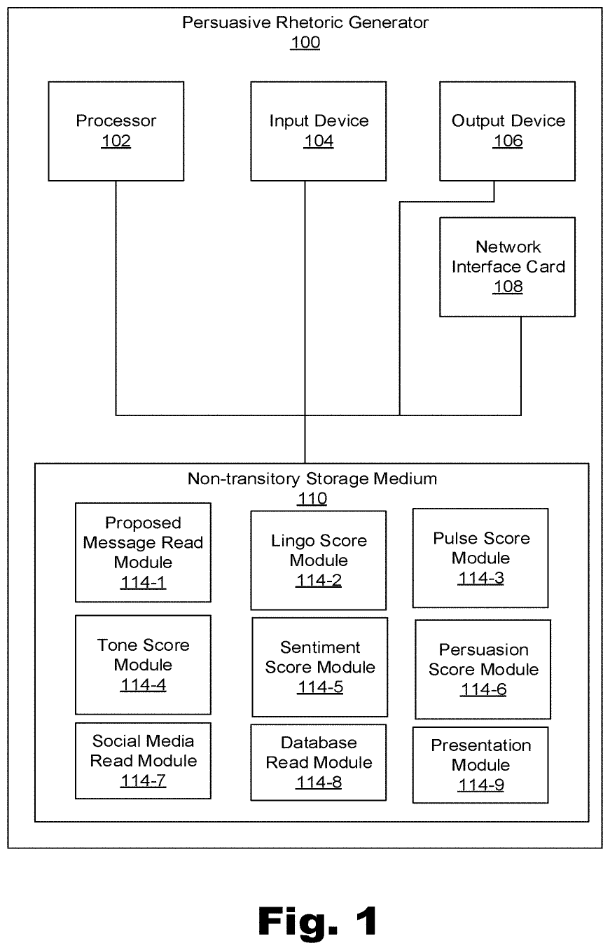

Referring now to the figures, FIG. 1 illustrates a persuasive rhetoric generator (100). The persuasive rhetoric generator (100) includes a processor (102), and input device (104), and output device (106), a network interface card (108), and a non-transitory storage medium (110).

The processor (102) causes the persuasive rhetoric generator (100) to perform a particular task. The processor (102) may execute a number of instructions stored in the non-transitory storage medium (110) to cause the persuasive rhetoric generator (100) to perform a particular task.

The input device (104) may receive input from a single device, such as a keyboard, or from a number of devices, such as a computer mouse, a touchscreen, a microphone, or a biometric reader. The input device (104) allows a user of the persuasive rhetoric generator (100) to provide instructions to the persuasive rhetoric generator as to what it should do. The input device (104) may receive input of a message that the persuasive rhetoric generator (100) may evaluate for a social media participant.

An output device (106) provides the persuasive rhetoric generator (100) a means whereby it can provide information to the user of the persuasive rhetoric generator (100). The output device may be a computer screen, a touchscreen, an audio output device, or other means to impart language and data to the user of the persuasive rhetoric generator (100).

The network interface card (108) may allow the persuasive rhetoric generator (100) to interact with other computing devices. The persuasive rhetoric generator (100) may interact with a nether computing device that contains a database of information harvested from social media networks. The information in the databases may be partially processed to enable the persuasive rhetoric generator (100) to efficiently search and process the information. The network interface card (108) may allow the persuasive rhetoric generator (100) to interact with a number of social media networks. The persuasive rhetoric generator (100) may interact with the social media networks both by reading post of a variety of social media participants, or directly posting a message from the user of the persuasive rhetoric generator.

The non-transitory storage medium (110) may store computer code instructions that instruct the processor (102) to cause the persuasive rhetoric generator (100) to perform a particular task. The non-transitory storage medium may consist of a computer hard drive or other types of mass storage devices. The non-transitory storage medium may include a number of modules (114).

The number of modules (114) cause the persuasive rhetoric generator (100) to perform a particular task. Though modules are illustrated as to the purpose and task the module may perform, modules may be combined, or may be divided into multiple steps, and remain consistent with the principles disclosed herein. The modules may contain software instructions, computer hardware, or a combination thereof.

As illustrated, the non-transitory storage medium (110) contains a proposed message read module (114-1), a lingo score module (114-2), a pulse score module (114-3), a tone score module (114-4), a sentiment score module (114-5), a social persuasion score module (114-6), a social media read module (114-7), a database read module (114-8), and a presentation module (114-9).

The proposed message read module (114-1) causes the persuasive rhetoric generator (100) to read a proposed message from an input device (104). The proposed message may be a message, such as a post, that the user of the persuasive rhetoric generator (100) wishes to post on a social media network. The proposed message read module (114-1) may read a proposed message from an audio input device and use voice to text translation to create a text-based message.

The lingo score module (114-2) may examine the contents of the proposed message to evaluate and score the language use within the proposed message. The lingo score module (114-2) may measure the linguistic lingo of a number of proposed messages based on the use of emojis, hashtags, mentions, post urls, abbreviations, emoticons, emojis, capitalization and punctuation. The lingo score module (114-2) may compare the linguistic usage within the proposed message against the linguistic usage of a number of social media post. The number of social media post may represent a target audience for the proposed message.

Lingo. Lingo is defined as the language, and social media lingo in this study refers to the different Twitter practical language utilized by users to communicate (Oxford Dictionaries, 2014). In this study, the term lingo refers to the practical language used by Twitter users. Social media lingo is a type of language that contains atypical language or technical expressions. The umbrella independent variable, lingo, consisted of five components: (a) mentions, (b) hashtags, (c) abbreviations like RTs (retweets), (d) post link or URLs, and (e) emojis (each defined in more detail below). Each component of the lingo variable yielded a score of 0 (does not appear in the tweet) or 1 (appears in the tweet). Lingo—the social media language, symbols, or lingo of the tweet—was measured by five variables: (a) the mention (@), (b) hashtag (#), (c) URL, (d) Emoji ( ) and (e) abbreviations (RT). FIG. 27 shows how each social media platform differs in its emoji representations.

The pulse score module (114-3) examines the frequency of messages of a user of the persuasive rhetoric generator (100). The pulse score module (114-3) may examine the frequency of messages from other users of the social network, including other influential leaders, participants, or followers of the user of the persuasive rhetoric generator (100). The pulse score module (114-3) may examine the frequency of post over a particular time period.

The tone score module (114-4) may examine and score the tone of the message including a message type, intensity, category of tone, and sentiment of a number of proposed messages of a producing speaker to a target audience. The tone score module (114-4) may categorize the message into a tone type or provide a numeric score evaluating the tone of the proposed message.

The sentiment module (114-5) scores the sentiment of a proposed message. The sentiment may measure the direction, emotion, characteristics, and user information of a message to determine a direction and the direction of a and the number of previously published messages. The sentiment module may, for example, determined that a proposed message deviates from the pattern of messages and the consistency of those sentiments.

The social persuasion score module (114-6) may combine the output of the lingo score module (114-2), the pulse score module (114-3), the tone score module (114-4), and the sentiment score module (114-5) to create a social persuasion score representing the effectiveness of each of a number of proposed messages so that the user of the persuasive rhetoric generator (100) may select a message that is persuasive to the target audience and continues with the desired message of the user of the persuasive rhetoric generator (100).

The social media read module (114-7) may read a number of messages shared by a number of different users on a number of different social media networks to inform the persuasive rhetoric generator (100) of the lingo, poles, tone, and sentiment of other users of social media networks both before and after the persuasive rhetoric generator (100) post a message from the user of the persuasive rhetoric generator (100).

The database read module (114-8) may read information regarding social media posts from a database. The database may include a number of raw social media posts, or it may include a number of partially processed social media posts that may be used in identifying the lingo, pulse, tone, and sentiment of a number of social media users targeted by the user of the persuasive rhetoric generator (100).

The presentation module (114-9) presents the social persuasion score to the user of the persuasive rhetoric generator (100). The presentation module (114-9) may also present the lingo score, the pulse score, the tone score, and the sentiment score. Additional scores, layout, and functionality may be presented as part of the presentation modules (114-9) activities.

And over all example according to FIG. 1 may now be given. A user uses the persuasive rhetoric generator (100). The proposed message read module (114-1) causes the processor (102) to read a proposed message using the input device (104) from the user of the persuasive rhetoric generator (100).

The persuasive rhetoric generator (100) may use a social media read module (114-7) in the database read module (114-8) to provide information to evaluate the proposed message.

The lingo score module (114-2) may identify a score for the lingo used in the proposed message comparing the lingo to known quantities, including the data read from the social media read module (114-7) and the database read module (114-8).

The pulse score module (114-3) may measure the frequency of posting over a period of time to identify if the user of a persuasive rhetoric generator (100) is posting too frequently or too infrequently to be persuasive with their target audience.

The tone score module (114-4) measures the tone of a number of proposed messages by comparing those messages with the data retrieved from the social media read module (114-7) and the database read module (114-8).

The sentiment score module (114-5) measures the sentiment of a proposed message using the social media read module (114-7) and the database read module (114-8). The sentiment may be identified to match a number of social media users or may be selected to alter the tone and sentiment of a discussion.

The social persuasion score module (114-6) may use the output of the lingo score module (114-2), the pulse score module (114-3), the tone score module (114-4), and the sentiment score module (114-5) to identify a single score representing the persuasion level of a number of proposed messages.

The social media read module (114-7) may read posts from the user of the persuasive rhetoric generator (100) and other users to inform the persuasive rhetoric generator (100) of the lingo, pulse, tone, and sentiment of the conversation within social media.

The database read module (114-8) may read posts that have been stored in a computer database from the user of the persuasive rhetoric generator (100) and other users of social media networks to inform the persuasive rhetoric generator (100) of the lingo, pulse, tone, and sentiment of the conversations within social media.

The presentation module (114-9) may present the scores generated by the social persuasion score module (114-6), the lingo score module (114-2), the pulse score module (114-3), the tone score module (114-4), and the sentiment score module (114-5) to inform the user of the persuasion factors related to a number of proposed messages.

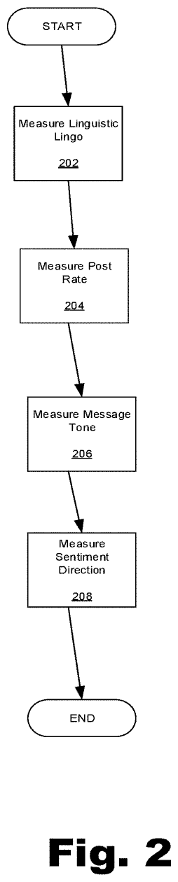

FIG. 2 represents a method (200) for generating persuasive rhetoric for a social media participant. The method (200) includes measuring linguistic lingo (202), measuring pulse rate (204), measuring message tone (206), measuring sentiment direction (208), and identifying a social persuasion score (210).

Measuring the linguistic lingo (202) measures the word selection, emoticons, emojis, and selection of idea expressing symbols as compared to existing conversations and education levels. For example, an overly wordy and complex message may be ineffective at communicating an idea to a group of teenagers interested in music. The same message, however, may be effective in communicating with an academic audience. In another example, a trendy post full of emoji's and emoticons may be effective with a young audience, however they may be ineffective with an academic audience.

Measuring the pulse rate (204) measures the frequency of messages compared to the attentiveness of the audience. A high pulse rate may indicate that messages are not being seen or are not effectively communicating with the target audience. A high pulse rate may indicate that messages are being discarded. A low pulse rate indicates that the audience is not receiving frequent enough messaging so as to keep the speaker in the mind of the audience. A pulse rate that is effective may have a resonant effect with the audience so as to amplify the message being presented well keeping the speaker in the mind of the intended audience.

Measuring the message tone (206) measures the tone of the message compared to the target audience. For example, the tone of the message to a religious audience may be less confrontational then the tone of the message to an audience preparing to protest for a cause.

Measuring a sentiment direction (208) examines the emotional attributes of a message and compares them to the emotional desires of the target audience. For example, an auto mechanic audience may be less interested in emotions and more interest in factual presentations of information. However a different group may be more affected by emotions as may be seen in the public dialogue for that different group.

Calculating a social persuasion score (210) may include combining the linguistic lingo, pulse rate, message tone, and sentiment direction to determine the amount of persuasiveness of a set of particular messages. By a user consistently optimizing the persuasiveness of their messages the user can increase their stature and influence. In a political situation, the user may be able to influence voters to vote for them by being a more effective persuader.

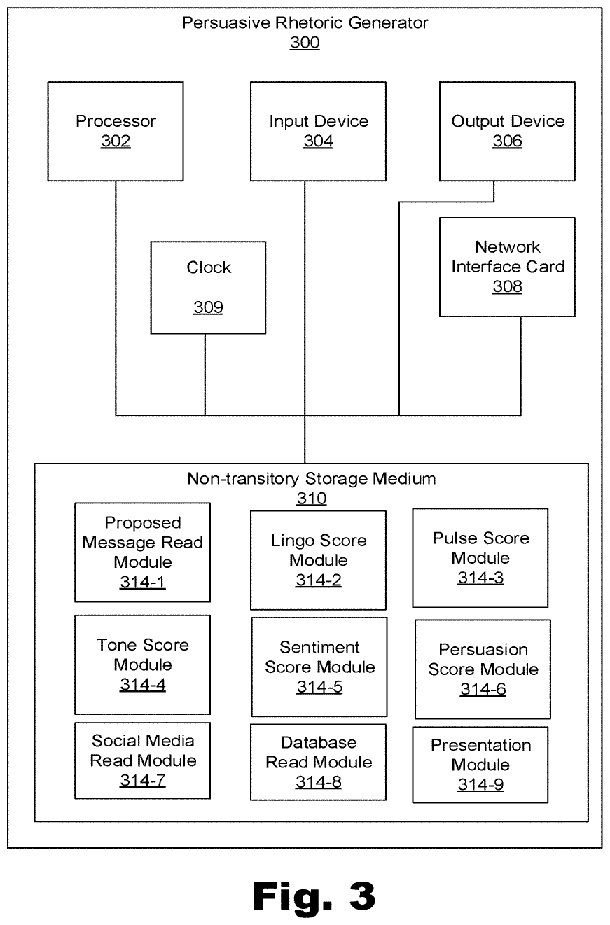

FIG. 3 represents a persuasive rhetoric generator (300) according to one example of the principles described herein. The persuasive rhetoric generator (300) may include a processor (302), an input device (304), an output device (306), a network interface card (308), a clock (309) and a non-transitory storage medium (310).

As described above, the non-transitory storage medium (310) may include a number of modules that cause the processor (302) to cause the persuasive rhetoric generator (300) to perform a particular task. As illustrated the modules include a proposed message read module (314-1), a lingo score module (314-2), a pulse score module (314-3) a tone score module (314-4), a sentiment score module (314-5), a social persuasion score module (314-6), a social media read module (314-7), a database read module (314-8), and a presentation module (314-9).

As illustrated, the pulse score module (314-3) may use the clock (309) to measure the amount of time between messages, or the frequency between the messages that are shared. This may allow the user of the persuasive rhetoric generator (300) to send messages at a frequency that may resonate with a number of individuals that are in the influence of the persuasive rhetoric generator. The residents may increase the effectiveness of the user of the persuasive rhetoric generator so as to increase the persuasive factor of that speaker and the rhetoric they use.

FIG. 11 represents an interface for displaying the output of pulse measuring module; analytics (83) for organization, group, or subgroup; pulse rate (84); number of unique authors (85); number of reports (86); time interval to most recent last mention (87); definition of pulse (88).

FIG. 12 represents the output of a sentiment measuring module. Main descriptive text (89) for profile. Influencers window (90) of advertising, Feed section with most important feeds selected by the user or AI, Feed can be private or public. Main text (91) of current feed. Graphical representation or scatter plot of sentiment (9100) relative to the number of postings;

FIG. 13 represents a tone signup interface. Indicator that tone is being displayed (92); sign up box (93); signup button (94); instructions (95); definition of tone metric (96).

FIG. 14 represents the output of a tone analyzing module; tone tab analyzer tab (97); content of the message that is being analyzed for tone (98); icon button for instructing system to analyze the content of the message (99); reviewers pane (100); post comment button (101); box for entering comments about the message that is being analyzed (102); definition of tone metric (103).

FIG. 15 depicts an expression interface, specifically a sentiment selection tool of an interface; display of types of sentiment ranging from negative sentiment, to neutral sentiment, to positive sentiment (104).

FIG. 16 depicts an expression interface, including a voting icon of an interface, allowing a user to vote in favor of or against an item.

FIG. 17 is a process for creating a campaign, creating a voting booth, or generating persuasive rhetoric;

Content from social media engagement is entered by user into the App. Content includes but is not limited to: lingo, jargon, language, abbreviations, hashtags, emojis, emoticons, poll links, mentions, videos GIFs, text, video, audio, images, timing (pulse, frequency, business, noise), types of campaigns, types of voting booths, types, of tone, branding, sentiment, identity and situation. The app then analyzes the content to obtain the Social Media Voice used for the unpublished content with the IBM Watson Artificial Intelligence Natural Language Processing and Tone Analyzer and provides a unit of measure for each variable (tone, sentiment, lingo, pulse). The app then calculates the current and optimal Social Media Persuasion Score (SPS) for the content. The app then provides suggestions to increase persuasiveness of content based on the optimal SPS score. Suggestions include modifications to content, which type of publication (type of campaign or voting booth) to use, and the rate of publication to use based on the optimal persuasion score. The user can then choose which content to publish based on the improved SPS score.

The user can then publish the more persuasive content (which is a voting booth or campaign) at the more persuasive rate in the most persuasive way (type of campaign or voting booth) and receive enhanced engagement for using the suggested and/or modified persuasive content based on the improved SPS score. Enhanced engagement metrics can include increased return on engagement (ROE), return on influence (ROI), return on message (ROM), return on follower (ROF), and return on power (ROP).

The present application claims the benefit of provisional XXX; the present application also claims the benefit of nonprovisional patent application XXX, which claims the benefit of provisional XXX. All of the other applications upon which a claim of benefit has been made are references that are incorporated by reference.

Predominant tone or predominant score is obtained unless it's a subscore or a tone in one of the three categories (predominant emotion tone, for example). A tone, such as joy, may have a corresponding tone intensity value; at other times; an emotion tone may have a corresponding emotion tone intensity For example, three categories of tone may be determined for any message so when referring to a specific tone or type of tone, then the scores associated with that type of tone are unlimiting since there may be other tones or social constructs that have a similar tone. Message, unless otherwise stated, refers to social media message such as a Twitter® or Facebook message.

Finalized emotion tone intensity may be representable by a numeric value indicating emotion tone strength for the set of published messages;

language tone intensity may be representable by a numeric value indicating language tone intensity for the proposed message;
finalized emotion tone intensity may be representable by a numeric value indicating emotion tone strength for the set of published messages;
finalized emotion tone intensity may be representable by a numeric value indicating emotion tone strength for the set of published messages;
finalized language tone intensity may be representable by a numeric value indicating language tone intensity
language tone intensity may be representable by a numeric value indicating language tone intensity for the proposed message
a finalized social propensities tone intensity may be represented by a numeric value,

Follower engagement has also been called social media consumer or firm engagement, among other terms (Barger et al., 2016). This has caused misidentification, lack of identification, and limited advancement of the research (Barger et al., 2016). Also, when researchers previously tried to measure tone outside of the context of social media, they have often incorrectly referred to tone and sentiment interchangeably (Papacharissi, 2015). The current study, because of the advances of artificial intelligence, machine learning, and natural language understanding, was an attempt, by disentangling the two variables of tone and sentiment, to contribute to the literature on social media networks, social media leadership communication, and social media engagement.

Finally, leaders struggle with engaging followers in conversations on SMPs like Twitter, even with paid, earned, or organically generated media (Tumasjan, Sprenger, Sandner, & Welpe, 2010). Appendix A provides a diagram of how the author views owned, paid, earned, and shared tactics. SMLs use SMPs to create a voice and communicate, but most SMLs fail to use a strategic tone to maximize follower engagement for their organizations (Boyd & Ellison, 2007). From their ineffective communication skills, SMLs generate content that is neither meaningful to followers nor one that provokes listening or engagement by followers; hence, they cannot generate a long-term interaction (Kietzmann, Hermkens, McCarthy, & Silvestre, 2011).

The system may change a proposed message to increase the likelihood that the engagement will be higher; for example, the system may add more language of an angry tone to increase the likelihood that engagement will be increased. In some embodiments, the system may delete @mentions from a proposed message when the proposed sender is a world leader, such as Donald Trump in 2019.

This specification defines social media voice as the method by which a social media user communicates in a comprehensible manner on a social media platform (SMP) to other users. SMV (Social Media Voice) may include the tone, sentiment, lingo, and pulse of a message (i.e., tweet). An SMV may establish the purpose of a social media leader (SML). Follower engagement may be defined as the reaction of a follower to a tweet in the form of likes, retweets, and replies to a tweet (Twitter, 2018). SMV may encompass the following variables: tone (intensity and type), sentiment (intensity), lingo (mentions, hashtags, URLs, abbreviations, and emojis) and pulse (frequency deviation and volatility) based on factors of participation in an audience. 1 illustrates the relationship between a leader and a follower's SMV communication exchange. The diagram illustrates a feedback loop where sentiment within SMV with tone and lingo in the message is hypothesized to generate social media engagement by the follower, causing a reply within a social network.

### 1. An Illustration of the Social Media Voice Model by the Author.

A leader (sender) communicates with a follower (receiver) in a social media feedback loop. The social media voice comprising of type of tone and tone intensity convey a willing attitude to the follower. The follower responds based on the frequency creating a pulse that is volatile or not that drives engagement that in the form of measurable feedback or social media metrics. This participation is a response to the social media voice strategic sentiment. Participation takes form in social media engagement (i.e., likes or reciprocity, shares or retweets, and comments or replies).

An example of a tone analyzer is the artificial intelligence system developed by International Business Machines (IBM) Corporation, an American multinational information technology company, that developed a question-answering artificial intelligence computer system known as Watson, IBM Tone Analyzer®. A tone analyzer may be broadly defined and may included systems, methods, and computer products as follows: A tone analyzer,

Embodiment TA1. A method implemented by an information handling system that includes a memory and a processor for providing a tone optimization recommendation, the method comprising:
decomposing digital content, resulting in decomposed digital content that includes a word; using a linguistic inquiry and word count dictionary to define a word category;
normalizing a frequency of words that are used in the digital content and belong to the word category to determine a word category score, wherein the word category includes the word;
using a tone prediction model and the word category score to infer a current tone of the digital content, wherein the tone prediction model was built using training data from a psychometric study;
obtaining a desired tone inference for a target audience;
determining, by a tone optimization generator, a linguistic tone optimization recommendation to reduce a difference between the current tone and the desired tone, wherein the linguistic tone optimization recommendation includes a linguistic modification suggestion, and wherein the tone optimization generator uses a correlation learned from the tone prediction model; and
outputting the linguistic tone optimization recommendation.
Embodiment TA2. The method of Embodiment TA1, further comprising:
implementing the linguistic tone optimization recommendation, resulting in an updated current tone;
determining a revised optimization recommendation to reduce a difference between the updated current tone and the desired tone; and
providing the revised tone optimization recommendation.
Embodiment TA3. The method of Embodiment TA1, wherein the outputting the linguistic tone optimization recommendation includes implementing the tone optimization recommendation.
Embodiment TA4. The method of Embodiment TA1, further comprising:
outputting an explanation for the current tone.
Embodiment TA5. The method of Embodiment TA1, wherein the linguistic tone optimization recommendation includes a plurality of linguistic modification suggestions, further comprising:
prioritizing the linguistic modification suggestions, resulting in prioritized modification suggestions; and
outputting the prioritized modification suggestions.
Embodiment TA6. The method of Embodiment TA1, wherein the outputting the linguistic tone optimization recommendation includes outputting the linguistic tone optimization recommendation as a suggestion to modify the digital content.
Embodiment TA7. The method of Embodiment TA1, further comprising:
obtaining another desired tone inference for another target audience;
determining another tone optimization recommendation to reduce a difference between the current tone and the another desired tone; and
outputting the another tone optimization recommendation.
Embodiment TA8. The method of Embodiment TA1, wherein the outputting the linguistic tone optimization recommendation includes outputting the linguistic tone optimization recommendation using a visual depiction.
Embodiment TA9. A computer program product stored in a non-transitory computer readable storage medium, comprising computer program code that, when executed by an information handling system, causes the information handling system to provide a tone optimization recommendation by performing actions comprising:
decomposing digital content, resulting in decomposed digital content that includes a word; using a linguistic inquiry and word count dictionary to define a word category;
normalizing a frequency of words that are used in the digital content and belong to the word category to determine a word category score, wherein the word category includes the word;
using a tone prediction model and the word category score to infer a current tone of the digital content, wherein the tone prediction model was built using training data from a psychometric study;
obtaining a desired tone inference for a target audience;
determining, by a tone optimization generator, a linguistic tone optimization recommendation to reduce a difference between the current tone and the desired tone, and wherein the tone optimization generator uses a correlation learned from the tone prediction model; and
outputting the linguistic tone optimization recommendation.
Embodiment TA10. The computer program product of Embodiment TA9, further comprising: implementing the linguistic tone optimization recommendation, resulting in an updated current tone;
determining a revised optimization recommendation to reduce a difference between the updated current tone and the desired tone; and
providing the revised tone optimization recommendation.
Embodiment TA11. The computer program product of Embodiment TA9, wherein the outputting the linguistic tone optimization recommendation includes implementing the linguistic tone optimization recommendation.
Embodiment TA12. The computer program product of Embodiment TA9, further comprising: outputting an explanation for the current tone.
Embodiment TA13. The computer program product of Embodiment TA9, wherein the linguistic tone optimization recommendation includes a plurality of linguistic modification suggestions, further comprising:
prioritizing the linguistic modification suggestions, resulting in prioritized modification suggestions; and
outputting the prioritized modification suggestions.
Embodiment TA14. The computer program product of Embodiment TA9, wherein the outputting the linguistic tone optimization recommendation includes outputting the tone optimization recommendation as a suggestion to modify the digital content.
Embodiment TA15. The computer program product of Embodiment TA9, further comprising: obtaining another desired tone inference for another target audience;
determining another tone optimization recommendation to reduce a difference between the current tone and the another desired tone; and
outputting the another tone optimization recommendation.
Embodiment TA16. The computer program product of Embodiment TA9, wherein the outputting the linguistic tone optimization recommendation includes outputting the tone optimization recommendation using a visual depiction.
Embodiment TA17. The computer program product of Embodiment TA9, further comprising: obtaining another desired tone, wherein the another desired tone includes another desired tone inference for another target audience;
determining another tone optimization recommendation to reduce a difference between the current tone and the another desired tone; and
outputting the another tone optimization recommendation via an interactive user interface.
Embodiment TA18. A system comprising:
one or more processors;
a memory coupled to at least one of the processors; and
a set of computer program instructions stored in the memory and executed by at least one of the processors to perform the actions of:
decomposing digital content, resulting in decomposed digital content that includes a word; using a linguistic inquiry and word count dictionary to define a word category, wherein the word category includes the word;
normalizing a frequency of words that are used in the digital content and belong to the word category to determine a word category score, wherein the word category includes the word;
using a tone prediction model and the word category score to infer a current tone of the digital content, wherein the tone prediction model was built using training data from a psychometric study;
obtaining a desired tone inference for a target audience;
determining, by a tone optimization generator, a linguistic tone optimization recommendation to reduce a difference between the current tone and the desired tone, wherein the linguistic tone optimization recommendation includes a linguistic modification suggestion, and wherein the tone optimization generator uses a correlation learned from the tone prediction model; and
outputting the linguistic tone optimization recommendation.
Embodiment TA19. The system of Embodiment TA18, wherein the set of computer program instructions stored in the memory and executed by at least one of the processors to perform additional actions of:
visually depicting the current tone and the linguistic tone optimization recommendation.
Embodiment TA20. The system of Embodiment TA18, wherein the set of computer program instructions stored in the memory and executed by at least one of the processors to perform additional actions of:
obtaining the digital content and providing the digital content to the tone analysis module.

Applicant declares that one skilled in the art would refer to US20180203847A1 patent application to understand what is a tone analyzer.

A sentiment analyzer may be defined as: Embodiment SA1. A computer-implemented method for systematically analyzing an electronic text, comprising: receiving the electronic text from a plurality of sources; determining an at least one term of interest to be identified in the electronic text; identifying a plurality of locations within the electronic text including the at least one term of interest; for each location within a plurality of locations, creating a snippet from a text segment around the at least one term of interest at the location within the electronic text; creating multiple taxonomies for the at least one term of interest from the snippets, wherein the taxonomies include an at least one category; and determining co-occurrences between the multiple taxonomies to determine associations between categories of a different taxonomies of the multiple taxonomies.

Embodiment SA2. The computer-implemented method of Embodiment SA1, further comprising: determining co-occurrences between a category of a single taxonomy and the at least one term of interest to determine significance of the at least one term of interest; and sorting the at least one term of interest by significance.
Embodiment SA3. The computer-implemented method of Embodiment SA2, further comprising sending the sorted at least one term of interest for user review.
Embodiment SA4. The computer-implemented method of Embodiment SA2, wherein each taxonomy of the multiple taxonomies is one of the group consisting of: a text clustering based taxonomy, a taxonomy created from the occurrence of terms of interest, a sentiment based taxonomy, and a time based taxonomy.
Embodiment SA5. The computer-implemented method of Embodiment SA4, wherein for each determined co-occurrence, determining a meaning of the co-occurrence from the term of interest, electronic text and sources of the electronic text involved in the co-occurrence.
Embodiment SA6. The computer-implemented method of Embodiment SA5, further comprising: creating from the categories of the electronic text a plurality of category/term of interest statistics of importance; and determining from the electronic text within each category and the category/term of interest statistics the importance of each co-occurrence.
Embodiment SA7. The computer-implemented method of Embodiment SA6, wherein the text clustering is cond to use a method based on selecting a cohesive terms of the electronic text to seed category selection.
Embodiment SA8. The computer-implemented method of Embodiment SA 2, wherein the electronic text is web based.
Embodiment SA9. A system for systematically analyzing an electronic text, comprising: a module to receive the electronic text from a plurality of sources; a module to determine an at least one term of interest to be identified in the electronic text; a module to identify a plurality of locations within the electronic text including the at least one term of interest; a module to create for each location within a plurality of locations a snippet from a text segment around the at least one term of interest at the location within the electronic text; a module to create multiple taxonomies for the at least one term of interest from the snippets, wherein the taxonomies include an at least one category; and a module to determine co-occurrences between the multiple taxonomies to determine associations between categories of a different taxonomies of the multiple taxonomies.
Embodiment SA10. The system of Embodiment SA9, further comprising: a module to determine co-occurrences for a single taxonomy against a term feature space to determine significance of the at least one term of interest; and a module to sort the at least one term of interest by significance.
Embodiment SA11. The system of Embodiment SA10, further comprising a module to send the sorted at least one term of interest for review.
Embodiment SA12. The system of Embodiment SA10, wherein each taxonomy of the multiple taxonomies is one of the group consisting of: a text clustering based taxonomy, a taxonomy created from the occurrence of terms of interest, a sentiment based taxonomy, and a time based taxonomy.
Embodiment SA13. The system of Embodiment SA12, wherein the module to determine co-occurrences for each co-occurrences determines a meaning of the co-occurrence from the term of interest, electronic text and sources of the electronic text involved in the co-occurrence.
Embodiment SA14. The system of Embodiment SA13, further comprising: determining for the at least one term of interest categories of the electronic text in the taxonomies; creating from the categories of the electronic text a plurality of category/term of interest statistics of importance; and determining from the electronic text within each category and the category/term of interest statistics the importance of each category.
Embodiment SA15. The system of Embodiment SA14, wherein the text clustering is cond to use a method based on selecting a cohesive terms of the electronic text to seed category selection.
Embodiment SA16. The system of Embodiment SA10, wherein the electronic text is web based.
Embodiment SA17. A computer program product comprising a computer useable storage medium to store a computer readable program, wherein the computer readable program, when executed on a computer, causes the computer to perform operations comprising: receiving the electronic text from a plurality of sources; determining an at least one term of interest to be identified in the electronic text; identifying a plurality of locations within the electronic text including the at least one term of interest; for each location within a plurality of locations, creating a snippet from a text segment around the at least one term of interest at the location within the electronic text; creating multiple taxonomies for the at least one term of interest from the snippets, wherein the taxonomies include an at least one category; and determining co-occurrences between the multiple taxonomies to determine associations between categories of a different taxonomies of the multiple taxonomies; determining co-occurrences between a category of a single taxonomy and the at least one term of interest to determine significance of the at least one term of interest; and sorting the at least one term of interest by significance; and outputting the sorted at least one term of interest.
Embodiment SA18. The computer program product of Embodiment SA17, wherein each taxonomy of the multiple taxonomies is one of the group consisting of: a text clustering based taxonomy, a taxonomy created from the occurrence of terms of interest, a sentiment based taxonomy, and a time based taxonomy.
Embodiment SA19. The computer program product of Embodiment SA18, wherein the text clustering is cond to use a method based on selecting a cohesive terms of the electronic text to seed category selection.
Embodiment SA20. The computer program product of Embodiment SA17, wherein the electronic text is web based.

Applicant declares that one skilled in the art would refer to WO2010066616A1 (PCT Patent Application) or to published information about IBM Sentiment Analyzer®, and natural language processing tools to determine. The system may determine whether a direct association exists between SMV and follower engagement and may control for number of followers as a constant during a multi-year sample of a group of social media participant's activity. They disclosed system may reply upon and perform machine learning on a study of the data set of Donald Trump's 35,647 tweets according to each of his four branded leadership personas as a business executive, political candidate, a world leader, and a combination of these personas referred to as an SML persona. Social media engagement may differ with a specific tone type and intensity based on branded leadership persona.

Social Media Platforms

Dunston (2016) stated that technology is drastically changing. Hence, it is imperative to understand the skill set and characteristics required for leaders to handle the changes in communication via mobile technology and SMPs. As defined by Kim, Kim, Kim, and Dey (2016), SMPs refers to a technology platform enabling users to share their feelings, insights, mood, knowledge, views, and other forms of data to other users, who may generate a network effect or create additional value. This definition divides the term SMP into two parts, the way the speaker conveys the message and how the listener decrypts that message. The combination of these two parts creates a process that can generate social media engagement. Many SMPs track social media engagement. Each SMP has a communication style and an SMV built around technical features and specific language. Each SMP has its own form of social media engagement measurements for its audience and shares the empirical analytics with the account owner and the public that provides insights on the identity of the audience and how they are engaged.

As technology evolves, the parameters of social media engagement will change, and the engagement measures will likely evolve as well (Garimella, Weber, & De Choudhury, 2016). Modern social media engagement measures include likes, replies, and shares, while older measures were limited to replies on instant messaging platforms, for instance. Different SMPs offer different communication clues with visual graphics in the form of icons or symbols, as illustrated in 2. Each icon illustrates a social media engagement activity. For example, on Twitter, a heart represents a like, a comment bubble represents a reply, and two box arrows represent a retweet (Twitter, 2017).

Twitter measures engagement by how many times a user intermingles with a tweet. Twitter measures this engagement by a series of “clicks wherever on a tweet, including retweets, replies, follows, likes, links, cards, hashtags, embedded media, username, profile photo, or Tweet expansion” (Twitter, 2017). 2 illustrates the different social media engagement icons for the top eight SMPs in the United States, what symbols they use, and how they are defined to encourage communication. For example, Twitter's “listen to me,” for example, shows the heart, comment bubble, and retweet box which are the independent variables in the current research study under the umbrella term engagement.

icons (similar) help social media platforms create social clues to help digital users in various social media platforms (Twitter) engage. Illustration by the author shows each social media platform has an implied voice that it speaks with its audiences. For example, Twitter says, “listen to me.”

The tone is not just what a brand or leader says but how a leader says it (Cummings, 2013). The leader's voice is the personality and tones are how a leader conveys a message to his or her followers (Cummings, 2013). The tone is also often defined by literature as what the author feels about the subject (Narayan, 2013). Tone refers to a leader's use of words, or mood, he or she conveys in a tweet. According to Patterson (2014), tone articulates or implies an author's emotional state. Hence, the feeling towards the subject he or she desires to share differs significantly from the approaches expressed by characters who appear in writing. According to Narayan (2013), the tone is a significant reason misunderstanding and feelings of dislike occurs among people unreasonably.

Understanding which type of tone to use and their patterns (tone intensity) on SMPs can help leaders become more persuasive in their posts with followers (Teng, Wei Khong, Wei Goh, & Yee Loong Chong, 2014). For instance, the tone of former U.K. iconic Prime Minister Margaret Thatcher often used in her speeches is credited with bringing Britain back to its course, and for that reason, she was referred to as the iron lady (Drexler, 2014; Gregory, 2013; Prestidge, 2017).

The absence of a tone-based social media voice communication strategy by leaders on social media platforms creates a linguistic feedback loop between both digital users: author vs. reader, speaker vs. listener, or leader vs. follower. A linguistic feedback loop occurs between users responding to a situation where they must reshape their digital communications in both leadership rhetoric and follower discourse. Leaders struggle with engaging followers in these conversations on an SMP like Twitter (Tumasjan et al., 2010). The best way to explain this complicated ebb and flow of communication and social media engagement among users on an SMP is with a special kind of diagram, as shown in 5.

Research has ensured credibility by using the verified, official personal account of Donald J. Trump, @realDonaldTrump, that Twitter validated as official via a blue checkmark. Twitter users are a primary source of information because of their increasing Twitter recognition (Gupta et al., 2014). Digital users interact by triggers of social media engagement (likes, retweets, and replies). According to Gupta et al. (2014), aspects such as the number of followers, mentions, and retweets are very helpful in determining the overall credibility of Twitter information.

Sentiment vs. Tone

Researchers define sentiment as an attitude or position, such as an opinion regarding another person, object, or idea (Miller, Blumenthal, & Chamberlain, 2015). According to Pearl (2016), sentiment analysis is a necessary means of making one's voice user input empathetic and smarter. The tone implies an author's feelings towards a follower. The tweet style a leader uses conveys an attitude on a topic to his/her followers. A leader conveys tone through the choice of words and phrases, viewpoint, and punctuation of words with symbols.

Sentiment analysis refers to the mining of various sources of data for opinions process using text analytics. Often, data gathered from the Internet and various SMPs are analyzed for sentiment. The term sentiment is often commingled with tone, since it is referred to as an emotion or feeling, and attitude or opinion (Papacharissi, 2015). However, this is a perceived mood by the author, speaker, or leader and aids in audience insights, customer service, and brand messaging (Tran, 2019). By understanding the sentiment in a tweet engagement, the direction of the conversation can be seen. Leaders produce a certain sentiment among followers, which can also serve as a tool to engage followers to respond or act on the posted content. Followers react to the content of messages from leaders with a particular sentiment that can be positive, negative, or neutral (Miller et al., 2015). Hence, sentiment can either be a positive or negative mood depicted in an SMP post or social media engagement. Tracing sentiment is crucial as it provides crucial context for how the leader should go on and respond to a text.

Social Media Noise

Social media platforms like Twitter have been highly used as an affordable and direct means of mass communication due to their increased capability to affect offline conduct (Liu, Kliman-Silver, & Mislove, 2014). The expectation is that organizations and their leaders use SMPs well to rebrand, reach, and engage followers (Liu et al., 2014). However, most leaders do not know how to use SMPs effectively (Kietzmann et al., 2011). Leaders who primarily focus on a number of followers and content without context could be contributing to social media noise. Leaders taking part ineffectively in SMPs underachieve in engaging followers even with paid, earned, or owned media. In a changing digital environment, social media engagement could become a holistic leadership strategy for leaders to use paid, owned, earned, and shared tactics as a framework to maximize their efforts (Burcher, 2012). (Appendix A provides a diagram and description paid, owned, earned, and shared.)

Instead of communicating effectively, SMLs create social media noise or content that may not be pertinent to followers nor elicit listening or engagement by followers (Kietzmann et al., 2011). Most online communication and political discourse seem to be a steady stream of non-strategic content that is probably not relevant and can have spam-like or repetitious levels of sentiment often generated by fake accounts or social bots (Dickerson, Kagan, Subrahmanian, 2014). The kinds of messages referred to as social media noise, are repetitive, narrow, oversimplified, valueless, and misleading (Allem & Ferrara, 2016). The data set for the current study did not contain as much social media noise because the sample was taken after two main data purges by Twitter. This is important because the first data purge was in January and July of 2018, effecting a reduction in Donald Trump's Twitter followers and engagement metrics.

Branded Leadership Personas

A persona is defined as an Internet identity (IID) that is established on the World Wide Web and online communities or websites (Bullingham & Vasconcelos, 2013). A persona can be a reflective or detached interpretation of a virtual identity with a holistic view of oneself. The biography or content can create an opinionated, logical, or emotional message. Followers can make different assessments regarding the leader's voices as biased, underdeveloped, or emotional (Dean, 2015).

Social personas provide a searchable interpersonal perception, as on a Twitter profile online, where personas can be updated with real-life roles, or as titles may change by both text and imagery. Personas are the online version, or human surrogate used to create a brand voice (Meese et al., 2015). Using a persona, the persona is embodied in a single person (Donald Trump) who embodies the different facets of the brand persona (real estate tycoon and entrepreneur, 2016 Republican presidential candidate, and 45th President of the United States of America) (Dion & Arnould, 2016).

Donald Trump's personas' facets were divided into four branded leadership categories in the current research study: business executive persona (22,170 tweets), political candidate (7,765 tweets), and world leader (5,712 tweets). A fourth persona was created for this study to refer to the sum total of three personas into one persona; this compound persona is defined in the study as a social media leader person (36,547 tweets). Cohen (2012) stated that by studying social media platforms, it is easy to understand an audience's personality. This is useful to incorporate marketing personas that help in understanding and coming up with targeted markets. Social media marketing addresses the importance of personas, but Donald Trump's usage of his Internet identity (Bullingham & Vasconcelos, 2013) could be an interpretation of his holistic view of himself. A social media persona provides a timeline of the interpersonal perception yet searchable online identity via the content (Tweets) posted during this real-life role, job, title, or position before it changes.

Dividing the tweets into these three personas allowed for examining the relationship between SMV and engagement within distinct persona leadership roles of @realDonaldTrump. If the effects of SMV on engagement vary as a function of persona, the study can help to identify and explain these nuances. If these effects do not vary as a function of persona, the social media persona (three personas combined) provides a comprehensive and parsimonious analysis of the effects of SMV on follower engagement.

The system has been used in a study of artificial intelligence to examine 9 years of tweets from a sole, prominent, highly ranked leader whose leadership persona has transformed various brands of leadership personas over the course of time. The examination involved analyzing these secondary data for tone and other crucial variables to define how tone relates to social media engagement for SMLs, and any other variables affecting these relationships.

A unique contribution of the system is to include both tone and sentiment as part of a social media voice. Previous research has typically only examined sentiment, but by using new technologies, this is the first study to measure both constructs and examine their associations with social media engagement. Lingo (mentions, hashtags, URLs, abbreviations, and emojis) is a measure of jargon, and pulse measures the frequency of tweeting by examining the amount of tweet burstiness.

7. The author's illustration of the research design, Singh's Social Media Voice Model, theoretical framework. The conceptual/theoretical framework of the research study of SMV is built around theories (digital rhetoric, distributed leadership, and social presence) and illustrates how social media platforms provide the style and tone is associated with social media engagement between the speaker and the reader or leader and follower based on situations or how persona roles adopt changes to their social media voice.

The five canons of rhetoric are invention, arrangement, style, memory, and delivery (Cicero, 2006). The arrangement, style, and delivery apply to the study while memory (memorizing text) and invention (drafting text) do not because the study only involves the use of published text. The arrangement is the process of ordering the text in the message, while the style is the process of selecting the optimal diction, a form of speech and direction for the text. Delivery is the process of selecting the optimal method of distributing a message (Cicero, 2006). In communication, these three cannons were the basis on which to choose the four variables of the study to analyze Donald Trump's digital rhetoric: tone, sentiment, lingo, and pulse. Lingo (mentions, hashtags, URLs, abbreviations, and emojis) is the language that is arranged specifically to Twitter, while tone and sentiment are how text is stylistically used in a tweet and pulse is how a tweet is delivered.

SMPs, such as Twitter, allow users to deploy unique forms of rhetoric to direct and persuade their users to interact with the platform in site-specific ways to engage audiences (Weeks, Ardèvol-Abreu, & Gil de Zúñiga, 2017). These forms include the tweet, like, retweet, and reply. With a tweet, a user can use special lingo (mentions, hashtags, URLs, abbreviations, and emojis) and convey a certain tone to elicit a certain sentiment. As technology grows, so does the scope of this unique (tweet) rhetoric (Brändli & Wassmer, 2014; Coleman & Blumler, 2009; Enli & Skogerbø, 2013; Eyman 2015; Fogg, 2003; Jackson & Lilleker, 2009; Jungherr, 2016; Kreiss, 2011; Kreiss, Lawrence, & McGregor, 2018; Morris, 2018; Stromer-Galley, 2014; Warnick, 2002). This means that companies and leaders will need to sharpen their ability to use language persuasively to convince, satisfy, and influence an audience.

To evaluate how Donald Trump engages his followers on Twitter, a study applied digital rhetoric to identify four variables in his messages for their tone (intensity, category, and type), sentiment (polarity), lingo (taxonomy), and pulse (burstiness). This enables future researchers to examine how entities such as governments, cyber defense commands, bureaucracies, and political leaders may deploy types of digital rhetoric as a means of power and control through communication, which can constrain the potential for building stronger social communities or networks (Arnold, Gibbs, & Wright, 2003; Blanchard, 2008; Bossetta, 2018; Freelon, 2015; Gibson, Greffet, & Cantijoch, 2016; Keller & Kleinen-von Königslöw, 2018; Kreiss, 2014; Losh, 2004; Matei & Ball-Rokeach, 2001; Morris, 2018; Papacharissi, 2009; Parmelee, 2014; van Dijck & Poell, 2013; Wagner & Gainous, 2014; Wellman, Haase, Whitte, & Hampton, 2002; Zappen, 2005).

Human interactions on social media platforms can happen in a viral manner whereby people frequently speak for short blasts and then go silent after a while for an extended period (Doyle, Szymanski, & Korniss, 2016; Hendrickson & Montague, 2016; King, 2017). This rhythmic pulse could create a favorable sentiment. Engaging in tone analyses across many social media applications helps scholars evaluate whether certain approaches to online communication effectively persuade audiences (Beatty, 2015), for example, sentiment. The strength of a leader's SMV regarding lingo and pulse benchmarks a leader's social media presence. If SMPs are used to persuade audiences by posting messages, then digital rhetoric might be able to cultivate, analyze, and nurture a consistent feedback loop exchange between the leader and follower that could evoke a sense of tone (Beatty, 2015; Brownstein, 1992).

Social Presence Theory

While digital rhetoric provides scholars with a broader context through which online communication happens, social presence theory explains the impact of personal presence on an SMP. Social presence theory provides scholars with a framework through which to examine how individuals interact (engagement) with a specific SMP (Lowenthal, 2010). The overall political, social, and business use of social media signifies how actively people know that they are engaging online, as digital communicators while performing with one another (Aral, Brynjolfsson, & Van Alstyne, 2010). Alternatively, Short, William, and Christie (1976) created social presence theory to explain how interpersonal communication satisfaction varies with increased or decreased levels of social presence, or the quality or state of being present, between two communicating actors depending on the communication medium. For example, the radio can allow a listener to hear another person, which is one-sided because the listener cannot communicate back. However, in social media, the listener can read, hear, or watch, and write a post while surfing the Internet, thus creating various degrees of social presence.

On Twitter, successful communication is predicated on a user's online profile and an awareness that another person is taking part in a mediated communication interaction through engagement (Gunawardena & Zittle, 1997; Lowenthal, 2010; Rice & Shook, 1990; Richardson & Swan, 2003; Salinäs, Rassmus-Gröhn, & Sjostrom, 2000; Walther, 1992). Social presence theory delineates the salience degree, or what is noticeable, in an interaction. Therefore, the social presence theory can show how the communication medium can offer people a feeling that they do share the same space with others. Social presence theory creates an emotional connection to form relationships to be part of a community. Social presence theory applies to the current study because it addresses the significance of perceiving others and their emotions as related to engagement in a mediated or non-face-to-face communication (Lowenthal, 2010).

For example, digital users interacting indirectly via Twitter help explain the degree of presence when directly communicating with one another. Hence, by measuring all the digital user's interactions, the number of likes, retweets, replies, or even follows by the SML's message, it is possible to measure engagement.

Face-to-face, non-verbal cues translate into digital cues and offer a basis on which to describe how individuals can use creative keyboard-based cues to send non-verbal information within digital communication such as the emoji (Alshenqeeti, 2016). Text-based non-verbal cues include lexical surrogates, capitalizations, intentional misspellings, relational icons, absence of corrections, and spatial arrays (Adams, Miles, Dunbar, & Giles, 2018). For example, the use of relational icons or emojis help adds a sense of emotion content to a text message.

As digital communication has evolved, and face-to-face interaction has become more limited, it is relevant for SPT to be evaluated within the mode of computer-mediated communication and digital rhetoric (Gunawardena, 1995; Gunawardena & Zittle, 1997; Grubb & Hines, 2000; Robinson, 2000; Salinäs et al., 2000; Stacey, 2002; Walther, 1996). The social interaction computer-mediated communication, on different digital platforms, has the potential to determine how actors have high salience when interacting online (Danchak et al., 2001; Gunawardena, 1995; Gunawardena & Zittle, 1997; Kehrwald, 2008; Lowenthal, 2010; Richardson & Swan, 2003; Tu, 2002).

Social media engagement allows one to measure which, among tone, sentiment, lingo, and pulse, are significant in message portrayal. Richardson and Swan (2003) agreed that the most critical communication channel for engagement is a consideration of social presence. Engagement, considering social presence, can enable or constrain leadership depending on how actively a leader communicates to followers. If a leader communicates ineffectively, then it could reduce engagement, resulting in a leader appearing less influential (Garrison, Anderson, & Archer, 1999). Traditionally, researchers measured SMP engagement based on computer-mediated communication (Walther, 1996; Walther, Anderson, & Park, 1994).

For purposes of this application: analytical tone indicates a person's reasoning and analytical attitude about things; an analytical person might be perceived as an intellectual, rational, systematic, emotionless, or impersonal. Confident tone may indicate a personal degree of certainty; a confident person might be perceived as assured, collected, hopeful, or egotistical. A tentative tone may indicate a personal degree of inhibition; a tentative person might be perceived as questionable, doubtful, or debatable. An anger tone may be evoked due to injustice, conflict, humiliation, negligence or betrayal; if an anger tone is active, an individual may attack a target verbally or physically. If anger is passive, the person may silently sulk and feel tension and hostility. A fear tone may be a response to impending danger; it may be a survival mechanism that may be triggered as a reaction to some negative stimulus; fear may be a mild caution or an extreme phobia. A joy or joyful tone may have shades of enjoyment, satisfaction, and pleasure; joy may indicate a sense of well-being, inner peace, love, safety, and contentment. A sad tone or sadness tone may indicate a feeling of loss and disadvantage, when a person is quiet, less energetic, and withdrawn, it may be inferred that the individual is feeling sadness.

Overview of the Research Design

In a previous study, Donald Trump's social media textual posts or tweets delivered by @realDonaldTrump Twitter account were defined as a message and followers of this account as the audience. Followers referred to digital users (people) in the Twitter's social network ecosystem (collectively known as the Twittersphere) who post, subscribe, or follow another Twitter user's tweets (Walker, 2018). Engagement, the dependent variable, refers to the responsiveness of the audience to the messages, measured by the number of likes, retweets, and replies. SMV, the independent variable, was operationally defined as tone, sentiment, lingo, and pulse. A tone analyzer was used measure the SMV. Donald Trump's four distinct personas (business executive, political candidate, world leader, a combination of the four) may be defined as his brand. The number of Twitter users who follow @realDonaldTrump daily may be defined as a number of followers and may be applied as a control variable.

An embodiment of the system was used as follows: the research sample consisted of 35,647 tweets from Donald Trump's verified Twitter account written between May 9, 2009, and Nov. 6, 2018. Donald Trump's personas consist of him as (a) a business executive, from May 4, 2009 to Jun. 15, 2015; (b) a political candidate, from Jun. 16, 2015 to Nov. 7, 2016; and (c) a world leader, from Nov. 8, 2016 to Nov. 6, 2018. The aggregate of his tweets, an SML from May 4, 2009, to Nov. 6, 2018, was also measured. Each research question was tested for each of the four personas. A number of followers, a control variable, was the total number of digital users that joined @realDonaldTrump during a given 24-hour period from 12:00 am to 11:59 pm starting in October 2009 to Nov. 6, 2018. A similar analysis may be performed by the system on a group of social media followers to determine which social media followers belong to the same category and should be grouped in a smaller subset than the larger set, or group, of followers. For example, the system may use natural language processing to examine all the Twitter accounts of individuals who identify themselves as a Republican or Democrat Congressman, Congresswoman, or Senator.

Regarding personas, the following example is illustrative: The justification for dividing Donald Trump's tweet into four personas is due to the distinct roles he played during each period. Persona 1, the business executive persona, covers the period from Mar. 4, 2009, when he was famous for his entrepreneurial ventures and his show, The Apprentice until the day he announced his candidature for President of the United States. Persona 2, the political candidate persona, shifted his persona into the political arena, and could potentially have shifted how much his SMV affects tweet engagement. Persona 3, the world leader persona, begins the day he won the election and announced to the world he would become the 45th President of the United States of America and continues through Nov. 6, 2018. Moreover, his change in persona could have systematic effects on how much his SMV influences his engagement. Persona 4, the SML persona (SLP), is the sum of the three personas.

Variables

Variables are phenomena that can be measured, including properties, characteristics, and qualities of a group, people, or objects (Schmidt, 2011). Variables can be measured directly or indirectly (Schmidt, 2011). The system may analyze four independent variables (IVs): tone, sentiment, lingo, and pulse. The system may analyze three dependent variables (DVs) related to engagement included the number of likes, number of replies, and the number of retweets. The system may use a control variable: a number of followers.

### Definitions of Variables

Engagement refers to commitment, passion, involvement, absorption, zeal, energy, dedication, and enthusiasm (Schaufeli, 2013). Examples of engagement include likes, retweets, and replies. Like or likes are represented on Twitter by a heart icon or button (Twitter, 2017). A retweet is a re-posting of a persona or another person's tweet (Nations, 2017). A reply on Twitter refers to the response message or tweet from an individual while a retweet is to broadcast (forwarding an email) a tweet posted by another individual to others (Twitter, n.d.).

Tone refers to the expression of writers' emotional state or the feelings they have regarding the subject they desire to share (Dean, 2015). In this study, the tone was the quality of voice that expresses the speaker's feelings, often towards the person being addressed. In literature, the tone is the way a writer (speaker or leader) expresses the writer's attitude toward the subject. Attitude is the actual emotion that the writer (speaker or leader) has towards his or her audience and him or herself. Seven types of tones were measured (intensity) and identified (type). The tones were classified into two groups of emotional and language. The identified emotional tones are (a) joy, (b) sadness, (c) anger, and (d) fear (Bhuiyan, 2017). The language tones are (a) analytical, (b) tentative, and (c) confident (Bhuiyan, 2017).

Sentiment refers to an individual's attitude about, or an opinion regarding, an object's attitude, such as an attitude or opinion regarding a president's performance (Miller et al., 2015). The sentiment was measured in intensity, ranging from negative to positive, and in direction. In addition, it was measured as the absolute value of the intensity of sentiment, independent of tone type.

Lingo was measured in five variables: the mention (@), hashtag (#), post link or URL, emoji, and retweet RT abbreviations, capital R and capital T. The number of URLs or extensions in the tweet were calculated as part of the lingo. Pulse was measured in the amount of time between each message or tweet that occurred in a set of data in the social media feed. The dependent variables were in three forms of engagement: number of likes, number of retweets, and number of replies, as posted by 56 million followers as of Nov. 6, 2018. Lingo is the language; in this study, social media lingo refers to the different Twitter practical language users use to communicate (Stevenson, 2010). Examples of lingo include mentions, hashtags, post links, abbreviations, and emojis. A hashtag is any word that begins with the pound symbol (#) (Shapp, 2014). Mentions are words or phrases that begin with the @ sign followed by a user's username in a tweet (Nations, 2017).

Pulse is the umbrella term for calculating the rhythm of the social media voice and analyzing the response of a social media post by measuring the volatility and frequency. To measure pulse, one must first look at clusters or bursts of tweets during a set time period. This research examined at tweets within a 24-hour time period. The statistical burstiness of a post is the average amount of time between each post within a 24-hour period. Burstiness is defined as the increase or decrease in the frequency of activity of an act specified in the communication of unexpected events (Doyle et al., 2016; Hendrickson & Montague, 2016; King, 2017). The study included defining and calculating a frequency of engagement between a leader's tweet and follower engagement. Pulse rate refers to the intermittent increases and decreases in activity or frequency of an event (Doyle et al., 2016). The number of followers is the digital users within a social media platform that join another follower's account (Beal, n.d.). This number grows based on presence, brand, and frequency of posts. However, the increment of growth happens in real-time. The number of followers controlled for as growth occurs every 24 hours regardless of the number of tweets posted within that time frame. The number of followers can increase or decrease based on engagement, content, purges, and policy.

### Definition of Terms

The definitions are provided in the attached Appendix C. However; a few key terms have been provided below.

Social media engagement. Social media engagement is how to measure and how to analyze a digital user's participation at the opposite end of a social media communications feedback loop as a member of that social media platform.

Social Media Leader (SML). SML refers to a social media user with established integrity online, in a precise cause, belief, standard, or organization. An SML has access to vast and influential followers and engages these followers via social media platform), which empowers the leader to strengthen the approval of his or her message. SMLs have the power to persuade these followers by their forceful engagement of their personal and professional network using their tone: emotional, social, and language.

Social media platform (SMP). SMP is the software technology, management, and service for an online social network based on web 2.0 that enables online communication among users (Valls, Ouro, Freund, & Andrade, 2012).

Social media pulse (SMp). SMp is the reaction rate at which a social media post or social media platforms coverts engagement or action during a particular period of time, that reflects the messages frequency, volume, and volatility. The pulse is the social media rate (SMR), which is the frequency in which a message is sent each minute (TPM) and the rate of the amount of time between the message sent in the form of burstiness. This pulse provides a rhythm to the author of a message to help measure his or her communication performance.

Social media voice (SMV). SMV is a method by which a social media user communicates in a comprehensible manner on a social media platform to other users. SMV is the selection of the type of tone, the polarity of sentiment, the structure of lingo, and the frequency of selection of words to express messages on a social media platform to direct interactions with others.

Social media saturation (SMS). SMS is the exposure of a social media post or message in a communication campaign that reaches a given time period where the audience or follower no longer engages on the message any further nor takes an extra action.

Return on tone (ROT). ROT is the overall type of tone strength or intensity relative to the amount of social media engagement (e.g., likes, retweets, replies) to express a message's true value or worth in attitude, feelings, and will.

For purposes of this application: system may also refer to apparatus. The system may rely on previous studies or perform similar analysis as follows: the system may test the hypothesis that SMV (tone, sentiment, lingo (mentions, hashtags, URLs, abbreviations, and emojis), and pulse) is associated with social media engagement (likes, retweets, and replies). Second, the system may attempt to disentangle the relationship between tone and sentiment in social media, which adds to the literature the unique contribution of the two variable. Third, the study may determine if these associations differ depending on the brand persona of SML. Therefore, the system may solve (a) whether a correlation exists between an SML's use of tone, sentiment, language (lingo (mentions, hashtags, URLs, abbreviations, and emojis)) and frequency (pulse) in a message sent to followers, and the engagement followers have with that message on an SMP while the number of followers remains constant; and (b) to what extent those factors could serve as predictors of engagement.

The system may calculate Donald Trump's SMV on Twitter to determine if it predicts follower engagement.

The system may interface with other system like the IBM Watson Tone Analyzer® and Sentiment Analyzer® as well as IBM SPSS to measure the variables of tone, sentiment, lingo, and pulse, and their association with engagement on Twitter and use the IBM Watson Tone Analyzer® to measure messages from the brand perspective of a leader or various personas. Likes, replies, and retweets rather than follower growth may serve as better empirical evidence of engagement over a period of time-based on the leader's tweets because a user can only choose to follow a user once, but it does not mean the follower is communicatively engaged with the leader. Anyone can follow another user and avoid paying any attention to what the leader says; hence, the more accurate engagement metric is the direct response of a follower.

Distinct types of social cues, which are either positive or negative, include vocal tone, body language, gestures, and facial expression (Sauppé & Mutlu, 2014). When people talk, they use shared knowledge, including verbal and visual context, to predict the behavior of others and subsequently modify their response from those predictions. Visual and verbal cues are significant in all interactions because they can clarify meaning, reveal the intentions of speakers, and evaluate their perceived emotional tone in a conversation (Sauppé & Mutlu, 2014). For instance, social media cues are believed to offer instantaneity and visual indications, like the Twitter feed, which makes the users feel connected (Sexton, 2009). For example, the cues on social media platforms include having a Twitter logo beside the user's comment that may change a user's attitude toward another user or enable users to understand the reason and sense in their comments (Sexton, 2009).

Twitter Facts on Engagement

Twitter categorizes users as active or non-active. Accounts can also be private and non-private. Twitter measures engagement by three variables: likes, retweets, and replies. The number of follower's updates in real time as soon as one joins the platform. There are 330 million active users on Twitter monthly. The total number of tweets sent per day is approximately 500 million (Hatch, 2018). The percentage of Twitter users using the mobile application version is 80%. The number of Twitter daily active users is 100 million. Twitter defines the active and non-active users. Of all male Internet users, 24% use Twitter whereas of all female Internet users, 21% use Twitter (Hatch, 2018). Only 21% of the Twitter sphere is in the United States. That means there are approximately 67 million Twitter users in the United States. Approximately 56% of Twitter users spend $50,000 and more in year (Hatch, 2018). Twitter handles up to 18 quintillion user accounts.

Frequency Deviation

Frequency deviation is the difference between the immediate number of times per second that the current changes direction of the carrier frequency and a frequency modulated wave (Wen, Yu, Zeng, & Wang, 2016). Frequency deviation is mainly used in frequency modulated (FM) radios to give the maximum difference between the nominal carrier frequency and the FM frequency modulated frequency (Lauri, Colone, Cardinali, Bongioanni, & Lombardo, 2007). In the current study, frequency measures tweets for a period of time, in a burst or cluster, and contributes to a Tweet's overall scale of volatility. It adjusts based on the volatility of a single message during a specific time period, accounting for any deviation.

Coefficient Variations

Coefficient variation is the ratio of standard deviation to the mean (Reed, Lynn, & Meade, 2002). It indicates the degree of variability relative to the mean of the population. A higher coefficient of variation indicates a higher level of dispersion around the mean (Reed et al., 2002). The social media platform should strive to have a lower coefficient of variation in order to minimize volatility in the industry. For example, when creating a social media platform, it is important to ensure the information will be received by a large number of people and have many users to ensure a low coefficient of variation.

Volatility

Social media has taken a significant change in the digital era. The volatility of these social media platforms has made it necessary to create room for evolving changes. The audience of each social media platform varies dramatically (Hadley, 2017). It is therefore important to know and understand the demographics of a channel before displaying the content to the audience (Hadley, 2017). Understanding the audience of the different platform is important in creating true connections among the people (Hadley, 2017). For example, with the new redesign of Snap Chat features, the industry was losing more than 1,000 fans per month, dropping its market dominance drastically (Hadley, 2017). Twitter and Facebook, however, are improving by making the sharing of information much easier. It is now clear how volatile the industry can be when the audience satisfaction is not attained. Pulse, when measured by frequency of engagement, creates total volatility. Pulse rate is the intermittent increases and decreases in activity or frequency of an event (Doyle et al., 2016).

Velocity

In communication, velocity is defined as the speed at which information can be transmitted from one medium to another. The rate at which people engage content in social media at a given time is referred to as the social media velocity (Agrawal, Dasgupta, & Gupta, 2017). Stories with more engagement and activity have a higher velocity than the dormant ones. Total activity includes the likes, comments, tweets, and the number of shares a post in social media gets at a given time (Agrawal et al., 2017). The social velocity is important because it shows that the users were not only drawn to the stories but also engaged in it. For example, if something happens to a celebrity, such as an accident or an illness, such information will trend on social media and people will react to it by sending messages expressing their thoughts. People will also share the information with their friends, and, within a short period of time, the information will have reached a large number of people.

Burstiness or Burst of Messages

Burstiness is the transmission of data and characteristic in communication in bursts rather than as a continuous stream (Otomo, Kobayashi, Fukuda, & Esaki, 2017). Burst transmission is the transfer of large amounts of data in a short period of time. It is caused by the nature or type of data that are being communicated. Bursty transmissions reduce the chances of detection in radio transmissions, with low probabilities of recognition and intercept (Otomo et al., 2017). An example of burstiness of messages is evident among the computer architectures who rely on cache rather than bandwidth. It shows higher bandwidth until the cache is fully depleted and the information is retrieved from outside sources of the hardware (Otomo et al., 2017).

In communication, burstiness is a characteristic involving data transmitted intermittently rather than a continuous stream (Winslow, 2017). Burstiness on social media, also known as social media pulse, is the increase and decrease in the frequency or activity of an act specified in the communication of unexpected events (Doyle et al., 2016; Hendrickson & Montague, 2016; King, 2017). Doyle et al. (2016) stated that human interactions happen in a viral manner whereby people frequently speak for short blasts and then go silent after a while for an extended period.

According to Hendrickson and Montague (2016), as the witnessing of tragic events happens, and large data upload, there are spikes in interactive commentary among users, but over time the social media event's public response decreases. For example, Tweets about an emergency that occurs, such as national news breaking a fire tragedy, will show a lot of initial user mentions, but over time will decrease. In such unexpected events, the witnesses are more likely to pick up their phones and computers to share their experiences with the rest of the world via a social media platform such as Twitter (Hendrickson & Montague, 2016). This pattern predicts the overall pulse of an event. Besides pulse, the two final variables, sentiment and tone, describe how digital rhetoric theory translates across social networking platforms within different forms of user engagement.

Tone manipulation occurs when a person uses her or his ability to influence another for personal advantage and has a negative sentiment. Digital rhetoric also explores how its unique characteristics both afford and constrain the potential for building social communities or networks (Arnold et al., 2003; Matei & Ball-Rokeach, 2001; Quan-Haase, Wellman, Whitte, & Hampton, 2002; Wright, 2003; Zappen, 2005). Theories of digital rhetoric can be transformed and expanded depending on the context of its persuasiveness (Zappen, 2005). Social media is one context. Keller et al. (2018) argued that political actors' use of digital rhetoric does not just exploit the potential of social media, but also benefits it in other ways.

Tone Versus Sentiment

The two independent variables in the current study of tone and sentiment will help in evaluating social media persona and engagement in digital rhetoric. Natural language processing can describe tone and sentiment interchangeably. The two independent variables of tone and sentiment will help in evaluating social media persona and engagement in the context of digital rhetoric. Tone and sentiment are often used interchangeably to describe natural language processing (Young & Soroka, 2012). The sentiment is the view, attitude, or position taken toward an event and can have a positive, negative, or neutral emotion (Miller et al., 2015; Pang & Lee, 2008). The tone is the manner and attitude in which a message is delivered to evoke a specific response from followers (Ramos, 2005).

Tone and sentiment differ structurally. The sentiment is positive, negative, or neutral. If the tone is the leader/author's attitude toward a subject, then the mood is how followers should feel as readers, or the emotion evoked by the leader/author. The tone may show more: a social media actor's indifference, objectivity, impartiality, or ambivalence, which can be both positive and negative (Moran, 2016). In addition, tone can reflect the overall sentiment of a message (Kharde & Sonawane, 2016). Tone can be emotional or emotionally neutral, but sentiment requires emotion. Emotion is an instinctive feeling or state of mind (anger, fear, joy) and the mood is a temporary state of emotion (Geoffard & Luchini, 2010). Tone can be emotional by being funny, serious, formal, casual, respectful, irreverent, or enthusiastic (Moran, 2016). Tone can also be formal or informal based on diction or word choice. A formal tone is more severe and impersonal when dealing with authority or with a professional. An informal tone conveys more straightforward and causal phrases (Sauter, Eisner, Ekman, & Scott, 2010). Also, tone can express the intended sentiment for followers and mood of a speaker—frustrated, cheerful, critical, gloomy, or angry (Brownstein, 1992; Crews, 1977; Hacker, 1991; Moran, 2016).

Tone and sentiment also serve different purposes. Tone represents the conversational human voice of a leader speaking to followers and can, therefore, make a company, brand, or social media user feel closer and more real to an audience, since they are directing it (Berry, Carbone, & Haeckel, 2002; Dean, 2015; Kelleher 2009; Park & Cameron, 2014; Young & Soroka, 2012). Sentiment informs a leader of the mood of his or her followers, so he or she can modify the tone, as needed. Sentiment analysis contains content-specific linguistic markers of tone that can change, unlike tone, which is usually consistent. For example, the word happy is usually followed by homographs, such as not, right, well, or lie (Young & Soroka, 2012).

Unlike sentiment, the tone also defines how a text translates across digital platforms (Hart, 1984a, 1984b, 2001; Pitt, Plangger, Botha, Kietzmann, & Pitt, 2017). Sentiment analysis evaluates the attitude of the speaker only without testing contextual polarity or broad emotional reactions to a text. Sentiment analysis, or emotion AI, is similar to opinion-mining because it uses natural language processing, computational linguistics, and text analysis to identify, extract, and quantify subjective information from specific digital texts (Pang & Lee, 2008).

With natural language processing and AI technology, scholars can independently evaluate tone from sentiment and how they are used across various social networks (Haas, 2011; Jurafsky, 2009; Lally, 2011; Moran, 2016; Nadkarni, Ohno-Machado, & Chapman, 2011; Thompson & Mooney, 2003).

The only AI application to date that measures tone with a consistent success rate is the IBM Watson Tone Analyzer®. The researcher used IBM Watson Tone Analyzer® for the current study. IBM approaches tonal analysis using natural language processing and AI research develops scores for different tone dimensions such as emotion and language showing a “relationship between linguistic behavior and psychological theories” (Levelt, 1972, p. 18). Online language can evoke certain emotional responses depending on perceived tone or sentiment in text.

Engaging in tone analyses across many social media applications can help scholars evaluate whether certain approaches to online communication are effective and persuasive to audiences (Moran, 2016). The tone of voice may give evidence of the emotion of an individual's message while influencing his or her mood or how he or she feels about his or her message, and this is gives direction to sentiment (Roter, Frankel, Hall, & Sluyter, 2006). Variations in tone may influence factors such as desirability and brand personality, which may help organizations reach their user base (Booth & Matic, 2011; Moran, 2016).

Similar to how tone functions within traditional texts, a speaker's perceived attitude can help test whether tonal analysis expresses an emotional state in online communication (Phelan, 2014). The overall objective when trying to achieve a particular tone on social media is to express an attitude about a subject (Scheir, 2004). The ability of IBM to analyze tone could be crucial for leaders to educate themselves on how best to communicate and avoid situations that can adversely affect their brand (Barcelos, Dantas, & Sénéca, 2018). Social media fuels interest in sentiment analysis and, like brand evaluations using tonal analysis, allows businesses to appraise their social media messaging (Cordis, 2009). Twitter provides one of the most valid online indicators of political sentiment so far because direct correlations are found between political and party positions, indicating how tweets reflect offline political landscapes (Tumasjan et al., 2010).

According to Krieg (2016), Donald Trump effectively structured most of his tweets using a correct balance of tone and sentiment to push for consistent support among followers. Epstein (2016) also argued that Donald Trump's tone correlates with sentiment. For example, Donald Trump's tweets are often filled with satire, but when tweeting about people and things that touch on art, entertainment, and media, the content changes (Epstein, 2016). Epstein also explained that all of Donald Trump's tweets since he started tweeting in 2009 are searchable, therefore exposing his behavior to the general public. Krieg (2016) noted that Donald Trump often incorporates mentions using the @ character to associate people and organizations with his sentiments. For example, in one of his tweets, Donald Trump used the @ character (used as a mention) to direct attention to certain news agencies by stating that “The FAKE NEWS media (failing @nytimes, @NBCNews, @ABC, @CBS, @CNN) is not my enemy, it is the enemy of the American People!” (Twitter, 2018).

Tone analysis, opinion mining, or sentiment are correlated to social media users' ability to persuade and influence through their use of digital rhetoric (Haven, 2004; Nettel & Roque, 2012). Influence is the power to change or affect a person and the ability to command or force that effect (Sims, 2017). For example, using opinions and facts may influence a reader whether they are in favor of or against a political position taken by Donald Trump. Leaders who can use their voice effectively increase their influence over followers by rhetoric or using correct persuasive tones (Jacobs, Masson, Harvill, & Schimmel, 2011; Teng et al., 2015; Wissler et al., 2002). Tone also creates a relationship between the leader and follower. It lays down the foundation for leaders to express their character and identity so they can establish a power of authority (Lopez, 2014).

Personality

Personality is a significant attribute that represents an individual's character when interacting with other people, primarily through communication (Chen, Hsieh, Mahmud, & Nichols, 2014). The biggest threat to a personality is miscommunication because it could be computer-mediated and nonverbally affect the emotions of others while organizations can be affected (Byron, 2008). To a further extent, Twitter is also a platform that can reveal the personality of individuals because it is a social media network that allows users to publicly display their information and have insights into their lives (Robles, Edmondson, & Turner, 2011). The language used by individuals, specifically through words, is among the most direct means through which thoughts and feelings are expressed. Personality assessment depends on a self-report, acquaintance report, and/or behavior because these three provide a broad range of data identifying how they correlate (Fast & Funder, 2008).

Personality rating depends on how much an individual is known by another persona and the level of interaction between them. Personality could be recognized through the language used in texts because it could express an emotion where anger, fear, joy, and sadness could be highlighted due to each emotion being common in most of the known cases (Kim, Valitutti, & Calvo, 2010). Other individuals may only notice personality factors, therefore accommodating critical aspects of how their behavior correlates with the patterns (Norman, 1963). Posts on social media are beneficial when one wants to detect the users' emotions when their emotional state appears in their textual or video message. A social media post implies that users have preferences interacting and understanding other users; however, this improves through understanding their emotions since it is in a real-time setting (Wang & Pal, 2015).

Habits, thoughts, feelings, and actions are entirely different for every person. What people think, feel, and do may be entirely different from what they say about their thoughts, feelings, and actions. What users say merely implies that their personality is associated with the language they use, as it is in written form, from an interview, or even a recorded speech (Yarkoni, 2010). Language reveals personality has no assumptions but is based on facts studied and analyzed from a list of attributes directly associated with individuals, and personality explains why they think, feel, or do things in a certain way (Hopwood et al., 2011).

Personality is an analysis of language whether it is in written form, an interview, or a speech (Norman, 1963). Understanding how emotion translates across text is important because without understanding, interacting with the associated individuals will be a challenging task, which is why an analysis of their language is critical (Yarkoni, 2010; Hopwood, et. al, 2011). Peers also have an advantage in determining what an individual's personality is because their assessment of others make it easier to produce a model that can categorize each of their ratings and know who is best placed in which category.

Personality interaction and understanding provides the basis of analysis for tone and sentiment uniquely and fashionably. The approximately eight emotional utterances or basic emotions are: (a) joy, (b) sadness, (c) anger, (d) fear, (e) analytical, (f) candid, (g) tentative, and (h) confident. These can be measured using language (Erwina, Chayanara, Syarfina, & Gustianingsih, 2014). The top five tones are expressed as an emotion: joy, sadness, anger, fear, and disgust (Sidana, 2017).

Engagement

In the current study, engagement is “a holistic psychological state in which one is cognitively and emotionally energized to behave in ways that exemplify the positive ways in which group members prefer to think of themselves” (Ray et al., 2014, p. 53). Engagement refers to commitment, passion, involvement, absorption, zeal, energy, dedication, and enthusiasm (Schaufeli, 2013). Twitter defined engagement as the “total number of times a user interacted with a Tweet. Clicks anywhere on the Tweet, including retweets, replies, follows likes, links, cards, hashtags, embedded media, username, profile photo, or Tweet expansion” (Twitter, 2018, p. 5).

For the current study, engagement was assessed through a consumer-based perspective on two levels. First, a low-level engagement of customers is defined as content-only consumers (Agostino & Arnaboldi, 2016) and second, as high-level engagement consisting of those that generate content (Boulianne, 2015). For example, on a social media platform such as Twitter, some followers only view content and fail to comment, like, or retweet (level one), while others will retweet, like, and retweet (level two). To date, however, no study provided a consensus on what constitutes a social media platform's overall engagement (Perreault & Mosconi, 2018).

Twitter is the social media platform of choice for the current study, the goal of which was to reveal how engagement happens via variables such as tone, sentiment, lingo, and pulse. IBM's Watson Tone Analyzer measured these variables. The association of engagement and tone with a social media leader's social media voice helps machines and humans cross the fine line of just detecting human emotion in generating the tone. The ability to measure and use tone accurately helps business, government, and organizational leaders increase engagement and make better decisions within these systems. Twitter's signature character limits direct engagement in site-specific ways relative to digital rhetoric. Social and technical factors also affect a user base where perception shapes the critical masses using social media (Di Gangi & Wasko, 2016).

Language Lingo and Social Media Jargon

[PTO2]Emoji. An emoji signifies a digital image, an icon, and character to express an idea or emoticon (Thompson, 2016). An emoji is also a visual representation of emotion, symbol, or object (Da Costa, 2018). Emojis are a prevailing vehicle for branding. The more individuals continue to use mobile messaging the greater their desire for more emoji alternatives (Emogi Research Team, 2016). For instance, Twitter increasingly introduces new emoji options ranging from entertainment to history and politics. About 92% of people online are now using emojis to a point that they are replacing expressions such as LOL and OMG with the * face with tears of joy (Thompson, 2016). Emoji is resourceful in today's online writing or communication, especially when an individual has the words and lacks the tone of voice (Thompson, 2016). In addition, an emoji is an effective nonverbal feature that conveys an ambient presence when words are unnecessary.

Abbreviations, specifically RT. Abbreviations refer to shortened words or phrases such as RT (retweet) on the Twitter platform. The abbreviations are an important feature on Twitter given the character limit that demands the use of minimal words as possible to convey a message. In addition, Twitter abbreviations and acronyms are an odd mash-up of a slang, common sense short forms, corporate buzzwords, and old-school chat room phrases (Fisher, 2012). Zarrella (2009) discussed the use of retweets and its effect on Twitter users. Retweets refer to a feature on the Twitter social media platform that allows a user to report a tweet by another user. Retweets are a significant feature in Twitter, primarily allowing a post to reach a wider audience (Zarrella, 2009).

What is jargon? Jargon refers to specialized vocabulary peculiar to certain individuals in a profession, trade, and science (Ong Hai Liaw, 2013). Jargon can be a vague language, gibberish, or specific language dialect. Hudson (1978) defined jargon as writing that uses technical words that are intelligible; each social media platform is developing its own vocabulary. Hudson, however, maintained that when a jargon word confines a certain group, profession, and trade then it becomes a useful word. Hence, in the online community, jargon words are useful and make sense in that area but may not make sense in another group.

Hashtag. A hashtag refers to a phrase preceded by a pound sign (#), usually meant to identify messages on the specific topic of interest that facilitates its search. Notably, Trump has his favorite and commonly used hashtags, including #MAGA, or in full, #MakeAmericaGreatAgain and #AmericaFirst (Davis, 2018).

Mention. A mention refers to a situation where an individual namedrops another on a social media platform post. In addition, it refers to an occurrence when a keyword, hashtag, or monitored brand is used on a social media post. It is identified by the symbol @ and followed by the user's name on that social media platform. For example, Donald Trump's handle name @DonaldTrump was taken, so he opted for @realDonaldTrump on Twitter. According to Lampos, Aletras, Preo?iuc-Pietro, and Cohn (2014), @mention is a good indicator of high user activity and interactions online.

URL. A URL stands for Uniform Resource Locator and address of a resource available on the Internet, developed in 1994 by Tim Bernes-Lee (Lloyd, 2018). A URL sometimes denoting a web address is a unique identifier used to access a resource online. It contains strings and protocol details that help download resources on the Internet (Varga, 2016). Hence, a URL is a web address or a standardized naming convention that helps in addressing documents accessible online.

What is lingo. Lingo refers to a particular vocabulary or language unique to a specific people, region, or subject. According to Beal (2016), lingo is known to a person within it but is unusual and difficult to understand for people outside the environment in which it is used. Lingo is usually a special language used by a particular group of people on a specific subject. The language of Twitter or social media understanding helps to understand the jargon or lingo being spoken. Each of these hashtags, emojis, mentions, URLs, and abbreviations help decipher and give value to what is important when looking at the structure of a message on Twitter. Donald Trump's use of these social media lingo and proficiency provides insight to his engagement interactions by his followers.

Engagement via Social Media Voice Social media voice refers to using tone, sentiment, lingo, and pulse to create and express significant messages and message maps that direct a system's interactions with others on social media platforms (Kim et al., 2016). Social media voice is an example of effective digital rhetoric and assists in creating significant messages and maps that direct a brand in its interactions with customers across social media platforms. Leaders of organizations who wish to prosper on social media platforms or business need to showcase their brand by using a natural online voice (Charlesworth, 2014) because social media voice comprises understanding digital rhetoric. Digital rhetoric situates brand persona first, then suitable message tone, and last, the intended language to communicate effectively in each post made on social media (Platon, 2014).

Leaders aim to establish an effective tone to contact their followers and to increase the interactions. Through shares, likes, and replies to the comments of followers on their posts, leaders can increase social media engagement, which will have a positive impact both online and offline (BigCommerce, 2018b). The manner through which a brand communicates with a consumer influences the process of shaping the attitude the consumer will have and the decision whether to push the relationship beyond the social media encounter. Engagement allows one to measure which of these is significant: tone, sentiment, lingo, and pulse. 13 illustrates types of engagements, how they are measured, and where Twitter is found in the category of content creation and high engagement among the types of social media engagement.

A persona is how one views oneself; for example, if I identify as a blogger, then my persona would be of a blogger.

Following and Follower Growth on Twitter

Social media engagement on social media platforms is measured by the number of public shares, likes, and comments mostly for a business account (BigCommerce, 2018b). Each of the social media platforms has its means of expressing appreciation for posts made, including following and retweets on Twitter, likes and shares on Facebook, as well as likes and following on Instagram. A follow signifies a user who decides to see all posts made by another person in his or her content feed (BigCommerce, 2018a). According to Walker (2018), follower refers to people who subscribe or follow another Twitter user's tweets. The system may rely upon the following information: As Twitter continued to gain popularity as a social media platform, so did Donald Trump (Hoffman, 2017). His established activity on Twitter provided the correct digital lingo or words to reach a particular group of people online (BBC News, 2016). This is supported by studies showing how words may be used to express certain emotions in certain online contexts (Ghazi, Inkpen, & Szpakowicz, 2014). Donald Trump's use of Twitter lingo such as hashtags enabled him to convey information and emotion. For instance, the phrase “Making America Great Again” and the hashtag #MAGA captured the attention of his followers at an emotional level, especially the American citizens who believed that the United States needed to reclaim its lost glory. This belief enabled him to gain great support in the 2016 elections, creating and maintaining a hashtag around this slogan “Making America Great Again” or in digital lingo, #MAGA, as shown in 19 below. The all-time popularity of this hashtag has been at 81.4, according to Hashtagfiy.me, and as of Aug. 23, 2018, popularity ratings were 83.2. Hashtagify.me measures on a scale from 0 to 100, with 100 as the most popular hashtag on Twitter.

The popularity of Hashtag of Donald Trump's message “make America great again,” defined as #MAGA on hastagify.me is well known. Donald Trump's use of hashtags in his tweets can either increase his engagement or decrease it. In this research study hashtags are under the Lingo variable and aide in understanding digital rhetoric. The research study argues that hashtags have been used to create tone. For example, the hashtag #not really while others help identify the branded leadership persona of the account holder. For example, when Donald Trump uses #potus (world leader persona) or #MAGA (candidate persona) or #trumptower (business executive persona).

Persona is a social media leader's online identity. Donald Trump's leadership roles, as based on his number of tweets and their dates, include: (a) the businessman persona, all tweets from May 4, 2009 to Jun. 15, 2015; (b) the political candidate persona, all tweets from Jun. 16, 2015 to Nov. 7, 2016; and (c) the world leader persona, all tweets from Nov. 8, 2016 to May 21, 2018. These role changes came with a change in profile information, biography, and background image. This online branding indicates to the user a visual change in tone of the identity to the follower. The criteria for identity have been outlined based on the time of Donald Trump's announcements of leadership role changes, such as when he announced that he was running for office in 2015 for President of the United States.

The system may divide a person's account into separate personas as follows: The justification for dividing Donald Trump's tweets into three personas separates the data into distinct leadership roles he played during each period. A possible change in persona may have systemic effects on how much his social media voice predicts his tweet engagement. Persona 1, the business executive, covers the period from Mar. 9, 2009 until the day he announced his candidacy for President of the United States. As a business executive, he was famous for his entrepreneurial ventures and his show, The Apprentice. Persona 2, the candidate persona, shifted Donald Trump's social media relevance into the political arena, therefore, potentially shifting how much his social media voice relates to tweet engagement. Persona 3, the world leader persona, began the day Donald Trump became President of the United States and continued through May 21, 2018. Creating Persona 4, called the social media leader persona, which is the summation of the three personas, allowed examining whether Donald Trump's social media voice has consistent effects on follower engagement despite his having three distinct real-world personas.

The system may collect and analyze all tweets responses of single account, such as the @realDonaldTrump account for social media voice, which comprises the four independent variables—tone, sentiment, lingo, and pulse. The system may collect tweet responses for a plurality of users.

The IBM Bluemix Cloud Platform may be integrated with a website to run the data in real-time, and data backup or repository stored the data on the public website, www.TwitterStudy.org, which will be accessible for future research studies. The primary instrument of the system may be IBM Watson Tone Analyzer® to quantify tone and sentiment. IBM Watson Tone Analyzer® may be used to examine undersized Web data, including tweets, blog posts, email, and longer documents (IBM Cloud Docs, 2017). The tone analyzer may use natural language understanding, AI, and machine learning to create more accurate predictions of the tone and sentiment of written texts (Moreno & Redondo, 2016).

Social Media Voice

1. Tone: The intensity ranges from 0 to 1. Anything over 0.05 is considered significant by IBM Watson Tone Analyzer®. The dominant intensity was the highest value from the range 0 to 1. There were seven types of tone broken into two categories (emotional or language). The emotional tones were (a) joy, (b) sadness, (c) anger, (d) fear. The language tones are (e) analytical, (f) tentative, and (g) confident.
2. Sentiment: The intensity scale ranged from −1 to +1. The direction of sentiment is negative (a negative number indicates negative sentiment) and positive (a positive number indicates positive sentiment).
3. Lingo: The social media language, symbols or lingo of the tweet consisted of five variables, the mention (@), hashtag (#), URL, emoji, abbreviations RT (retweet) capital R and capital T.
4. Pulse: Pulse was a compound measurement of communication created based on frequency deviation (subtracting the number of messages sent during a time period minus the average number of messages within that same time period) and volatility (which uses the coefficient of variation to measure by taking the standard deviation and dividing it by the mean). (Appendix J shows a sample calculation of volatility).

Engagement

1. A number of likes: The number of favorites or likes of each specific tweet the day the data were extracted on Nov. 6, 2018.
2. A number of retweets: The number of retweets of each specific tweet the day the data were extracted on Nov. 6, 2018.
3. A number of replies: The number of replies to each specific tweet the day the data were extracted on Nov. 6, 2018.

Personas

Business executive persona: Includes all tweets of @realDonaldTrump from May 4, 2009, to Jun. 15, 2015.

1. Political candidate persona: Includes all tweets of @realDonaldTrump from Jun. 15, 2015 (starting at 11:57 a.m.) to Nov. 7, 2016.
2. World leader persona: Includes all tweets of @realDonaldTrump from Nov. 8, 2016 (starting at midnight) to Nov. 6, 2018.
3. Social media leader persona: Includes all tweets of @realDonaldTrump from May 4, 2009, to Nov. 6, 2018.
21. Tweet from Twitter @realDonaldTrump's verified account on Jun. 16, 2015.
I am officially running for President of the United States. A tone analyzer, such as IBM Tone Analyzer®, may identified the type of tone as tentative and a tone type of 0.69. This tweet may be used by the system to start calculating the political candidate branded leadership persona.

Specifically, the tweets or messages may be separated into three time periods endpoints: (a) the day of announcing his candidacy, (b) the day after Election Day, and (c) the end of day Nov. 6, 2018. The tweets may be separated into these personas and assigned a color for identification: orange for the business executive, blue for a political candidate, and purple for world leader persona. world leader).

Instrumentation

Data collection instruments refer to the devices used in a study to collect data (Bastos et al., 2014). In this study, the researcher used a series of devices and developed a research website called www.Twitterism.com with a secure login and public dashboard display (see 30. IBM Watson Tone Analyzer® is a computer system that answers questions and capable of identifying a natural language's tone and sentiment (Gliozzo et al., 2017). The IBM Watson Tone Analyzer®, natural language understanding Sentiment Analyzer® and natural language understanding software that offers a different application programming interface for analysis of texts through a process known as natural language processing. Natural language processing uses AI and computational linguistics that map the interaction between computers and human languages (Davydova, 2017). The instrumentation used in the collection of data is IBM Watson Natural Language Sentiment, Natural Language Artificial Intelligence Concepts, and Tone Analyzer. Other tools to be used to process the data are the IBM SPSS® software platform, which offers advanced statistical analysis, a vast library of machine-learning algorithms, text analysis, open-source extensibility, integration with big data; and Microsoft Excel (Appendix K provides a sample master table), data analysis tools and spreadsheet templates that can track and visualize data for this study (International Business Machines, n.d.). The instruments helped measure the tweets of the leader by providing sentiment polarity, fundamental concepts artificially implied by machine learning from each tweet, and seven specific types of tone.

Gathering tweets is possible using the sophisticated natural language processing software through a process call data mining. Applying Twitter application programming interface and software language python 2.7 data were pulled from the public database of Twitter. Tweepy is a tool for accessing the Twitter application programming interface and supports Python. The results received by the Twitter application programming interface was in JavaScript Object Notation (JSON) format, which focuses on the text attributes of each tweet and the information about the Twitter, account holder. JSON is used primarily to transmit data between two entities like a server and web application or vice versa standard ECMA-404 (International Business Machines, n.d.). Natural language processing software permits the operator to the user to take excerpts of important metadata from their concepts and sentiments (IBM Cloud Docs, 2017). As a result, the software helped to understand a leader's use of a complex human language and reveal significant engagement understanding with his followers.

The researcher inputs natural language, or data-mined into the software algorithms, which recognize features such as punctuation; n-grams (bigrams, trigrams, unigrams); emotions; greetings; curse words; and sentiment polarity to categorize various emotion groupings (IBM Cloud Docs, 2017). IBM used precision, recall, and F-score to evaluate the accuracy of its classification model (International Business Machines, n.d.). This model was used for the study to measure tone and sentiment because it demonstrated a high level of reliability and validity according to IBM scholarly research for quantifying other data (Peck, Olsen, & Devore, 2015).

IBM Watson Tone Analyzer® and natural language understanding provide unique analyses of tone and sentiment. They each have distinct algorithms to predict tone and sentiment accurately without confounding one another (Daffron, 2016). For example, “while a customer review may have an overall negative sentiment, particular keywords in the review may have a positive tone, which allows deeper analysis of the text” (Daffron, 2016, para. 7). Therefore, results could accurately distinguish tone from the sentiment in the same text if the text yielded a positive tone but negative sentiment or vice versa. This approach offered a unique opportunity to separate these two measures previously intermingled due to lack of existing technologies able to distinguish sentiment from the tone in the same text.

Then, using IBM Watson Tone Analyzer, evidence of tone was formulated into a numerical value by using a subset of artificial intelligence AI, called machine learning. The AI uses statistical techniques that grant machines the ability to increasingly advance performance on an exact task, in essence, to think for themselves or learn. Machine learning was applied, without being explicitly programmed to identify seven types of emotions: anger, fear, sadness, joy, analytical, confident, and tentative.

The IBM computer generated a value for tone and identified the type once an analysis of the data was submitted. For this research, the IBM Watson Tone Analyzer® and the natural language understanding tools were the instruments for collecting data. IBM uses precision, recall, and F-score to evaluate the accuracy of its classification model. The model demonstrates high accuracy when compared to a benchmark dataset (Peck et al., 2015).

Tone Analyzer

The IBM Watson Tone Analyzer® tool uses psycholinguistics theory, which explores relationships amongst linguistic behavior and psychological theories (IBM Cloud Docs, 2017). Psycholinguistic scholars work to comprehend whether the words we use daily reflect the real identity of an individual regarding who they are, how they feel, and how they think (IBM Cloud Docs, 2017). IBM Cloud Docs (2017) postulated that after years of research, marketing, psychology, and other fields reflect an acceptance that language does mirror more than humans wish to say. The IBM Watson Tone Analyzer® service uses linguistic analysis and the correlations between the linguistic features of a written text alongside emotional and language tones to develop scores for each of these tone dimensions.

Ferrucci et al. (2006) defined unstructured information management (UIMA) as a measure for carrying out analysis on textual content. Consequently, UIMA uses Watson but does not require to go through Watson to use UIMA. Notably, IBM's UIMA construction is open-source, and the Apache foundation funds it (Ferrucci et al., 2006). The incorporation into IBM Bluemix is a cloud platform as a service (PaaS) coined by the organization to support numerous programming languages and services. Additionally, the PaaS can support integrated DevOps to build, run, deploy, and manage cloud applications. Bluemix is an open technology referred to as Cloud Foundry, and it operates on Soft Layer infrastructure (Sehgal, Papoutsidakis, Srivastava, & Bansal, 2016).

The IBM Watson Tone Analyzer® was the primary instrument in the data collection process for the current study. The linguistic tone analysis tool was used as a means of detecting and analyzing both language and emotional tones from a text or a tweet in this context (IBM Cloud Docs, 2017). The tool was critical in this study since it can analyze tone at a file and sentence point. Hence, it was ideal for understanding how communications in written form are perceived and reacted to accordingly. Businesses have used this tool to respond to their customers appropriately, as it allows them to learn the tone used by the customers while communicating (IBM Cloud Docs, 2017).

According to Hedge (2016), IBM tone analyzer is essential since it provides for the ability to pinpoint areas in a text where emotion appears. Hedge (2016) further stated that for the tool to provide emotion scores from a tweet, it makes use of a stacked generalization-based ensemble framework that presents better predictive accuracy. Similarly, Mostafa et al. (2016) stated that “IBM Watson Personality Insights provides a deeper understanding of people's personality characteristics, needs, and values to drive personalization” (p. 385). The study entailed using IBM Watson™ natural language understanding because it eases the analysis of semantic features of concepts and sentiment. Furthermore, it can recognize high-level notions not openly referenced in the tweet, analyze the sentiment towards phrases, and the sentiment of the tweets (Riya, 2018). This feature supported analyzing the sentiment toward exact target phrases and the sentiment of the tweet as a whole. Sentiment information was also calculated for detected entities and keywords by enabling the sentiment option for those features.

A sentiment can be broken down into three groups such as, positive, negative, and neutral. Furthermore, natural language understanding offers multiple ways to excerpt sentiment (Beigi, Hu, Maciejewski, & Liu, 2016). What IBM referred to as document sentiment is the result of retrieving the primary sentiment feature and calculating a positive, negative, or neutral label as applied to an entire document (Buzek, 2017). The measurements were most helpful when looking at the 280 characters of the tweet made by @realDonaldTrump.

The measurement occurred using natural language understanding from IBM Watson, which offers some application programming interfaces meant to conduct text analysis via natural language processing. The application programming interfaces are capable of analyzing text, and understanding extensive characteristics, such as keyword, language, sentiment, emotion, entity, concept tagging, and taxonomy. All of these application programming interfaces were integrated into the website www.Twitterism.com to provide a visual representation of the data. The IBM Watson natural language understanding block allows the user to examine and track functions on the tweets, regardless of all the computation happening in the system such as examining the messages posted through Twitter, gauge tone, and filtering them to a specific concept.

The IBM Watson™ Tone Analyzer uses linguistic analysis to determine emotion and language form a written message; therefore, it is possible to analyze the document and the sentences (IBM Cloud Docs, 2017). The service is especially crucial for businesses to comprehend how a tweet is perceived by the consumer and is used to improve the tone communicated in a tweet. Moreover, this tool allows leaders in business to have an opportunity to comprehend their customers' sentiment and tone and then respond to each other's requests appropriately to improve customer relations. However, in this study, this tool was used not from a consumer perspective but from a brand's perspective. Below are the specific tools or instruments used in the collection of data for the current study.

Natural Language Understanding Sentiment and Tone Analyzer

The IBM Watson natural language understanding, sentiment, and tone analyzer tools are natural language understanding software that offers several programming interface application programming interfaces for analysis of texts through a process known as natural language processing (Davydova, 2017). The samples of selected tweets of @realDonaldTrump based on personas were applied, and each of the selected 36,696 tweets was entered into the Watson sentiment analyzing tool and then the Tone Analyzer tool. After copying and pasting the tweets, clicking on the analyze icon began the text analysis process. The feedback was be offered with the level of sentiment available, which can either be negative or positive. The tool also allowed for analyzing an exact target phrase sentiment for certain detected entities as well as keywords (PubNub, 2017). The tone analyzer tool gave feedback on the type of tone, the intensity of that tone, and the breakup of other tones found in the tweet. The dominant tone was extracted in this study, and that was determined by the intensity value of the type of tone (IBM Cloud Docs, 2017).

According to Gliozzo et al. (2017), natural language understanding is trained in an open domain, and with its custom annotation models, it is possible to customize further domain-specific entities, as well as relations in the chosen text. As a result, the natural language understanding custom model supersedes the typical entity recognition model (Gliozzo et al., 2017). The tool is essential since it allows for an in-depth analysis to take place, allowing for determining a positive tone despite the follower's reply being a negative sentiment. The tool has a sentiment score ranging from −1 to 1; negative scores stand for negative sentiments, and positive scores indicate positive sentiments.

According to Daffron (2016), natural language understanding builds on AlchemyLanguage, its predecessor, making it a leader in the analysis of texts due to the key improvements added. For example, whereas a customer review could have a general negative sentiment, then specific keywords in the review might have a positive tone allowing more in-depth analysis of a text (Daffron, 2016). Braun, Hernandez-Mendez, Matthes, and Langen (2017) stated that natural language understanding involves the extraction of structured semantic information from unstructured input languages, such as the chat messages or tweet replies that are being analyzed in this research. To extract the semantic information effectively, natural language understanding attaches user-defined labels to messages (Braun et al., 2017). 22 demonstrates an analysis of unstructured data using Watson natural language understanding. This study applied natural language understanding and tone analyzer via Watson Assistant. All data tweets are in a SQL file repository and third-party applications web application called Twitterism to display publicly the results of the research of @realDonaldTrump's social media voice.

IBM measured the validity of the Tone Analyzer service, and below are the results. In statistical analysis, the F1 (macro-average) score is a measure of the test accuracy; it is the weighted average of the precision (1 is the best value and 0 the worst):
Emotional tone categories were benchmarked against standard emotion datasets, including ISEAR and SEMEVAL. The results showed that the ensembles model average performance for ISEAR and SEMEVAL (macro-average F1 score around 41% and 68%, respectively, for the two data sets) is statistically better compared to the best-reported accuracy of the hi-tech models (with a macro-average F1 score around 37% and 63%, respectively) (Agrawal et al., 2017).
Language tone was evaluated with a detailed study of over 200,000 sentences gathered from sources, including debate forums, speeches, and social media. Among the sentences, 1,330 sentences for analytical tone and 1,000 sentences each for confident and tentative tone were selected. Then the sentences were submitted to the Tone Analyzer service, and humans were requested to analyze them as well (Agrawal et al., 2017).
For the human analysis, IBM used the crowd-sourcing platform referred to as CrowdFlower to explain the chosen sentences with diverse tags. Only those with an approval rating of more than 85% were permitted to take part in the annotation tasks. The final labels were chosen from the most prevalent of five selected annotated results (Agrawal et al., 2017).
For analytical tone, humans labeled 915 of the 1,330 sentences as analytical, 411 as non-analytical, and four as not understandable. Via the comparison of the predicted label with ground-truth labels, the analytical tone detection acquired an F1 score of 0.7518 (Agrawal et al., 2017).
For a tentative tone, humans labeled 292 of the 1,000 sentences as tentative, 706 as non-tentative, and two as not understandable. Through the comparison of the forecast label with ground-truth labels, and it received an F1 score of 0.6369 (Agrawal et al., 2017).
For a confident tone, humans labeled 623 of the 1,000 sentences as confident, 374 as non-confident, and three as not understandable (Agrawal et al., 2017).
By likening the predicted label with the ground-truth labels, confident tone detection received an F1 score of 0.7288. The total differences between the predicted and ground-trust labels are not statistically significant, and the finding designates that the service performs fine (Agrawal et al., 2017).
   23. Illustration by the author displays the type: independent, dependent, control variable (CnV), category, variable, level of measurement (ratio or nominal).
   For example, the tone is being measured first for intensity and then identifying the type.

Independent Variables

Tone. IBM Watson™ measures seven types of tone: (a) joy, (b) sadness, (c) anger, (d) fear, (e) analytical, (f) tentative, and (g) confident (Bhuiyan, 2017). These types are divided into two categories: (a) emotion, consists of joy, sadness, anger, and fear; and (b) language, which consists of analytical, tentative, and confident. Each type of tone comes with an intensity score ranging from 0 to 1. If a type of tone was not detected, the IBM tool produced no score. The tweet was given a score of 0 for that tone. If a tweet yielded two or more types of tone, the highest value type of each tone was the dominant tone used in later analyses.

The artificial intelligence software's Tone Analyzer tool indicated the tweet, “Make America Great Again,” had a joy tone of 0.66 and a score of 0 on all other tones. The tweet “DACA was abandoned by the Democrats. Very unfair to them! Would have been tied to desperately needed Wall” (@realDonaldTrump, 2018) received a sadness score of 0.60, a confident tone score of 0.94, and a score of 0 on all other tone variables. Therefore, in future analyses, this tweet would have a tone score of 0.94 with confidence as the dominant tone; the sadness tone score would not be considered in later analyses. 24 presents the interface of the tone analyzer; 25 presents an example of the output with scores from the tone analyzer.

24. IBM Tone Analyzer presents an example of Watson's′″ output of tone intensity and type.
The screenshot was taken from a public website located at IBM Watson Developer Cloud at https://tone-analyzer-demo.ng.bluemix.net/. Copyright 2018 IBM for educational purposes only.
25. IBM tone analyzer output of Tweet analysis “Make America Great Again” results in emotional tone “Joy.”
The screenshot was taken from a public website located at IBM Watson Developer Cloud at https://tone-analyzer-demo.ng.bluemix.net/. Copyright 2018 IBM for educational purposes only.

Sentiment. Sentiment analysis is defined as the procedure of computationally identifying and cataloging views articulated in a message, specifically to comprehend whether the sender's attitude toward a particular topic, product, among others, is either negative, positive, or neutral (Jhaveri, Chaudhari, & Kurup, 2011; Pearl, 2016). Social media sentiment yielded two variables for sentiment: (a) intensity and (b) polarity. Mohammad and Zhu (2014) defined sentiment analysis as the assessment as to whether a text is positive, negative, or neutral.

Sentiment polarity is divided into positive, negative, or neutral. Intensity ranges from −1 to 1. Intensity scores between −1.0 and −0.1 indicate a negative polarity, 0 scores are neutral, and scores from +0.1 and +1 indicate a positive polarity. An example would be a @realDonaldTrump tweet made on Jun. 16, 2017: “The Fake News Media hates when I use what has turned out to be my very powerful Social Media—over 100 million people! I can go around them” (realDonaldTrump, 2017). This tweet had a score of −0.8 when processed by the IBM Watson™ advanced text analysis. The tweet would receive a sentiment intensity score of −0.8, and the sentiment polarity would be negative. 26 provides a screenshot of the IBM sentiment analyzer.

26. The interface of the sentiment analyzer.
Overall sentiment on “fake news” gives a value of −0.80 located at the bottom of the. The screenshot was taken from a public website located at IBM Watson Developer Cloud at https://natural-language-understanding-demo.ng.bluemix.net/Copyright 2018 IBM for educational purposes only.

Lingo. Lingo is defined as the language, and social media lingo in this study refers to the different Twitter practical language utilized by users to communicate (Oxford Dictionaries, 2014). In this study, the term lingo refers to the practical language used by Twitter users. Social media lingo is a type of language that contains atypical language or technical expressions. The umbrella independent variable, lingo, consisted of five components: (a) mentions, (b) hashtags, (c) abbreviations like RTs (retweets), (d) post link or URLs, and (e) emojis (each defined in more detail below). Each component of the lingo variable yielded a score of 0 (does not appear in the tweet) or 1 (appears in the tweet). Lingo—the social media language, symbols, or lingo of the tweet—was measured by five variables: (a) the mention (@), (b) hashtag (#), (c) URL, (d) Emoji ( ) and (e) abbreviations (RT). 27 shows how each social media platform differs in its emoji representations.

27. Emoji representations illustration from the author of the different emojis on various technology platforms.
For example, a turban emoji identified by the term “turban” has various symbolic, iconic, and graphically differences. The emoji tone is each image is different but named the same. In 2015 skin tones were added to emojis. The study will look at if a tone is present within a tweet.
1. Mention includes @handle in the text of the tweet at any point other than the beginning.
a. The symbol or icon is the @ or. @ sign before a Twitter username called a handle. Mentions used to be known as replies.
b. An example of mention of a person would be @realDonaldTrump tweet made on Mar. 3, 2017: “We should start an immediate investigation into @SenSchumer and his ties to Russia and Putin. A total hypocrite! https://t.co/lk3yqjHzsA” (@SenSchumer is the mention of U.S. Senator Chuck Schumer).
a. The hashtag is a type of metadata tag used to generate tagging, which makes it possible for others to find messages of topics within Twitter easily. The symbol or icon is # sign before a keyword or phrase that identifies with something or someone.
b. An example of a hashtag would be @realDonaldTrump tweet made on Jul. 2, 2017: “#FraudNewsCNN #FNN https://t.co/WYUnHjjUjg” (#FraudNewsCNN and #FNN is the abbreviation hashtag for Fraud News CNN, are the two hashtags in this single tweet).
2. Abbreviation, for example, RT (retweet) at the beginning of a tweet illustrates that a user is re-posting someone else's content by the abbreviation and capitalization of an R and a T. Other abbreviations would be b/c (because), BTW (by the way), B4 (before) or w/(with). In this study, abbreviation, sample sizes of 200 or more were taken into consideration. An example of an RT would be @realDonaldTrump tweet made on Oct. 24, 2012: “RT @ReutersPolitics: Trump to give $5 million to charity if Obama releases records http://t.co/xCQbR1j2” (the capitalization R and T are placed before the tweet).
3. Post Link or URL is the address of a World Wide Web page (Beal, 2016).
a. The symbol is identified by lettering www. Additionally, the use of HTTP (Hypertext Transfer Protocol), https (Secure Hypertext Transfer Protocol), or any web link that connects to a web page. All links (URLs) posted in Tweets are shortened using our http://t.co link service, and in each tweet, the original URL or a shortened version of the original URL by a third party can be displayed in a tweet. Multiple URLs can also be displayed. The total number of URLs and their type were collected. Note: the content of these URLs was not analyzed.
b. An example of a URL would be @realDonaldTrump tweet made on Feb. 11, 2011: “Watch my speech at CPAC in Washington D.C. yesterday . . . http://www.youtube.com/watch?v=PR1b8yKxcAo” (the URL is http://www.youtube.com/watch?v=PR1b8yKxcAo, referring to YouTube channel video that is no longer available).
a. Emoji is a digital image, symbol, or icon that express is an idea, emotion in electronic format (Oxford Dictionaries, 2014). Because each technology platform has emerged at different times, the emojis are represented differently in each platform but have a common theme or name structure. For example, emojis with turbans have different images based on technologies but are named the same. The symbol of an emoji on Twitter is unique, and the introduction of hashflags unique to Twitter lingo can be found in 9 above, represented by a cartoon mini icon.
b. An example of an emoji would be @realDonaldTrump tweet made on Jul. 21, 2017: “Six months in—it is the hope of GROWTH*that is making America * FOUR TRILLION DOLLARS *RICHER.”-Stuart @VarneyCo *https://t.co/s7fYOicWGV https://t.co/x9MeUzDom6″ (there are three emojis: * chart increasing, * money bag, and * movie camera.
28. An example of a tweet from @realDonaldTrump that illustrates data fields that could be extracted from a single tweet.
The image is from Twitter.com and designed by the author of this study. For example, the tweet highlights all the sub-variables of lingo: hashtag, mention, URLs (post link), abbreviations, and emojis.

Pulse. Social media pulse is the fourth independent variable for the study. This variable is the number of minutes between tweets. The researcher looked for the rate of in-between social media posts (tweets) to comprehend their relationship with follower engagement (likes, retweets, and replies). This pulse variable has a rate that captures statistical burstiness of each tweet posted. In statistics, burstiness refers to the intermittent increases as well as the decreases in activity or frequency of an incident. Doyle et al. (2016) stated that interactions happen whereby people happen to speak very frequently for short blasts and then go silent after a while for an extended period. Doyle et al. (2016), Hendrickson and Montagu (2016), and King (2017) described burstiness as the increase and decrease in the frequency of activity of an act specifically communication of unexpected events. In communication, burstiness is a characteristic involving data that are transmitted intermittently, in bursts, rather than a continuous stream (Winslow, 2017).

The social media pulse or pulse refers to the unforeseen events that happen simultaneously and have been defined as shared by many observers who witness them (Hendrickson & Montague, 2016). In such unexpected events, the witnesses are most likely to pick up their phones and computers to share what they have experienced with the rest of the world via a social media platform such as Twitter. According to Hendrickson and Montague (2016), as the witnessing event happens, and large data are being uploaded, the events mature in time as a sharper inactivity rate and then exponentially decay.

In this study, the pulse variable measured the intermittent increases and decreases (rate) of the frequency of tweets posted per hour within a 24-hour period labeled as frequency deviation. The pulse rate was then assigned to each tweet for that day; hence, for every hour, the researcher measured how many tweets were made. Additionally, the researcher took that number of tweets per hour and within a 24-hour period and calculated the pulse rate for the day for each tweet. This calculation was done by coefficient variation, which was calculated on a day-by-day basis. The coefficient of variation (CV) is applied specifically while comparing results from two surveys or tests with dissimilar values or measures (Statistics How To, 2018). The formula for the coefficient of variation (CV) is:

Coefficient of variation=(standard deviation/mean)

CV for a population:
CV=sigma/mu. All times 100%
CV for a smaple:
CV=S/x bar. * 100% In symbols: ? is the standard deviation for a population, similar to “s” for the sample. ? is the mean for the population, which is the same as the XBar in the sample. In other words, to acquire the coefficient of variation, divide the standard deviation by the mean and multiply by 100. Therefore, each tweet within the same day was assigned the same coefficient variation score, yielding the fourth independent variable of the pulse. Changes in pulse per day were used to examine associations of tweet engagement. The formula for this calculation is as follows: coefficient of variation=(standard deviation of tweets per day/mean number of tweets per day, as shown below:

$$CV day 1 = \frac{SD day 1}{Xbar day 1}$$

Standard deviation is calculated by each value x (the set of the tweet data), subtracting the overall avg(x) (the mean average of all value x in the dataset of tweets) from x, then multiplying that result by itself. The standard deviation informs individuals about the amount of data spread out from the mean or the scores close to the average. The standard deviation is a measure of distance, and for it to be calculated, one must first calculate the sum of all those squared values (Nolan & Heinzen, 2010), then divide that result by (n−1) (n is the number of values of x in the dataset of tweets), then find the square root of that last number. Once these calculations of the CV were done, the pulse rate for the day was used as the independent measurement for each tweet that day. This calculation was done for all 9 years of tweets from May 4, 2009, to Nov. 6, 2018, to see how the pulse rate increases, decreases or has no effect on follower engagement on a social media post.

For example, if there were 12 tweets in a day, the mean was 0.5 (12 tweets divided by 24 hours). If all 12 tweets were posted within the same hour, the standard deviation of tweets posted per hour was 2.5, yielding a pulse score of 5 for that day. All 12 tweets that were posted that day would be assigned a pulse score of 5. If on a different day, 12 tweets were posted with one tweet posted per hour, the standard deviation of tweets per hour would be 0.51 and the mean number of tweets per hour would be 0.5, yielding a pulse score of 1.02. These two examples of pulse scores calculated illustrate that days with the same frequency of tweets can have very different pulse scores depending upon how close in time the tweets were posted. This calculation allowed examining if variations in tweet burstiness per day are associated with tweet engagement. In the analyses, the pulse rate was included as an independent variable to examine if the time between tweets predicts engagement. The distribution of this variable was considered carefully before any analyses were conducted.

Persona. For this study, the persona was operationally defined as the time frame in which the leader has changed his Internet identity by changing his persona during his change of leadership role. These leadership roles include: (a) the leader's business executive persona, which included all tweets from May 4, 2009, to Jun. 15, 2015; (b) the political candidate persona, which included all tweets from Jun. 16, 2015, to Nov. 7, 2016; and (c) the world leader persona, which included all tweets from Nov. 8, 2016 to Nov. 6, 2018. The change in personas is usually accompanied by a change in the profile picture, bio, and background image. This online branding indicates a visual tone change of the identity to the follower. The criteria for choosing the timeframe were outlined based on time of announcements of leadership role changes, for example, when Donald Trump announced that he was running for office in 2015 for President of the United States. Another example would be the night of the election when he was elected as the 45th President of the United States to become a world leader.

Dependent Variables

The dependent variables pertain to tweet engagement. The three dependent variables for tweet engagement are the number of likes (positive attitude), the number of retweets (shares), and the number of replies (responses), as follows.

[PTO3]Like. Like is represented by this icon on Twitter (heart). For this study, the dependent variable of likes was operationally defined as the number of likes of each specific tweet when the data were extracted on Nov. 6, 2018. Like or likes are represented on Twitter by a heart icon or button (Twitter, 2017). Liking is a form of engagement that allows users to show appreciation (Twitter, n.d.). Like is defined as a way for a digital user to convey an attitude or feelings in the form of direct speech (Stevenson, 2010). Likes were once called favorites, or faves, and were represented by a star icon (*) until Nov. 3, 2015. Twitter pre-dates Facebook and Tumblr's like button. The favorite button was an engagement button like the thumbs up like button on Facebook (Parsons, 2015). The engagement of alike used for Tweets (messages of 280 characters) or Moments. The @realDonaldTrump account has liked heart icons at the bottom of each textual tweet sent. An example of the number of likes of one specific tweet is: “Such a beautiful and important evening! The forgotten man and woman will never be forgotten again. We will all come together as never before.”—@realDonaldTrump tweet on Nov. 9, 2016, had [heart] 633253] likes by Twitter followers.

Retweets. Retweets are represented by this icon on Twitter (*). A retweet or RT is stated to be a re-posting of a persona, or another person's tweet (Twitter, n.d.). For this study, the dependent variable of retweets was operationally defined as the number of retweets of each specific tweet when the data were extracted on Nov. 6, 2018. Retweets are a form of engagement that allows users to pass, share, or amplify a tweet with another user on Twitter. The retweet icon or button is represented by users who retweet and have an option to share their social media voice before retweeting. The Twitter retweet icon or button is a box made of two clockwise arrows. The author's handle is automatically added to the retweet. Users can retweet their tweet or re-post. The digital number of times each tweet has been retweeted appears on each tweet. An example of the number of retweets of one specific tweet is: “#FraudNewsCNN #FNN https://t.co/WYUnHjjUjg”-@realDonaldTrump tweet on Jul. 2, 2017, had [RT 369,530] retweets by Twitter followers.

Replies. Replies are represented by the speech bubble icon Twitter (*). A reply on Twitter is defined as a response to another individual's tweet using the reply icon (Twitter, n.d.). The dependent variable of replies was the number of replies to each specific tweet when the data were extracted on Nov. 6, 2018. Replies on Twitter occur when users comment on or mention someone they follow with their tweets. Replies only appear to the user who replied to the feed, the user's feed, and the feeds of users who follow each other. The reply button used to be a curved arrow that rotates counterclockwise but was upgraded to a speech bubble icon on Jun. 15, 2017. The digital number or replies of each tweet is shown next to some likes and RTS. An example of the number of replies of a specific tweet is: “#FraudNewsCNN #FNN https://t.co/WYUnHjjUjg”—@realDonaldTrump tweet on Jul. 2, 2017, that had [137,000] replies by Twitter followers. 29 is an illustration by the author of the icons used by Twitter of the dependent variables that will be measured by followers of @realDonaldTrump

29. The icons used by Twitter users to create engagement on a tweet.

For example, the heart ion, when pressed, will be filled in color, and a like will be assigned to that tweet adding to the tally of the number of followers who click on the icon or heart symbol.

Control Factor: Number of Followers

Follower growth refers to the number of followers who choose to follow another Twitter user account by clicking on the symbol or icon Follow button displayed on the user's Twitter account website or mobile application. Once this button is clicked, it will change the status to Following displaying an activation status of the relationship. Following is limited to 5,000 accounts total but can be readjusted by the ratio of the follower to following as defined by the Twitter Rules located at https://help.twitter.com/en/rules-and-policies/twitter-rules. The data from follower growth were collected from the website https://twitter.com/@realDonaldTrump data that were collected for the period of the study by using www.Twittercounter.com method that extracts a daily total of followers from October 2009 to August 2018 on a day to day basis from @realDonaldTrump Twitter account.

Follower growth or the number of followers was treated as a control variable in the analyses because of the engagement of tweets changes from day to day. The number of followers is not the same every tweet so by factoring this, there was some control over engagement during the 9 years of tweets. The reason for not using it as a dependent variable is that the data available only revealed the number of new followers day-by-day. All independent and dependent variables in the study were used to examine effects on a tweet-by-tweet basis. Therefore, due to the structure of the available data, follower growth was described and used to test any hypotheses as a control variable only because it can have an effect on the results. 29 provides an example of @realDonaldTrump's follower growth and tweets number from Nov. 1 through Nov. 8, 2017. By controlling for the number of followers every 24 hours in the research study will allow for more accurate insights on the association of SMV and engagement.

Follower data may be further analyzed by examining the following data to create an audience profile or persona of who follows by using data extracted by www.BirdSongAnalytics.com, which is listed in Forbes Magazine and defined as one of the top 10 social media analytics tools by researchers in 120 countries around the world. Public data from more than 50 million followers were extracted to help define the audience persona as part of the descriptive statistics in the study.

The system may take data from 56 million followers of @realDonaldTrump's Twitter as of May 25, 2018.

Data Collection

The first step of data collection by the system is to extract all of the messages created by social participants who share at lento ne the 35,647 tweets written between May 4, 2009, and Nov. 6, 2018, from Donald Trump's Twitter account, @realDonaldTrump. The data may bescraped (scraping is a technique in which a computer program extracts data from human-readable output coming from another program) by using a public code from github.com and placed into a master Excel spreadsheet, which consisted of 35,647 rows (one per tweet) and five columns. The five columns may be: (a) the scrape data of text of each tweet, (b) the number of likes for each tweet, (c) the number of retweets of each tweet, (d) the number of replies to each tweet, and (e) the timestamp of each tweet. After the data may bescraped, two additional columns may becreated with a unique ID number for each tweet and a categorical variable representing the three selected personas of Donald Trump as a businessman executive, political candidate, and world leader. This entire process may be done by DR Digital Labs.com. They helped organize the data and integrate IBM Watson application programming interfaces into a master spreadsheet that is HTML five integrated into a public domain for this Twitter study, www.twitterstudy.org

A score of 1 represented the business executive persona, a score of 2 represented the political candidate persona, and a score of 3 represented the world leader persona. When the social media leader persona was analyzed, all tweets from personas 1, 2, and 3 were included. A fourth persona was used as a label for the sum of all three personas known as the social media leader persona. The written texts of each tweet were entered in IBM Watson's Tone Analyzer® and Sentiment Analyzer®.

TABLE 1
Audience Profile Data Collected from 52,132,191 Million Followers
of @realDonaldTrump Were Measured to Describe to “Whom”
the Leader's Social Media Voice is Digitally Talking.

Label
Information
A non-identifying number
The Twitter account name
The real name was given by the user
The locator URL or weblink
The biography is given by the account holder
The total amount of followers
The total amount of following
The number of times a tweet has been sent
A link they have provided
When they created the account
They make their account private
Twitter has indicated as influential
The last time they sent a tweet
The gender they provided
User ID
Screen name
Real name (as given)
Twitter URL
Biography (Text)
Follower count
Following count
Tweet count
Biography URL (if provided)
Created date (date account joined Twitter)
Protected (true/false)
Verified (true/false)
Date of tweet
Gender (based on first name lookups)

The tone and sentiment scores were added to the spreadsheet. These scores yielded nine additional columns representing different variables of tone. The analysis of sentiment yielded three additional columns representing different variables. They are the intensity score of negative, neutral, and positive sentiment. Two of the three sentiment variables had incomplete data in each row, as each tweet receives an intensity score only in one of the three polarities of sentiment.

To create the remaining two independent variables, queries were conducted within Excel. Six queries conducted for the component of lingo. Additional columns were added for the mention, hashtag, URL, RT, and emoji. If these components were present in the text of the tweet, they received a score of 1; if not, they received a 0. Each component of lingo was added as an additional column representing different summary variables of lingo.

Finally, to create the variable of the pulse, the timestamp of the later tweet was subtracted from the target tweet, and the resulting numerical value was added as a new column of the corresponding tweet to represent the pulse of that tweet. Data from a separate scrape were also incorporated into the master data file. The number of Donald Trump's followers of each day was scraped previously and was included in an additional column in the master database with its matched timestamp. The master data file consisted of 35,647 rows of 27 columns. Frequency deviation and volatility was added to the excel spreadsheet while the number of followers were assigned to tweets within a twenty-four period to be used as a control variable.

Once the master data file was created, the data were exported to SPSS for data analysis and hosted on www.TwitterStudy.org. A separate data folder was created for @realDonaldTrump followers for data scraped from the BirdSong Analytics data file containing the demographic information of his 51 million followers from May 25, 2018. BirdSong Analytics was perfect for the study because it is a social reporting tool meant to run public reports such as those from Twitter, Instagram, and Facebook (Ney, 2016). Consequently, the tool was used to gather all tweets and information from Donald Trump's followers. These data were used to describe different demographic information of the leader's followers and were not used in any data analysis but rather in helping define the audience of the leader. This master data Excel file included geography, gender, time zone, the device used, the average number of followers, and date of account creation. This 40-million-follower file was scraped in conjunction with Bird Song Analytics. These data helped to define the audience persona of who correctly is engaging and to whom @realDonaldTrump is talking. Using the components, interface, and protocols, the researcher was able to integrate the Twitter application programming interface fully with the Web server (IBM Bluemix Hosting) and then create an interface between IBM Watson by use of the IBM application programming interface (API) which allows applications to communicate with one another via a website (www.twitterism.com).

Data Analysis Plan

The focus of the data analysis is threefold. First, the intensity score of the dominant tone, independent of the type of tone, was used to predict follower engagement simultaneously with the other three independent variables. This examination was done with multiple regression and hierarchal regression (to test if tone still matters) to examine whether the four independent variables (tone, lingo, pulse, and sentiment) associate with tweet engagement. The unique statistical relationship of tone was examined to predict social media engagement beyond the effects of the other independent variables. This approach helped provide a plan for answering RQ1 and RQ2.

The second step of data analysis involved examining if tweets with different tone categories had statistically different levels of social media engagement. To address RQ3, the social media engagement levels of tweets with a dominant emotional tone and tweets with a dominant language tone were compared via another multiple regression.

The third test was the use of multiple regression test to examine the three different types of persona and their association with tone intensity and type of tone intensity. A chi-square or ?2 test was used and ANOVA for all the tweets and identified the periods in which dominant tone type and the dominant intensity were shown during the three persona time periods. This approach helped provide a plan for answering RQ5.

Before data analyses began, correlations between the dependent variables and the independent variable of lingo were examined. This step served to examine whether the dependent variables or different components of and of the variables, including lingo, had significant overlap. If the significant overlap was apparent (e.g., correlations above 0.8), then data reduction was considered. If there was high redundancy between the dependent variables, a composite score of the redundant variables was created. This approach allowed for testing the effects of social media voice more efficiently. If the redundancy between the dependent variables was low, each analysis was conducted separately. Each variable was tested to ensure all assumptions of parametric data analyses are met. If any variable violated the assumptions of the specific analyses, appropriate action was taken.

Research Question 4

The fourth research question was addressed by examining if tweets with different dominant tone types within the tone categories had significantly different levels of tweet engagement. The statistical analysis that was used to examine this question is multiple regression. IBM Watson™ produces two different categories of tone, which are emotional (joy, fear, anger, and sadness) and language (analytical, confident, and tentative). Furthermore, these models allowed examining how the intensity of distinct types of tone affected tweet engagement, which was examined in the first two research questions. Similar to RQ1, RQ2, and RQ3, these analyses were conducted four times, one for each persona, and separately for each dependent variable. The fourth research question is divided into two parts. The first part (a) examines if tweets with different dominant tone types have statistically different levels of tweet engagement. In the second part (b), multiple regression is used to examine the tone intensity of each type of tone individually, while controlling for the number of followers. Similar to Research Questions 1 and 2, the researcher conducted these analyses twelve times, one for each persona, and separately for each dependent variable.

Research Question 5

The fifth research question was addressed by using a ?2 difference test to examine if different tone types and tone intensity were used significantly more frequently in the different personas (business executive persona, political candidate persona, and world leader persona). The chi-square or ?2 test was necessary since it examines independence across two variables or how well a sample fits the distribution of a specific population (Franke, Ho, & Christie, 2012; McHugh, 2013). The type of tone intensity was examined by conducting an ANOVA. Research question 5 examined whether there was a difference in tone (type and intensity) among the leader's three personas (business executive, political candidate, and world leader). Research question five has two parts. Part-1 pertains to the type of tone by the three personas, and Part-2 focuses on the intensity of tone by the three personas.

Part 2 looked at the type of tone intensity used statistical analysis via an analysis of variance (ANOVA). ANOVA is a collection of statistical models, and their associated variation among and between groups was used by the researcher to analyze the differences between group means in @realDonaldTrump Tweets and were broken into the various personas of business executive, political candidate, and world leader.

presents a real-time display of tweets, engagement, tone, sentiment on www.twitterism.com. The data displayed @realDonaldTrump's tweets in real-time, calculating the tone type (symbolized by the emoji), sentiment, lingo, pulse, and engagement (symbolized by the green and red arrows) illustrating the direction based on frequency and volatility of each tweet.

32. The web app will be found on the public URL www.Twitterism.com and will display the research in the following HTML interface. This page was designed by the author of the study.

Validity

The current study involved using quantitative methods to examine factors related to tweet engagement. As preliminary analyses, the inter-correlations of the dependent variables were analyzed to determine if any measures could be combined. If measures were highly correlated (i.e., Pearson's r>0.70) then data reduction was considered; if not, then separate analyses were conducted with each outcome variable (Simon & Goes, 2011). To examine how much of the variance in tweet engagement is accounted for by the independent variables, a multiple regression was conducted for each dependent variable. All independent variables were entered into the model to examine how much variance was accounted for overall, and the contribution of each variable. This process was done four times, one for each dependent variable.

Finally, a hierarchical regression was conducted to examine the unique effect of tone—above and beyond—the effect of sentiment on tweet engagement. In the hierarchical regression, the first sentiment was entered into the model, followed by a tone for each outcome variable. The order of entry allowed for examining the unique predictive effect of tone on levels of engagement after the effect of sentiment was removed. The order of entry was planned to be a conservative test of tone on levels of tweet engagement.

According to IBM Cloud Docs (2017), IBM found that about 30% of the samples had more than one associated tone; thus, IBM elected to solve a multi-label classification task rather than a multi-class classification task. For each tone, IBM trained the model independently by using a One-Vs-Rest paradigm. More importantly, the paradigm used the utterances for each class as positive samples and all other utterances as negative samples. IBM identified the tones predicted with at least a probability of 0.5 as the final tone. For several tones, the training data were heavily unbalanced; thus, IBM identified the optimal weight value of the cost function for each tone during training.

The system may use the following algorithm: social media tone was associated with engagement above and beyond the other variables. The study provided evidence that tone was significant in terms of its association with engagement or number of likes, retweets and replies. Specifically, the results showed that tone was associated with engagement in the social media leader person in both retweets and replies. The negative association indicated that as tone intensity increased, engagement (likes, retweets, and replies) decreased. However, there is one instance in which this polarity changes. In the world leader persona tone intensity was positively related to likes. Tone intensity increased in the leadership role as a world leader and so did the number of followers who liked Donald Trump.

The system may categorize the tone types into separate groups (language tones and emotional tones). This may be achieved by dummy coding the tone type variable so that all tweets with a dominant language tone were coded as one, and all other tweets coded as zero, creating a language tone variable. For purposes of this application, any reference to tweets may also refer to a social media message or message.

They system may analyze emotional tones such that all tweets with an emotional tone may be coded as one, and all other tweets coded as zero, to create an emotional tone variable. The system may conduct analysis for all tweets that do not have tone detected, such that tweets with no tone detected may be coded as one, and all other tweets may be coded as zero. The system may use a dummy coding process to conduct a multiple regression that examines the relationship between tweets with an emotional tone and follower engagement, as well as tweets with a language tone and follower engagement.

The result of the language and emotional tone variables may be included in the model revealed the association between the independent variable and dependent variable when compared to the dummy-coded variable not included in the model (Davis, 2018). In other words, if the language tone variable had a p-value of less than 0.05, and a positive beta weight, the result would suggest that language tones were associated with significantly more likes than tweets with no tone detected. If the beta weight were negative, that would suggest that the variable was associated with significantly fewer likes than tweets with no tone detected (Davis, 2018).

Likes

Likes may be as a metric for engagement on @realDonladTrump's tweets. The researcher sought to explain whether the different types of tone determined the number of likes a post received. Using multiple regression analysis, the system may examine the level of engagement based on the number of likes from tweets during the four persona periods.

Social media leader persona. The multiple regression analysis of a previous study revealed a significant negative effect on emotional tones while controlling for the other variables in the model, including the number of followers. This finding indicates that tweets with emotional tones are associated with a decrease in the number of likes in the social media leader persona. The results also revealed a significant positive effect on language tones, indicating that tweets with language tones were associated with an increase in the number of likes.

Retweets

Retweets may be used as a metric for engagement on a social media participant's tweets or published messages. The researcher sought to explain whether the various types of tone determined the number of retweets a post received. Using multiple regression analysis, the researcher explains the level of engagement based on the number of retweets during the four persona periods.

Social media leader persona. The multiple regression analysis revealed a significant negative effect on emotional tones while controlling for the other variables in the model, including the number of followers. This finding indicated that tweets with emotional tones were associated with a decrease in the number of retweets in the social media leader persona. There was also a significant and positive effect on language tones, indicating that tweets with language tones showed an increase in the number of retweets. Results are in Table 28.

Replies

Replies were used as a metric for engagement on @realDonladTrump's tweets. The researcher sought to explain whether the various types of tone determined the number of replies a post received. Using multiple regression analysis, the researcher explains the level of engagement based on the number of replies during the four persona periods.

Social media leader persona. The multiple regression analysis revealed a significant negative effect on emotional tones while controlling for the other variables in the model, including the number of followers. The findings indicated that tweets with emotional tones were associated with a decrease in the number of replies in the social media leader persona. The results also revealed a significant positive effect on language tones, indicating that tweets with language tones were associated with an increase in the number of replies. Results are in Table 30.

Emotional tone may be associated with a decrease in engagement. Language tones as defined by IBM Watson Artificial Intelligence Tone Analyzer, or a similar tone analyzer, may categorize the type of tones of, confident, analytical and tentative as language tones. The system may alter proposed messages so that the language tone exhibits higher levels of engagement. Depending on the persona, unless it is a world leader, the system may then alter proposed messages to delete language associated with emotional tones (anger, fear, sad and joyful) to increase the likelihood of higher levels of engagement (which may be measured by

In some embodiments, the language of a proposed message may be altered to have anger, fear, sadness, confident, analytical, and tentative tones, indicating that tweets with these dominant tones were associated with an increased number of replies in the social media leader persona. The results revealed a negative effect for joy, indicating that tweets with a dominant joy tone were associated with a significant decrease in the number of replies.

Likes with anger intensity. The multiple regression analysis revealed a significant negative effect on anger intensity while controlling for the number of followers in the social media leader persona only. This finding indicated that as likes increased, anger intensity tended to decrease. These results are in Table 38. The results did not reveal a significant relationship between anger intensity and likes in the following personas: business executive, political candidate, and world leader. These results are in Table 39.

Likes with fear intensity. The multiple regression analysis revealed a significant negative effect of fear intensity while controlling for the number of followers in the political candidate persona. This finding indicated that the fear intensity increased while the number of likes decreased. The results did not reveal a significant relationship between fear intensity and likes in the following personas: social media leader, business executive, and world leader. The results of the social media leader persona are in Table 40, and the results of the business executive persona, political candidate persona, and world leader persona are in Table 41.

Likes with sadness intensity. The multiple regression analysis revealed a significant negative effect for sadness intensity while controlling for the number of followers in the business executive leader and social media leader personas. This finding indicated that as sadness intensity increased, the number of likes tended to decrease. The results revealed significant positive relationships between sadness intensity and likes in the following personas: political candidate and world leader. This indicated that as sadness intensity increased the number of likes tended to increase. The results of the social media leader persona are in Table 42, and the results of the business executive persona, political candidate persona, and world leader persona are in Table 43.

The system may delete words or lingo conventions associated with sadness, as determined by creating a database, and then send the adapted proposed message to a user for approval.

In summary, Question Four analyzed the association between different tone types and engagement as well as individual tone intensities and engagement. The variable of engagement includes likes, retweets, and replies. The number of followers was controlled during the research. Using SPSS, a multiple regression analysis was used to discover the relationships between tone types and tone intensity with engagement. Question Four contained two parts. First, Question Four found that every tone has a positive relationship to engagement, except for joy which is consistently was found to be associated with less engagement. The second part of Question Four revealed that high tone intensity was associated with less engagement. This result was fairly consistent across all personas and all dependent variables.

In summary, each and Table highlighted different findings. The novel finding was that social media voice was associated with engagement. The variable of tone in social media tweet was a novel finding in the study of social media and illustrates that it is associated with engagement (likes, retweets, and replies) above and beyond sentiment, lingo (hashtag, mentions, URLs, abbreviations, and emojis) and pulse (volatility and frequency deviation). Using IBM artificial intelligence Tone Analyzer, the researcher classified tone into two categories: Language and Emotional. The language tone category was associated with more engagement while emotional tones were associated with less engagement. Additionally, after examining the relationship between each individual tone type and engagement, the findings revealed that tweets with anger, fear, sadness, confident, analytical and tentative tones were all associated with more engagement, while tweets with a joy tone were associated with less engagement. The study also found that, in general, higher tone intensities were related to lower levels of engagement (likes, retweets and replies). The findings in the analyses revealed that during the world leader persona Donald Trump used more confident and sadness tones and less joy tones. Furthermore, Donald Trump used less intensity of tone (dialed it down) in sadness, joy, confident, analytical and tentative tone intensities. This is consistent with the world leader persona, when Donald Trump became President. Donald Trump's fear intensity significantly increased in the political candidate persona when Donald Trump was running for President. However, Donald Trump's anger intensity did not change across the three leadership personas. A leader's use of SMV could affect the direction of engagement by using high tone intensity. The researcher specifically examined the type of tone and found that high tone intensity decreased engagement, while certain tone types in certain leadership personas increased engagement.

The study shows that in a world leader persona, his tone intensity produces an increase in social media engagement in terms of likes.

The frequency of tweets is important because excessive tweeting in a short succession of time (measured by a pulse: frequency deviation and volatility) was found to bring decreases in engagement. However, altering the patterns of tweets to generate a pulse (volatility) variable could lead to positive likes and retweets in a specific leadership persona. The series of tweets referring to virality or burstiness occurring due to disasters or national events (Kreis, 2017; Ott, 2017). This conclusion indicated that if Donald Trump increased the frequency of his tweets, he could create volatility. Volatility, when generated occasionally, will increase total engagement, which merits further research in terms of burstiness (as defined in Chapter I) or a cluster of tweets, and the difference between time, volume, frequency, and volatility in tweets or social media post.

Another finding of this study demonstrated that when Donald Trump tweets specific tone types (confident, analytical, tentative, angry, fear, sad and joy) received more engagement, tweets that had tone received more engagement than tweets with no tone. 47 below illustrates all seven types of tone detected by a 30-day interval analyzed over the last 9 years of Donald Trump's use of Twitter. The findings indicated that tone intensity contributed to Donald Trump's digital role as a social media leader beyond sentiment, lingo, and pulse the majority of the time. A possible explanation is a return on tone (ROT). As defined by the researcher, ROT suggests that measuring the analytics of tone type and intensity could predict engagement of social media conversations between leaders and followers even before they post (tweet) on Twitter. The study results from research question RQ1 demonstrated that specific variables (tone included) predict follower engagement and the associated impact can be seen in 47. The highlights each tone intensity over the last nine years and the volume of a specific type of tone used by @realDonaldTrump. This result proves that tone is statistically significant and can be measured on SMPs to help leaders strategically increase engagement.

In an examination of engagement, the study data revealed that likes changed the most in terms of relationship with a variable. Specifically, the use of joy tone in the political candidate persona increased the number of likes. In the world leader persona, the number of likes increased when associated with tone intensity. In every other persona, tone intensity decreased engagement. This finding suggests that either the leadership persona or the change in the intensity could have affected the polarity of engagement with Donald Trump's followers. These followers engage by liking his tweets more when his tone intensity is high as a world leader or President of the United States.

The study indicated that leadership personas were associated with engagement differently when considering both tone type and intensity. The findings showed that leadership personas varied among tone type; however, intensity decreased over time. This result suggests that as Donald Trump's tone decreased in intensity per specific persona, different characteristics from the variables may be a better predictor of engagement compared to others. Thus, the type of leadership persona is related to engagement, tone, sentiment, lingo, and pulse.

The first key finding was that sentiment was always negatively related to follower engagement. Tweets with a negative sentiment intensity (dominant score−0.1 to 1) tended to have higher levels of likes, retweets, and replies. An overly positive sentiment tends to decrease the number of likes, retweets, and replies. This finding reconfirmed what other studies have revealed about Donald Trump's sentiment as overly negative; however, prior quantitative findings indicate his negative sentiment also tends to generate more engagement by his followers (Cambria, Das, Bandyopadhyay, & Feraco, 2017; Miller, Blumenthal, & Chamberlain, 2015; Pang & Lee, 2008).

Previous research has typically involved examining sentiment in terms of words and sentences exhibiting positive, negative, or neutral sentiment (Beigi, Hu, Maciejewski, & Liu, 2016). According to the research on sentiment, Cambria et al. (2017) concluded that a customer review message could convey positive sentiment about service received but at the same time could have a negative sentiment about the food, that could then affect brand engagement. Miller et al. (2015) concurred that followers react to the content of messages from leaders with a positive, negative, or neutral sentiment.

By using new technologies, the study extended the body of research to measure sentiment intensity and both aspects of SMV (tone and sentiment) as well as examine their associations with social media engagement among a leader persona, including but not limited to a social media leader persona (the sum total of all social media posts and their relationship to follower social media engagement). Brand managers, social media marketers, social media influencers, digital marketers, and business executives could potentially benefit from these findings, as they highlight the importance of establishing a voice with these variables while consciously being aware of the strength or weakness (measured by intensity) of each to drive engagement, an intended direction to increase or decrease participation by followers. Studying the levels of sentiment among a leader proved to be more effective in measuring social media engagement between the leader and his or her followers. The study revealed that by understanding negative sentiment's impact on engagement, Donald Trump could modify his voice on social media.

The second key finding of RQ1 was that pulse (frequency deviation and volatility) is consistently negatively related to social media engagement across all personas and all dependent variables. However, volatility changes from negative engagement to positive engagement in the world leader persona has suggested that frequency deviation and volatility are not always the same and merit further study. This finding suggests that when Donald Trump tweeted excessively in a single day, each tweet received a decrease in social media engagement. Conversely, when he tweeted only a few times within a day, these tweets tended to receive more social media engagement—suggesting that tweets could lose follower attention.

This finding could be the result of what the researcher suggests is social media saturation (SMS), when followers have already engaged and therefore, do not engage further. This finding is consistent with other studies in which researchers examined tweeting frequency and engagement (Doyle, Szymanski, & Korniss, 2016; Hendrickson & Montague, 2016). In addition to tweeting frequency, the study also contributes a way to calculate (mathematically tweets per minute (TPM)) the frequency deviation and volatility (coefficient variation) of a social media message or post (tweet). These calculations were done based on how many tweets appeared within an hour. This frequency deviation calculation could be applied to the study of social media analytics or to establish a measurement benchmarking what is acceptable by Twitter, Inc. for account holders.

Follower's engagement with the frequency of tweets could also help leaders determine how often followers would like to hear from the leaders. The researcher's calculation for volatility and frequency is also similar to findings from Hendrickson and Montague (2016) which state when tragic events occur, large data are uploaded, and there are spikes in interactive commentary among users, but over time, the public response decreases. When Donald Trump tweets too much social media engagement by his followers also decrease. Doyle et al. (2016) also stated that human interactions happen in a viral manner whereby people frequently speak for short blasts and then go silent.
The study confirms that volatility can increase engagement, just like Doyle explained.

The third key finding is that different components of lingo affected social media engagement differently; some components were related to higher levels of engagement, while others were related to lower levels of engagement or had no relationship at all. For example, mention (@) was negatively related to engagement across all dependent variables and personas. If a mention was placed in one of Donald Trump's tweets, total engagement tended to decrease. And the opposite was true; if a mention was not present, engagement increased.

A potential explanation could be that including a mention in a tweet takes up, Use of hashtags, abbreviations, and emoji when considering the sum of Donald Trump's tweets increased positive engagement most of the time. However, there were some discrepancies occurred in the world leader and political candidate personas in that these components decreased engagement. Another finding showed that the use of a URL is associated with less engagement, meaning when a URL was present in Donald Trump's tweets, less social media engagement occurred among his followers.

The research showed that the use of lingo such as mention (@), abbreviations like RT, and URLs (web links) affected Donald Trump's ability to engage with followers negatively in other leadership personas, In addition to @mention, other forms of lingo, such as emoji, showed an increased desire for more emoji alternatives as more individuals continue to use mobile messaging (Emogi Research Team, 2016). For example, every time Donald Trump used an emoji, there was an increased social media engagement; however, the data were limited since Donald Trump's use of emojis was limited. The study has an opposite finding to Lampos that a mention decrease engagement.

This finding suggested that as Donald Trump's tone intensity increased, his engagement tended to decrease. As a practical application, when businesspersons or leaders write content, they should keep the tone in mind when constructing their social media posts.

The final part of RQ1 was to determine whether the number of followers entered in the model as a control variable increased engagement. The results revealed a positive relationship between the dependent variables. There was a negative relationship in retweets and replies in the business executive persona. This unexpected finding shows that as Donald Trump gained more followers, his engagement for retweets, replies, and likes decreased. A possible explanation could be that online advertisers, fake accounts, or bots may have boosted these engagements, thus skewing the data. Further research to examine this finding is merited.

The study results revealed that tweets with a dominant language tone received more social media engagement compared to tweets with a dominant emotional tone. Understanding whether the level of engagement changed between tweets with a dominant emotional tone versus a dominant language tone assisted in identifying which types of posts produced the most user interactions. Twitter engagement affects a number of followers since when one posts (tweets) via a like, retweet, or reply (Bock, Zmud, Kim, & Lee, 2005). Tweets with a dominant emotional tone affected engagement and number of followers.

The study results revealed a negative effect for joy, indicating that tweets with a dominant joy tone were associated with a statistically significant decrease in social media engagement. First, every tone had a positive relationship to engagement, except for joy, which was found consistently to be associated with less engagement. The second part of RQ4 revealed that high tone intensity was associated with less engagement. This result was consistent across all personas and all dependent variables.

Another finding from the study showed that when tone had a higher intensity, total engagement decreased. Consequently, the study revealed that followers prefer anger tone to joy, which is consistent with the researcher's findings that the type of tone matters when generating engagement. The results indicated that as the confident intensity increased, the number of replies tended to decrease.

The foregoing descriptions of embodiments have been presented only for purposes of illustration and description. They are not intended to be exhaustive or to limit the embodiments to the forms disclosed. Accordingly, many modifications and variations may be apparent to practitioners skilled in the art. Additionally, the above disclosure is not intended to limit the embodiments. The scope of the embodiments is defined by the appended claims.

B-SINGH-2-002N, claiming benefit of 2-001N and 2-001P

1. A method comprising:
digitally computing a finalized lingo score from a set of published messages published by a categorized group of social media participants, the finalized lingo score comprising a plurality of coefficients of variation for at least three lingo subscores selected from a group consisting of a hashtag subscore, a mentions subscore, an abbreviation subscore, a post-link subscore, an emoji subscore, a jargon subscore, an emoticon sub score, and an all capital letters subscore;
digitally computing a finalized engagement score, from a number of social media reactions to the set of messages published by the categorized group of social media participants, for the set of published messages;
calculating, via a processor, a value of an engagement score for a proposed message;
digitally computing a finalized posting frequency from the set of published messages published by the categorized group of social media participants, wherein the categorized group of social media participants belong to a number of categories selectable from an occupation category, a role category, a gender category, an age range category, a geographic location category; a celebrity status category, a politician category, a candidate category, a political opinion category, and combinations thereof;
digitally querying, via a processor, a tone analyzer for a finalized emotion tone computable from the set of published messages and for a finalized emotion tone computable from the set of published messages, the finalized emotion tone selectable from a group consisting of joy, sadness, anger, disgust, and fear;
digitally querying, via a processor, the tone analyzer for a computable finalized social propensities tone from the set of published messages and for a finalized social propensities tone, the finalized social propensities tone comprising a social propensities tone selected from a group consisting of openness, conscientiousness, extroversion, agreeableness, and emotional range;
digitally querying, via a processor, the tone analyzer for a computable finalized language tone from the set of published messages and a computable finalized language tone intensity from the set of published messages, the finalized language tone selectable from a group consisting of analytical, confident, and tentative;
digitally receiving, via a processor from the tone analyzer, the finalized emotion tone, the finalized emotion tone intensity, the finalized social propensities tone, the finalized social propensities tone intensity, the finalized language tone, and the finalized language tone intensity;
digitally querying, via a processor, the sentiment analyzer for a finalized sentiment computable from the set of published messages, the finalized sentiment selectable from a group consisting of a positive sentiment, a neutral sentiment, and a negative sentiment;
digitally receiving, from the sentiment analyzer, the finalized sentiment computable from the set of published messages;
digitally querying, via a processor, the tone analyzer for an emotion tone computable from the proposed message and an emotion tone intensity computable from the proposed message, the emotion tone selectable from a group consisting of joy tone, sadness tone, anger tone, disgust tone, and fear tone;
digitally querying, via a processor, the tone analyzer for a social propensities tone computable from the proposed message and a social propensities tone intensity computable from the proposed message, the social propensities tone selectable from a group consisting of openness tone, conscientiousness tone, extroversion tone, agreeableness tone, and emotional range tone;
digitally querying, via a processor, the tone analyzer for a language tone computable from the proposed message and a language tone intensity computable from the proposed message, the language tone selectable from a group consisting of analytical tone, confident tone, and tentative tone;
digitally receiving, via a processor, from the tone analyzer, for the proposed message, the emotion tone, emotion tone intensity, the social propensities tone, the social propensities tone intensity, the language tone, and the language tone intensity;
digitally querying, via a processor, the sentiment analyzer for a sentiment computable from the proposed message, the sentiment selectable from a group consisting of a positive sentiment, a neutral sentiment, and a negative sentiment;
digitally receiving, via a processor, from the sentiment analyzer, the sentiment for the proposed message;
digitally analyzing, via a processor, the proposed message by computing a proposed message lingo score for the proposed message and a proposed user posting frequency for the proposed message;
digitally comparing, via a processor, the finalized lingo score with the lingo score of the proposed message;
digitally comparing, via a processor, the finalized posting frequency with the posting frequency of the proposed message;
digitally comparing, via a processor, the finalized emotion tone with the emotion tone of the proposed message;
digitally comparing, via a processor, the finalized emotion tone intensity with the emotion tone intensity of the proposed message;
digitally comparing, via a processor, the finalized social propensities tone with the social propensities tone of the proposed message;
digitally comparing, via a processor, the corresponding finalized social propensities tone intensity with the social propensities tone intensity of the proposed message;
digitally comparing, via a processor, finalized language tone with the language tone of the proposed message;
digitally comparing, via a processor, the finalized language tone intensity with the language tone intensity of the proposed message;
digitally comparing, via a processor, the finalized posting frequency with the posting frequency of the proposed message; and,
digitally identifying, via a processor, a number of message issues, of the proposed message, changeable to increase the value of the predicted engagement score of the proposed message.

2. The method of claim 1, further comprising digitally managing a persona by identifying, via a processor, an optimal target lingo score, an optimal target posting frequency, an optimal target emotion tone, an optimal target emotion tone intensity, an optimal target social propensities tone, an optimal target social propensities tone intensity, an optimal target language tone, an optimal target language tone intensity, and an optimal target sentiment, for a target audience, the target audience identifiable by at least one characteristic selected from the group consisting of occupation, role, gender, age, geographic location, political party affiliation, marital status, status as a celebrity, status as a politician, status as political candidate, type of political opinion, and religious affiliation.

3. The method of claim 1, further comprising instructing an output device to display the at least three lingo subscores selected from the group consisting of a hashtag sub score, a mentions subscore, an abbreviation subscore, a post-link subscore, an emoji subscore, a jargon subscore, an emoticon subscore, and an all capital letters subscore.

4. The method of claim 1, further comprising identifying, via a processor, a number of synonym phrase, the number of synonymous phrases having the same denotation as the target phrase while having a different connotation, the different connotation influencing the tone intensity.

5. The method of claim 1, further comprising a step of optimizing the lingo score of the proposed message by identifying, via a processor, a number of linguistic additions and a number of linguistic deletions.

6. The method of claim 5, wherein optimizing the subscore comprises adding a number of hashtags, emoticons, or capital letters to improve a subscore of the target message. hashtag subscore, a mentions subscore, an abbreviation subscore, a post-link subscore, an emoji subscore, a jargon subscore, an emoticon subscore, and an all capital letters subscore.

7. The method of claim 1, further comprising delaying publication of the target message to match the target posting frequency.

8. The method of claim 1, wherein the target message comprises at least one selected from a group consisting of text, image, audio, video, and an image with text embedded.

9. The method of claim 1, further comprising monitoring, via a processor, a reach metric of the target message after the target message is published.

10. The method of claim 9, further comprising monitoring an effectiveness of a target message by monitoring a plurality of a frequency metric, volume metric, engagement metric, and saturation metric of the target message, wherein frequency measures the time between posts, volume measures the size of conversation about the target message, engagement measures a number of social media reactions to the target message, and saturation measures when engagement patterns of the target message indicate that the engagement patterns have decreased below a minimum engagement threshold.

11. An apparatus for generating persuasive rhetoric for a social media participant, the apparatus comprising:
a processor;
a network interface card, the network interface card communicatively connected to the processor;
a display, the display communicatively connected to the processor;
an input device, the input device communicatively connected to the processor to receive input from a user;
a non-transitory storage medium, the non-transitory storage medium communicatively connected to the processor containing computer program instructions, the computer program instructions causing the apparatus to perform a task, the instructions including:
target engagement scorer instructions digitally computing a target engagement score for a set of published messages, the target engagement score measuring the interactions with the set of published social media participants;
target lingo scorer instructions digitally computing a target lingo score from the set of published messages published by a categorized group of social media participants, wherein the target lingo score comprises a plurality of coefficients of variation for at least five lingo subscores selected from the group consisting of a hashtag sub score, a mentions subscore, an abbreviation subscore, a post-link subscore, an emoji subscore, a jargon subscore, an emoticon subscore, and an all capital letters subscore;
target posting frequency identifier instructions digitally computing a target posting frequency from the set of published messages published by the categorized group of social media participants, wherein the number of social media participants belong to a number of categories, wherein the category is selected from a group of categories comprising an occupation, a role, a gender, an age, a geographic location; celebrities, politicians, candidates, political opinion, females, and males;
digital tone requester instructions requesting that a tone analyzer identify a predominant tone and a corresponding tone intensity for the set of published messages, the predominant tone comprising a communication tone that is categorized into at least one joy, sadness, anger, fear, analytical, tentative, and confidence and the corresponding tone intensity representing a numeric value indicating the strength of the predominant tone; and,
digital tone receiver instructions receiving the predominant tone and the corresponding tone intensity from the tone analyzer;
digital sentiment receiver instructions requesting that a sentiment analyzer identify a predominant sentiment for the set of published messages, the predominant sentiment comprising at least one of positive sentiment, neutral sentiment, or negative sentiment;
target message analyzer instructions analyzing a target message by digitally computing a message lingo score, a posting frequency, a message tone, a message tone intensity, and a message sentiment; and,
a message lingo scorer instructions comparing the message lingo score, the posting frequency, the message tone, the message tone intensity, and the message sentiment to the target lingo score, the target posting frequency, the predominant tone, the tone intensity and the predominant sentiment to identify a number of message issues that may be changed to obtain a designated target result.

12. The apparatus of claim 11, further comprising target message receiver instructions for receiving a target message from a user using the input device.

13. The apparatus of claim 12, further comprising score presenter instructions for presenting a target lingo score and at least three subscores selected from a group consisting of from the target lingo score, the hashtag subscore, the mentions subscore, the abbreviation subscore, the post-link subscore, the emoji subscore, the jargon subscore, the emoticon subscore, the all capital letters subscore, the target posting frequency, the predominant tone, the tone intensity, the sentiment.

14. The apparatus of claim 13, further comprising target score presenting instructions, presenting a target score for the scores presented from the score presenter.

15. The apparatus of claim 14, further comprising synonym identifier instructions identifying a number of synonyms for phrases or words in the target message where the number of synonyms improve the presented scores.

16. The apparatus of claim 14, further comprising hashtag identifier instructions identifying a number of hashtags, based on the target message, that improve the hashtag subscore.

17. The apparatus of claim 13, wherein the target score is calculated based on a target audience of the target message.

18. The apparatus of claim 13, further comprising user target identifier instructions receiving, from a user, a target demographic, a target demographic comprising at least one of an occupation, a role, a gender, an age, a geographic location; celebrities, politicians, candidates, political opinion, females, and males.

19. The apparatus of claim 13, further comprising a historic target identifier instructions identifying the target demographic comprising at least one of an occupation, a role, a gender, an age, a geographic location; celebrities, politicians, candidates, political opinion, females, and males based on prior messages.

20. The apparatus of claim 13, combining receiving, from a user, a comprehensive target demographic, a user target demographic comprising at least one of an occupation, a role, a gender, an age, a geographic location; celebrities, politicians, candidates, political opinion, females, and males and identifying the target historic target identifier identifying the target demographic comprising at least one of an occupation, a role, a gender, an age, a geographic location; celebrities, politicians, candidates, political opinion, females, and males based on prior messages.
